(19) United States
(12) Patent Application Publication
(10) Pub. No.: US 2026/0260095 A1
(43) Pub. Date: Sep. 3, 2026

(54) System and Method for Circuit Topology Discovery

(71) Applicant: Northeastern University, Boston, MA (US)

(72) Inventors: Xuan Zhang, Lexington, MA (US); Jian Gao, Boston, MA (US)

(21) Appl. No.: 19/544,679

(22) Filed: Feb. 19, 2026

Related U.S. Application Data
(60) Provisional application No. 63/760,301, filed on Feb. 19, 2025.
(60) Provisional application No. 63/890,008, filed on Sep. 29, 2025.

(51) Int. Cl. G06N 3/045; G06F 16/901; G06N 3/042; G06N 3/092

(52) U.S. Cl. CPC G06N 3/045; G06F 16/9024; G06N 3/042; G06N 3/092

(57) ABSTRACT

A computer-implemented method and computer-based system train a generative engine for circuit topology discovery. The computer-implemented method generates a graph representing a circuit topology of a training dataset. The graph generated includes nodes and edges. The nodes represent device pins of circuit components in the circuit topology. The computer-implemented method transforms the graph generated into a sequential token representation of tokens by traversing the edges of the graph generated. The tokens represent the device pins. The traversing forms a traversal path that visits each edge of the edges at least once. The computer-implemented method trains the generative engine to predict successive tokens of the sequential token representation. Such prediction enables the generative engine to discover at least one circuit topology that is not present in the training dataset.

### RELATED APPLICATIONS

This application claims the benefit of U.S. Provisional Application No. 63/760,301, filed on Feb. 19, 2025 and U.S. Provisional Application No. 63/890,008, filed on Sep. 29, 2025. The entire teachings of the above applications are incorporated herein by reference.

### GOVERNMENT SUPPORT

This invention was made with government support under Grant Nos. 1942900 and 2416375 awarded by the National Science Foundation. The government has certain rights in the invention.

### BACKGROUND

Generative artificial intelligence (AI) is a type of AI that can create new content and ideas, including conversations, stories, images, videos, and music for non-limiting examples.

### SUMMARY

According to an example embodiment, a computer-implemented method for training a generative engine for circuit topology discovery comprises generating a graph representing a circuit topology of a training dataset. The graph generated includes nodes and edges. The nodes represent device pins of circuit components in the circuit topology. The computer-implemented method further comprises transforming the graph generated into a sequential token representation of tokens by traversing the edges of the graph generated. The tokens represent the device pins. The traversing forms a traversal path that visits each edge of the edges at least once. The computer-implemented method further comprises training the generative engine to predict successive tokens of the sequential token representation.

The training dataset may include a plurality of circuit topologies and the plurality of circuit topologies may include the circuit topology.

The computer-implemented method may further comprise repeating the representing, transforming, and training for each circuit topology of the plurality of circuit topologies.

The tokens may further represent circuit-level pins in the circuit topology.

The generative engine may be based on a causal model. The graph generated may be an undirected graph. The transforming may include converting the undirected graph to obtain an Eulerian circuit that visits each edge at least once. The generative engine may be a decoder-only transformer.

The computer-implemented method may further comprise compressing the sequential token representation prior to the training. The compressing may reduce a total length of the sequential token representation. The compressing may include at least one of: pruning redundant nodes and edges in the graph generated, subgraph mining and replacement, and solving a shortest-closed-path problem to obtain a minimal-length sequential token representation.

The computer-implemented method may further comprise pruning the graph generated prior to the transforming. The pruning may include removing redundant nodes and redundant edges in the graph generated. The pruning may include removing isolated nodes of a sub-graph of the graph generated and restructuring non-isolated nodes of the sub-graph that remain following the pruning.

The computer-implemented method may further comprise mining graphs representing a plurality of circuit topologies of the training dataset. The mining may include identifying a sub-graph that occurs in multiple graphs of the graphs mined and replacing instances of the sub-graph identified with a compact representation thereof.

The computer-implemented method may further comprise performing subsequent training of the generative engine. The subsequent training may be performed subsequent to the training. The subsequent training may fine tune the generative engine to perform target circuit topology discovery.

The subsequent training may be based on a text prompt input to the generative engine. The text prompt may represent a) at least one target circuit characteristic of a targeted circuit topology, b) at least one target circuit type of the targeted circuit topology, or c) a combination of a) and b) for non-limiting examples.

The subsequent training may include proximal policy optimization using a reward model that classifies circuit topologies generated by the generative engine into a plurality of ranked categories based on validity, relevance to a target circuit type, and performance for non-limiting examples.

The subsequent training may include direct preference optimization using pairs of circuit topologies, each pair including a preferred topology and a non-preferred topology ranked according to at least one performance metric

The subsequent training may be based on feedback input to the generative engine. The feedback may represent a reward or penalty received responsive to a circuit topology discovered by the generative engine. The reward or penalty received may be based on a comparison of a) at least one target circuit characteristic of a targeted circuit topology and at least one characteristic of the circuit topology discovered, b) at least one target circuit type of the targeted circuit topology and at least one type of the circuit topology discovered, or c) a combination of a) and b) for non-limiting examples.

The training dataset may include a corpus of distinct circuit topologies with diverse functionalities.

The transforming may include solving a shortest closed path problem on the graph generated to obtain a minimal-length sequential token representation that visits each edge of the graph at least once.

The computer-implemented method may further comprise augmenting the training dataset by generating, for each circuit topology of the training dataset, a plurality of distinct sequential token representations. Each distinct sequential token representation of the plurality of distinct sequential token representations may represent a same circuit topology via a different traversal path of a respective graph.

According to another example embodiment, a non-transitory computer-readable medium for training a generative engine for circuit topology discovery may have encoded thereon a sequence of instructions which, when loaded and executed by at least one processor, causes the at least one processor to generate a graph representing a circuit topology of a training dataset. The graph generated includes nodes and edges. The nodes represent device pins of circuit components in the circuit topology. The sequence of instructions may further cause the at least one processor to transform the graph generated into a sequential token representation of tokens by traversing the edges of the graph generated. The tokens may represent the device pins. The traversing may form a traversal path that visits each edge of the edges at least once. The sequence of instructions may further cause the at least one processor to train the generative engine to predict successive tokens of the sequential token representation.

Alternative non-transitory computer-readable medium embodiments parallel those described above in connection with the example computer-implemented method embodiment.

According to another example embodiment, a computer-implemented method for automating circuit topology discovery comprises generating, automatically via a trained generative engine, a sequential token representation of tokens. Tokens of the sequential token representation represent pins of a circuit topology discovered by the trained generative engine. The computer-implemented method further comprises transforming the sequential token representation generated by the trained generative engine into a graph. The graph represents the circuit topology discovered.

The pins may include device-level pins of circuit components of the circuit topology discovered and circuit-level pins in the circuit topology discovered.

The generative engine may be based on a causal model. The generative engine may be a decoder-only transformer.

The computer-implemented method may further comprise performing the generating responsive to a text prompt input to the trained generative engine. The text prompt may cause the circuit topology discovered to have a target circuit type or a target circuit characteristic for non-limiting examples.

The trained generative engine may be trained based on a training dataset. The circuit topology discovered may not be present in the training dataset. The training dataset may include a corpus of distinct circuit topologies with diverse functionalities.

It should be understood that example embodiments disclosed herein can be implemented in the form of a method, apparatus, system, or computer readable medium with program codes embodied thereon.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a block diagram of an example embodiment of a computer-based system configured to implement an example embodiment of a computer-implemented method disclosed herein.

FIG. 2 is a flow diagram of an example embodiment of a computer-implemented method for training a generative engine for circuit topology discovery.

FIG. 3 is a flow diagram of an example embodiment of a computer-implemented method for automating circuit topology discovery.

FIG. 4A is a typical data representation for analog circuit topology.

FIG. 4B is an existing analog circuit topology generation paradigm.

FIG. 5 is an overview 500 of an example embodiment of AnalogGenie.

FIG. 6A is a representation of a device level graph representation.

FIG. 6B is a representation of an example embodiment of a device pin level graph representation.

FIG. 7 is a graph that compares the training performance of AnalogGenie using unaugmented data and augmented data.

FIG. 8 and FIG. 9 are graphs of statistics of an example embodiment of an open-source dataset.

FIG. 10A is an example of an analog circuit topology.

FIG. 10B is an example embodiment of a device pin level graph representation of the analog circuit topology of FIG. 10A.

FIG. 10C includes four representations (1000C-1, 1000C-2, 1000C-3, and 1000C-4) of unique Eulerian circuits found by using a depth-first search (DFS) method.

FIGS. 11-13 are schematics of example embodiment of novel circuits generated by AnalogGenie.

FIG. 14 is a schematic of an example embodiment of a transconductance amplifier generated by AnalogGenie.

FIG. 15 and FIG. 16 are schematics of failed examples circuits generated by AnalogGenie.

FIG. 17A is an example circuit topology.

FIG. 17B is a representation of a device graph of the circuit topology of FIG. 17A.

FIG. 17C is a representation of example embodiment of a device pin graph of the circuit topology of FIG. 17A.

FIG. 17D is a representation of an AnalogGenie-Lite graph of the circuit topology of FIG. 17A.

FIGS. 18A and 18B are simplified diagrams that illustrate how an example embodiment of AnalogGenie-Lite identifies 1800A and simplifies 1800B frequent subgraphs, respectively.

FIG. 19 is a representation of two frequent subgraph examples.

FIGS. 20A and 20B are representations of eulerizing a graph based on early work and eulerizing a graph based on an example embodiment of AnalogGenie-Lite, respectively.

FIGS. 21A and 21B are graphs illustrating a comparison between methods.

FIG. 22 is a table that provides a performance comparison between AnalogGenie-Lite and existing analog circuit topology generation work.

FIG. 23 is a graph that demonstrates an example embodiment of compression for AnalogGenie-Lite's Chinese Postman sequence.

FIG. 24A is a representation of an example circuit topology.

FIG. 24B is a representation of an example embodiment of a device pin graph of the example circuit topology of FIG. 24A.

FIG. 24C is a representation of an example embodiment of an AnalogGenie-Lite graph of the example circuit topology of FIG. 24A.

FIG. 25A is an original circuit topology.

FIG. 25B is an example embodiment of pin-level graph representation of the original circuit topology of FIG. 25A.

FIG. 25C is an example embodiment of an Eulerian circuit of the original circuit topology of FIG. 25A.

FIG. 26 is an overview of an example embodiment of an efficient and versatile generative engine for targeted discovery of novel analog circuits.

FIGS. 27A and 27B are graphs of example embodiments of proximal policy optimization (PPO) and direct preference optimization (DPO), respectively.

FIGS. 28A and 28B are graphs of EVA's PPO loss and DPO loss, respectively, after pretraining while targeting Op-Amp design as an example.

FIG. 29 is a table that provides a performance comparison between EVA and existing analog circuit topology generation work.

FIG. 30 is a block diagram of an example embodiment of a model architecture.

FIG. 31 is a circuit schematic

FIG. 32 is a block diagram of an example internal structure of a computer optionally within an embodiment disclosed herein.

### DETAILED DESCRIPTION

A description of example embodiments follows.

A generative engine may be referred to interchangeably herein as an artificial intelligence (AI) engine. While an example embodiment disclosed herein may be described with reference to an analog circuit topology, it should be understood that the example embodiment is not limited thereto and may be applied to a digital circuit topology or other type of circuit topology.

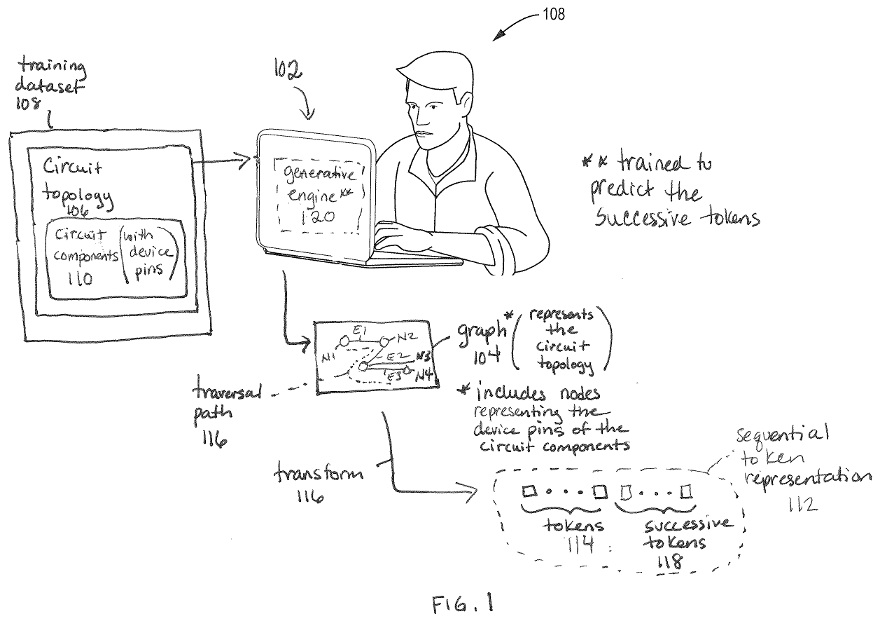

An example embodiment disclosed herein automates discovery of novel circuit topologies. Traditionally, this process either relies heavily on manual effort or focuses on reusing existing topologies. An example embodiment may employ a generative engine that can automatically discover diverse, novel, and high-performance topologies tailored to specific metrics within a few attempts. Such automatic discovery enables faster breakthroughs in next-generation technologies, such as generative artificial intelligent (AI) acceleration, 5G/6G, and quantum computing for non-limiting examples, by unlocking unprecedented design possibilities. A user, such as the user 108 of FIG. 1, disclosed below, may employ such a generative engine in an electronic design automation (EDA) tool for the automatic discovery for non-limiting example.

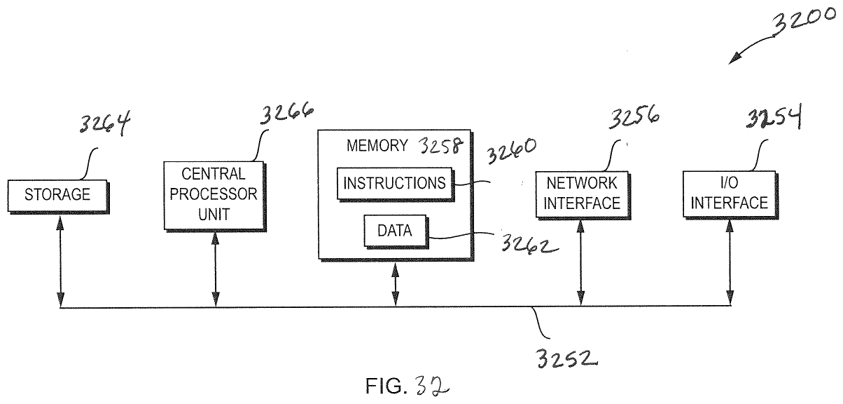

FIG. 1 is a block diagram of an example embodiment of a computer-based system 102 configured to implement an example embodiment of a computer-implemented method disclosed herein. The computer-based system 102 is a laptop in the example embodiment; however, it should be understood that a computer-based system disclosed herein is not limited to a laptop and may be any suitable machine with at least one processor and memory with computer code instructions implemented thereon, such as disclosed further below with regard to FIG. 32 for non-limiting example.

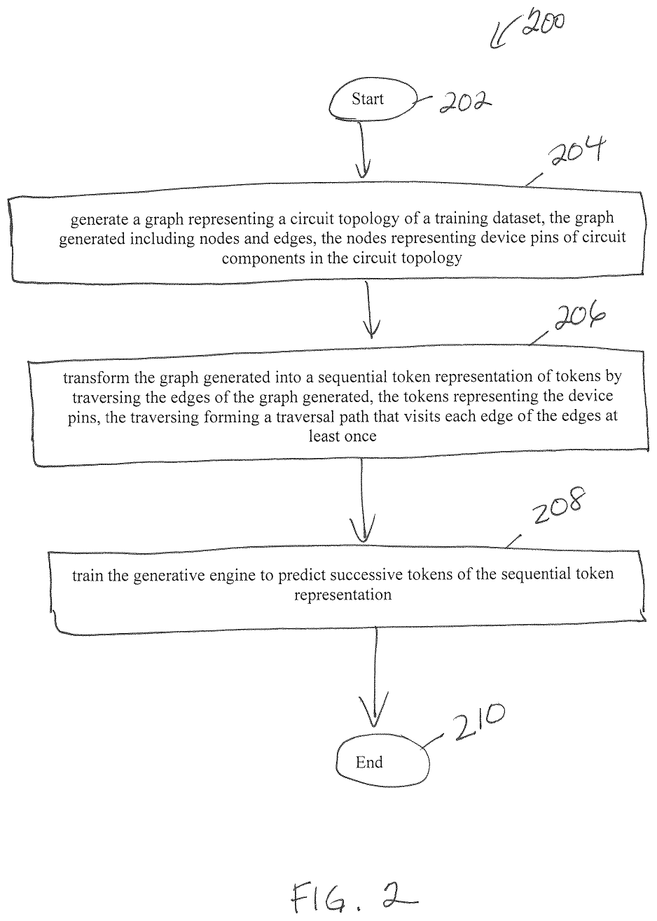

Continuing with reference to FIG. 1, the computer-based system 102 includes a non-transitory computer-readable medium (not shown) for training a generative engine 120 for circuit topology discovery. The non-transitory computer-readable medium has encoded thereon a sequence of instructions which, when loaded and executed by at least one processor (not shown), causes the at least one processor to generate a graph 104 representing a circuit topology 106 of a training dataset 108. The graph 104 generated includes nodes and edges, such as the nodes N1, . . . , N4 and edges E1, . . . , E3 shown for non-limiting examples. The nodes represent device pins (not shown) of circuit components 110 in the circuit topology 106. The sequence of instructions may further cause the at least one processor to transform 116 the graph 104 generated into a sequential token representation 112 of tokens 114 by traversing the edges of the graph 104 generated. The tokens 114 may represent the device pins. The traversing may form a traversal path 116 that visits each edge of the edges at least once. The sequence of instructions may further cause the at least one processor to train the generative engine 120 to predict successive tokens 118 of the sequential token representation 112. An example embodiment of a computer-implemented method for training the generative engine 120 is disclosed below with reference to FIG. 2.

FIG. 2 is a flow diagram 200 of an example embodiment of a computer-implemented method for training a generative engine for circuit topology discovery. The computer-implemented method begins (202) and comprises generating a graph representing a circuit topology of a training dataset (204). The graph generated includes nodes and edges. The nodes represent device pins of circuit components in the circuit topology. The computer-implemented method further comprises transforming the graph generated into a sequential token representation of tokens by traversing the edges of the graph generated (206). The tokens represent the device pins. The traversing forms a traversal path that visits each edge of the edges at least once. The computer-implemented method further comprises training the generative engine to predict successive tokens of the sequential token representation (208). The computer-implemented method thereafter ends (210) in the example embodiment.

With reference to FIG. 1 and FIG. 2, the training dataset 108 may include a plurality of circuit topologies and the plurality of circuit topologies may include the circuit topology 106. The computer-implemented method may further comprise repeating the representing, transforming, and training for each circuit topology of the plurality of circuit topologies.

The tokens 114 may further represent circuit-level pins in the circuit topology 106.

The generative engine 120 may be based on a causal model. The graph 104 generated may be an undirected graph. The transforming (206) may include converting the undirected graph to obtain an Eulerian circuit that visits each edge at least once. The generative engine 120 may be a decoder-only transformer.

The computer-implemented method may further comprise compressing the sequential token representation 112 prior to the training (208). The compressing may reduce a total length of the sequential token representation 112. The compressing may include at least one of: pruning redundant nodes and edges in the graph 104 generated, subgraph mining and replacement, and solving a shortest-closed-path problem to obtain a minimal-length sequential token representation.

The computer-implemented method may further comprise pruning the graph 104 generated prior to the transforming (206). The pruning may include removing redundant nodes and redundant edges in the graph 104 generated. The pruning may include removing isolated nodes of a sub-graph of the graph 104 generated and restructuring non-isolated nodes of the sub-graph that remain following the pruning.

The computer-implemented method may further comprise mining graphs representing a plurality of circuit topologies of the training dataset 108. The mining may include identifying a sub-graph that occurs in multiple graphs of the graphs mined and replacing instances of the sub-graph identified with a compact representation thereof.

The computer-implemented method may further comprise performing subsequent training of the generative engine 120. The subsequent training may be performed subsequent to the training (208). The subsequent training may fine tune the generative engine 120 to perform target circuit topology discovery.

The subsequent training may be based on a text prompt input to the generative engine 120. The text prompt may represent a) at least one target circuit characteristic of a targeted circuit topology, b) at least one target circuit type of the targeted circuit topology, or c) a combination of a) and b) for non-limiting examples.

The subsequent training may include proximal policy optimization using a reward model that classifies circuit topologies generated by the generative engine 120 into a plurality of ranked categories based on validity, relevance to a target circuit type, and performance for non-limiting examples.

The subsequent training may include direct preference optimization using pairs of circuit topologies, each pair including a preferred topology and a non-preferred topology ranked according to at least one performance metric

The subsequent training may be based on feedback input to the generative engine 120. The feedback may represent a reward or penalty received responsive to a circuit topology discovered by the generative engine. The reward or penalty received may be based on a comparison of a) at least one target circuit characteristic of a targeted circuit topology and at least one characteristic of the circuit topology discovered, b) at least one target circuit type of the targeted circuit topology and at least one type of the circuit topology discovered, or c) a combination of a) and b) for non-limiting examples.

The training dataset 108 may include a corpus of distinct circuit topologies with diverse functionalities.

The transforming (206) may include solving a shortest closed path problem on the graph generated to obtain a minimal-length sequential token representation that visits each edge of the graph at least once.

The computer-implemented method may further comprise augmenting the training dataset 108 by generating, for each circuit topology of the training dataset 108, a plurality of distinct sequential token representations. Each distinct sequential token representation of the plurality of distinct sequential token representations may represent a same circuit topology via a different traversal path of a respective graph.

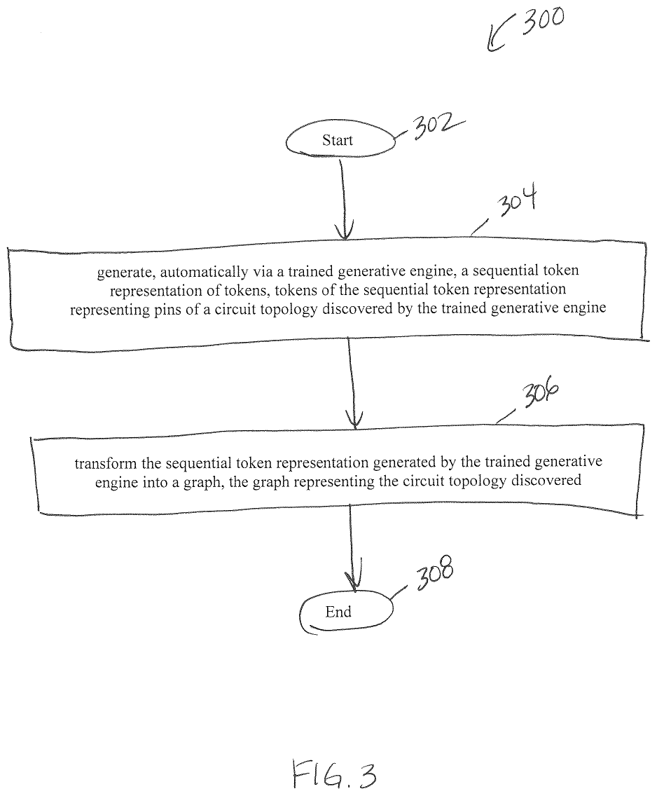

Following training of the generative engine 120, as disclosed above, the trained generative engine may be employed to automate circuit topology discovery, as disclosed below with reference to FIG. 3.

FIG. 3 is a flow diagram 300 of an example embodiment of a computer-implemented method for automating circuit topology discovery. The computer-implemented method begins (302) and comprises generating, automatically via a trained generative engine, a sequential token representation of tokens (304). Tokens of the sequential token representation represent pins of a circuit topology discovered by the trained generative engine. The computer-implemented method further comprises transforming the sequential token representation generated by the trained generative engine into a graph (306). The graph represents the circuit topology discovered. The computer-implemented method thereafter ends (308) in the example embodiment.

Further technical details are disclosed further below.

### Analoggenie: A Generative Engine for Automatic Discovery of Analog Circuit Topologies

The massive and large-scale design of foundational semiconductor integrated circuits (ICs) is crucial to sustaining the advancement of many emerging and future technologies, such as generative AI, 5G/6G, and quantum computing. Excitingly, recent studies have shown the great capabilities of foundational models in expediting the design of digital ICs. Yet, applying generative AI techniques to accelerate the design of analog ICs remains a significant challenge due to critical domain-specific issues, such as the lack of a comprehensive dataset and effective representation methods for analog circuits. This disclosure proposes, AnalogGenie, a Generative engine for automatic design/discovery of Analog circuit topologies—the most challenging and creative task in the conventional manual design flow of analog ICs. AnalogGenie addresses two key gaps in the field: building a foundational comprehensive dataset of analog circuit topology and developing a scalable sequence-based graph representation universal to analog circuits. Experimental results show the remarkable generation performance of AnalogGenie in the variety of analog ICs, increasing the number of devices within a single design, and discovering unseen circuit topologies far beyond any prior arts. An example embodiment paves the way to transform the longstanding time-consuming manual design flow of analog ICs to an automatic and massive manner powered by generative AI.

Semiconductor integrated circuits (ICs) are the foundational hardware cornerstone to advance many emerging technologies such as generative AI, 5G/6G, and quantum computing. The demand for and the scale of ICs are soaring to unprecedented levels with the ever-increasing information and computing workloads (e.g., training foundation models with billions of parameters) (Josh Achiam, Steven Adler, Sandhini Agarwal, Lama Ahmad, Ilge Akkaya, Florencia Leoni Aleman, Diogo Almeida, Janko Altenschmidt, Sam Altman, Shyamal Anadkat, et al. Gpt-4 technical report. arXiv preprint arXiv: 2303.08774, 2023). Thus, accelerating the design of advanced ICs is a key to sustaining the development of future technologies. Excitingly, recent breakthroughs in generative AI have presented transformative opportunities to expedite the conventional design flows of ICs. Domain-specific large language models (LLMs) have been developed to free human designers by automatically generating and correcting Hardware Description Languages (HDL) (Ruizhe Zhong, Xingbo Du, Shixiong Kai, Zhentao Tang, Siyuan Xu, Hui-Ling Zhen, Jianye Hao, Qiang Xu, Mingxuan Yuan, and Junchi Yan. Llm4eda: Emerging progress in large language models for electronic design automation. arXiv preprint arXiv: 2401.12224, 2023; Jason Blocklove, Siddharth Garg, Ramesh Karri, and Hammond Pearce. Chip-chat: Challenges and opportunities in conversational hardware design. In 2023 ACM/IEEE 5th Workshop on Machine Learning for CAD (MLCAD), pp. 1-6. IEEE, 2023); Kaiyan Chang, Ying Wang, Haimeng Ren, Mengdi Wang, Shengwen Liang, Yinhe Han, Huawei Li, and Xiaowei Li. Chipgpt: How far are we from natural language hardware design. arXiv preprint arXiv: 2305.14019, 2023; Shailja Thakur, Baleegh Ahmad, Hammond Pearce, Benjamin Tan, Brendan Dolan-Gavitt, Ramesh Karri, and Siddharth Garg. Verigen: A large language model for verilog code generation. ACM Transactions on Design Automation of Electronic Systems, 29 (3): 1-31, 2024; Shailja Thakur, Jason Blocklove, Hammond Pearce, Benjamin Tan, Siddharth Garg, and Ramesh Karri. Autochip: Automating hdl generation using llm feedback. arXiv preprint arXiv: 2311.04887, 2023; Yonggan Fu, Yongan Zhang, Zhongzhi Yu, Sixu Li, Zhifan Ye, Chaojian Li, Cheng Wan, and Yingyan Celine Lin. Gpt4aigchip: Towards next-generation ai accelerator design automation via large language models. In 2023 IEEE/ACM International Conference on Computer Aided Design (ICCAD), pp. 1-9. IEEE, 2023; Mingjie Liu, Nathaniel Pinckney, Brucek Khailany, and Haoxing Ren. Verilogeval: Evaluating large language models for verilog code generation. In 2023 IEEE/ACM International Conference on Computer Aided Design (ICCAD), pp. 1-8. IEEE, 2023b.; Haoyuan Wu, Zhuolun He, Xinyun Zhang, Xufeng Yao, Su Zheng, Haisheng Zheng, and Bei Yu. Chateda: A large language model powered autonomous agent for eda. IEEE Transactions on Computer-Aided Design of Integrated Circuits and Systems, 2024; Mingjie Liu, Teodor-Dumitru Ene, Robert Kirby, Chris Cheng, Nathaniel Pinckney, Rongjian Liang, Jonah Alben, Himyanshu Anand, Sanmitra Banerjee, Ismet Bayraktaroglu, et al. Chipnemo: Domain-adapted Ilms for chip design. arXiv preprint arXiv: 2311.00176, 2023a), which can be seamlessly used to synthesize digital ICs with desired functionalities. As an example, NVIDIA's ChipNeMo (Mingjie Liu, Teodor-Dumitru Ene, Robert Kirby, Chris Cheng, Nathaniel Pinckney, Rongjian Liang, Jonah Alben, Himyanshu Anand, Sanmitra Banerjee, Ismet Bayraktaroglu, et al. Chipnemo: Domain-adapted llms for chip design. arXiv preprint arXiv: 2311.00176, 2023a), a powerful domain-adapted LLM, can rapidly generate valuable digital designs with just a few prompts. Yet, applying generative AI to speed up the design of analog ICs-essential in ubiquitous electronic systems to bridge the interfaces between the physical world and cyberspace, ranging from enhancing performance in computing systems (e.g., high-speed memory interfaces and I/O links) to providing critical functionalities in communication and sensing systems (e.g., 5G/6G and quantum computing)—remains significantly understudied.

The fundamental challenge arises from the intricate design complexities of analog ICs. Unlike digital ICs that can be universally and hierarchically abstracted into Boolean logic representations and easily described with high-level hardware description languages (e.g., Verilog and VHDL) or programming languages (e.g., C), analog ICs remain intractable to such abstraction due to their lack of systematic hierarchical representation and the heuristic and knowledge-intensive nature of their design process (Georges G E Gielen and Rob A Rutenbar. Computer-aided design of analog and mixed-signal integrated circuits. Proceedings of the IEEE, 88 (12): 1825-1854, 2000). This makes it extremely hard to automate the design of analog ICs by developing programming languages similar to those used for digital ICs. As such, domain experts have followed a longstanding manual flow to design analog ICs. This process involves a number of time-consuming stages, such as selecting/creating an existing (new) circuit topology (i.e., defining the connections between devices), optimizing device parameters based on the topology to achieve desired performance, and designing the physical layout of the optimized circuit for manufacturing. Importantly, the topology generation stage is the foundation and most creative part of the analog IC design process, posing a formidable and perennial challenge to design automation. Addressing it is the key to accelerating the development of analog ICs.

There have been several studies in tackling this problem with generative AI techniques. The early pioneering work, CktGNN (Zehao Dong, Weidong Cao, Muhan Zhang, Dacheng Tao, Yixin Chen, and Xuan Zhang. Cktgnn: Circuit graph neural network for electronic design automation. arXiv preprint arXiv: 2308.16406, 2023), formulates the topology design as a graph generation task, as circuit topologies of analog ICs can be naturally represented as graph structures. It uses a graph variational autoencoder (VAE) to generate various circuit topologies for a specific type of analog ICs, i.e., operational-amplifiers (Op-Amps). More recently, foundational models have also been explored for designing analog circuit topologies. LaMAGIC (Chen-Chia Chang, Yikang Shan, Shaoze Fan, Jing Li, Shun Zhang, Ningyuan Cao, Yiran Chen, and Xin Zhang. Lamagic: Language-model-based topology generation for analog integrated circuits. arXiv preprint arXiv: 2407.18269, 2024), a fine-tuned masked language model (MLM), has been proposed to generate analog circuits with a fixed number of graph nodes. It shows a high success rate in designing a specific type of analog ICs, i.e., power converters (with fewer than 4 devices). AnalogCoder (Yao Lai, Sungyoung Lee, Guojin Chen, Souradip Poddar, Mengkang Hu, David Z Pan, and Ping Luo. Analogcoder: Analog circuit design via training-free code generation. arXiv preprint arXiv: 2405.14918, 2024), another LLM-based work, uses domain-specific prompt engineering to generate analog circuits from well-established LLM models (e.g., GPT-4). Instead of directly generating circuit topologies, it generates PySpice codes that can be converted to a SPICE (Simulation Program with Integrated Circuit Emphasis) netlist-a textual high-level description of device connections used for circuit simulation. AnalogCoder can generate a range of conventional analog circuits that often have a limited number of devices on the order of ten. These methods have demonstrated the potential of applying generative AI to analog IC design. Yet, a vast untapped frontier remains.

An example embodiment proposes, AnalogGenie, a Generative engine (model) for automatic discovery of analog circuit topologies. In contrast to previous methods (Zehao Dong, Weidong Cao, Muhan Zhang, Dacheng Tao, Yixin Chen, and Xuan Zhang. Cktgnn: Circuit graph neural network for electronic design automation. arXiv preprint arXiv: 2308.16406, 2023; Chen-Chia Chang, Yikang Shan, Shaoze Fan, Jing Li, Shun Zhang, Ningyuan Cao, Yiran Chen, and Xin Zhang. Lamagic: Language-model-based topology generation for analog integrated circuits. arXiv preprint arXiv: 2407.18269, 2024; Yao Lai, Sungyoung Lee, Guojin Chen, Souradip Poddar, Mengkang Hu, David Z Pan, and Ping Luo. Analogcoder: Analog circuit design via training-free code generation. arXiv preprint arXiv: 2405.14918, 2024) that are limited to a smaller scale of generation (e.g., generating a single type of ana-log ICs, small-size analog ICs, or conventional analog ICs), AnalogGenie addresses the problem of scalable and general design. It can significantly broaden the variety of analog ICs, increase the number of devices within a single design, and discover unseen circuit topologies. A major obstacle to advancing generative models for scalable analog circuit design automation is the lack of a comprehensive dataset of analog circuit topologies. An example embodiment may bridge this gap by building a extensive dataset that includes more than 3000 distinct analog circuit topologies with diverse functionalities (e.g., Op-Amps, Low Dropout Regulator (LDO), Bandgap reference, Comparator, Phase-Locked Loop (PLL), Low Noise Amplifier (LNA), Power Amplifiers (PA), Mixer, Voltage-Controlled Oscillator (VCO), etc) from public resources (Behzad Razavi. Design of Analog CMOS Integrated Circuits. McGraw-Hill, Inc., USA, 1 edition, 2000. ISBN 0072380322; Behzad Razavi and Razavi Behzad. RF microelectronics, volume 2. Prentice hall New York, 2012; David A Johns and Ken Martin. Analog integrated circuit design. John Wiley & Sons, 2008; Paul R Gray, Paul J Hurst, Stephen H Lewis, and Robert G Meyer. Analysis and design of analog integrated circuits. John Wiley & Sons, 2009; Phillip E Allen and Douglas R Holberg. CMOS analog circuit design. Elsevier, 2011; Hans Camenzind. Designing analog chips. Virtualbookworm Publishing, 2005). In addition, an example embodiment may apply data augmentation techniques to expand these circuit topologies by over 70×. As understood, this is the largest circuit dataset that effectively incorporates and enhances existing real-world analog circuit topologies to the greatest extent. This enables AnalogGenie to effectively learn various analog topologies and significantly enhance its generation capabilities, surpassing all previous methods (Zehao Dong, Weidong Cao, Muhan Zhang, Dacheng Tao, Yixin Chen, and Xuan Zhang. Cktgnn: Circuit graph neural network for electronic design automation. arXiv preprint arXiv: 2308.16406, 2023; Chen-Chia Chang, Yikang Shan, Shaoze Fan, Jing Li, Shun Zhang, Ningyuan Cao, Yiran Chen, and Xin Zhang. Lamagic: Language-model-based topology generation for analog integrated circuits. arXiv preprint arXiv: 2407.18269, 2024; Yao Lai, Sungyoung Lee, Guojin Chen, Souradip Poddar, Mengkang Hu, David Z Pan, and Ping Luo. Analogcoder: Analog circuit design via training-free code generation. arXiv preprint arXiv: 2405.14918, 2024).

Nonetheless, another key barrier to advancing the scalable design of analog circuits is short of a scalable and unambiguous representation of circuit topologies. AnalogCoder (Yao Lai, Sungyoung Lee, Guojin Chen, Souradip Poddar, Mengkang Hu, David Z Pan, and Ping Luo. Analogcoder: Analog circuit design via training-free code generation. arXiv preprint arXiv: 2405.14918, 2024) relies on high-level text representations that use multiple tokens to describe a single connection between devices, making the generation prone to errors. CktGNN (Zehao Dong, Weidong Cao, Muhan Zhang, Dacheng Tao, Yixin Chen, and Xuan Zhang. Cktgnn: Circuit graph neural network for electronic design automation. arXiv preprint arXiv: 2308.16406, 2023) and LaM-AGIC (Chen-Chia Chang, Yikang Shan, Shaoze Fan, Jing Li, Shun Zhang, Ningyuan Cao, Yiran Chen, and Xin Zhang. Lamagic: Language-model-based topology generation for analog integrated circuits. arXiv preprint arXiv: 2407.18269, 2024) use graph-based representations with a fixed number of nodes, where each node represents a circuit device or subgraph. This ignores the critical low-level details essential in analog circuit design, leading to ambiguous and unscalable circuit generation. An example embodiment proposes a scalable sequence-style data structure that captures fundamental analog circuit design details while efficiently describing large circuit graphs. Specifically, an example embodiment represents each circuit topology as an undirected graph where each node is a device pin (FIG. 6B). An example embodiment then sequentializes it into an Eulerian circuit-a trail (traversal path) that visits every edge exactly once and starts and ends at the same node. This unique representation allows AnalogGenie to generate circuit topologies in a scalable, flexible, and efficient manner. These developed dataset and techniques can thus enable AnalogGenie with exceptional capabilities to produce diverse, large, and unseen analog circuit topologies. The advancement holds both profound engineering and scientific significance, demonstrating that generative AI can not only meet human expertise but also unlock the possibilities beyond human capability.

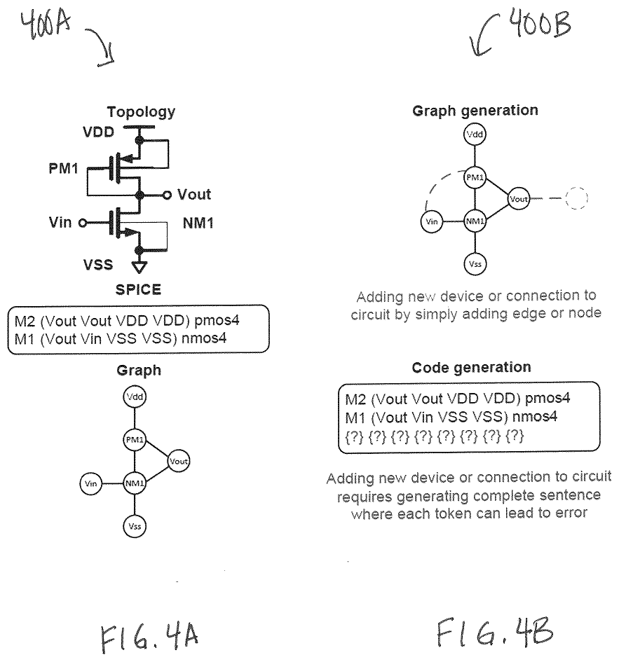

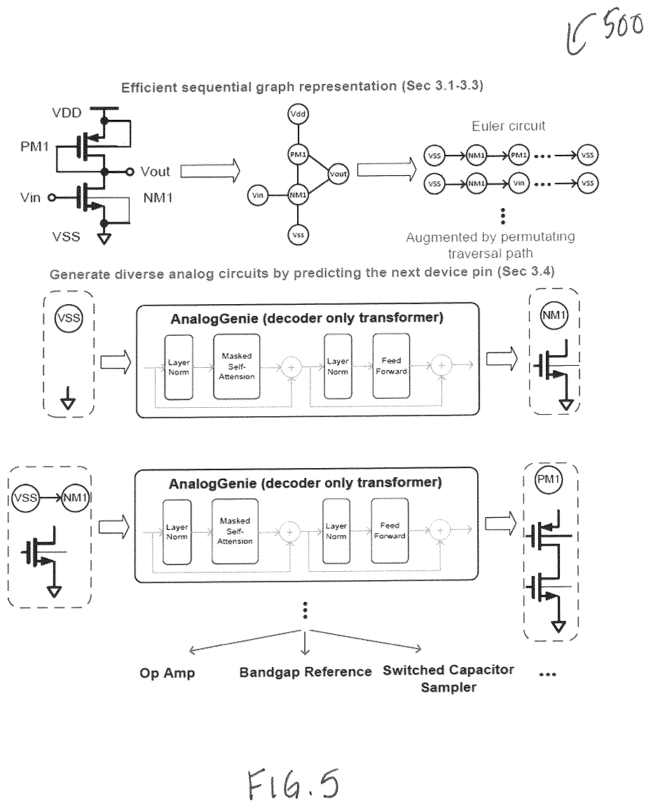

FIGS. 4A and 4B show current states of analog circuit topology generation.

FIG. 4A is a typical data representation for analog circuit topology.

FIG. 4B is an existing analog circuit topology generation paradigm. Graph provides a clear one-to-one mapping between the graph generation process and the circuit design process. PySpice code is a high-level representation, making its generation process more prone to error.

Contributions disclosed herein include: (1) a generative engine, AnalogGenie, built on a GPT model to generate diverse analog circuits by predicting the next device pin to connect in the circuit; (2) introduction of a sequence-based, pin-level graph representation that efficiently and expressively captures large analog circuit topologies; (3) development of a comprehensive dataset of analog circuit topologies to advance research in analog electronic design automation using generative AI and introduce an augmentation scheme to enhance data diversity. (4) Experiment results show that AnalogGenie is capable of automatically generating far more, large-scale, valid, unseen, and high-performance topologies compared to existing graph generation and foundation model work.

### 2 Preliminaries and Related Works

### 2.1 Design Processes of Analog Circuits

The design process of analog circuits begins with creating the circuit topology, which involves determining the device types (i.e., NMOS/PMOS transistor, capacitor, resistor, inductor, etc.) and the number of devices, and defining how they are interconnected. Following this, designers perform device sizing, i.e., optimizing the physical dimensions of devices to achieve desired performance. Finally, the physical layout (i.e., mask design) is developed to prepare for manufacturing. Note that a physical design is the representation of an IC in terms of planar geometric shapes corresponding to the different stacked physical layers (e.g., metal, oxide, or semiconductor) during the fabrication process. Of all these stages, topology design demands the most creative effort, as it needs to be conceptualized from scratch by human designers. While significant progress has been made in automating device sizing (Hanrui Wang, Kuan Wang, Jiacheng Yang, Linxiao Shen, Nan Sun, Hae-Seung Lee, and Song Han. Gcn-rl circuit designer: Transferable transistor sizing with graph neural networks and reinforce-ment learning. In 2020 57th ACM/IEEE Design Automation Conference (DAC), pp. 1-6. IEEE, 2020; Weidong Cao, Mouhacine Benosman, Xuan Zhang, and Rui Ma. Domain knowledge-infused deep learning for automated analog/radio-frequency circuit parameter optimization. In Proceedings of the 59th ACM/IEEE Design Automation Conference, pp. 1015-1020, 2022; Jian Gao, Weidong Cao, and Xuan Zhang. Rose: Robust analog circuit parameter optimization with sampling-efficient reinforcement learning. In 2023 60th ACM/IEEE Design Automation Conference (DAC), pp. 1-6. IEEE, 2023; Weidong Cao, Jian Gao, Tianrui Ma, Rui Ma, Mouhacine Benosman, and Xuan Zhang. Rose-opt: Robust and efficient analog circuit parameter optimization with knowledge-infused reinforcement learning. IEEE Transactions on Computer-Aided Design of Integrated Circuits and Systems, 2024) and layout design (Kishor Kunal, Meghna Madhusudan, Arvind K Sharma, Wenbin Xu, Steven M Burns, Ramesh Harjani, Jiang Hu, Desmond A Kirkpatrick, and Sachin S Sapatnekar. Align: Open-source analog layout automation from the ground up. In Proceedings of the 56th Annual Design Automation Conference 2019, pp. 1-4, 2019; Biying Xu, Keren Zhu, Mingjie Liu, Yibo Lin, Shaolan Li, Xiyuan Tang, Nan Sun, and David Z Pan. Magical: Toward fully automated analog ic layout leveraging human and machine intelligence. In 2019 IEEE/ACM International Conference on Computer-Aided Design (ICCAD), pp. 1-8. IEEE, 2019), the topology generation remains a challenging problem due to its abstract and complex nature. This work aims to address this thorny issue.

### 2.2 Generative AI for Analog Circuit Topology Generation

An analog circuit topology can be naturally represented as a graph structure, providing a clear one to-one mapping between graph generation and topology design (FIG. 4A). For instance, adding a node to a graph corresponds directly to adding a new device to a circuit topology, while adding an edge between nodes represents a new connection between devices. This intuitive representation has led most existing topology generation methods to focus on graph generation (FIG. 4B), such as CktGNN (Zehao Dong, Weidong Cao, Muhan Zhang, Dacheng Tao, Yixin Chen, and Xuan Zhang. Cktgnn: Circuit graph neural network for electronic design automation. arXiv preprint arXiv: 2308.16406, 2023) and LaMagic (Chen-Chia Chang, Yikang Shan, Shaoze Fan, Jing Li, Shun Zhang, Ningyuan Cao, Yiran Chen, and Xin Zhang. Lamagic: Language-model-based topology generation for analog integrated circuits. arXiv preprint arXiv: 2407.18269, 2024). Yet, these approaches are often limited to generating only a single type of circuit topology (e.g., Op-Amps or power converters). This is because they rely on one-shot generation by predicting the adjacency matrix directly and pre-define the number of nodes for generation, thereby suffering from low scalability (Yanqiao Zhu, Yuanqi Du, Yinkai Wang, Yichen Xu, Jieyu Zhang, Qiang Liu, and Shu Wu. A survey on deep graph generation: Methods and applications. In Learning on Graphs Conference, pp. 47-1. PMLR, 2022). In contrast, our work employs sequential graph generation (Section 3), offering far greater flexibility and more adaptability to various types of circuit designs.

An analog circuit can also be compiled into a SPICE (Simulation Program with Integrated Circuit Emphasis) netlist (FIG. 4A). A SPICE netlist is a text-based high-level description of the connection between devices (i.e., nets) in a circuit topology, which is used in the process of circuit performance simulation. Leveraging the powerful code and text generation capabilities of LLMs, recent work, AnalogCoder (Yao Lai, Sungyoung Lee, Guojin Chen, Souradip Poddar, Mengkang Hu, David Z Pan, and Ping Luo. Analogcoder: Analog circuit design via training-free code generation. arXiv preprint arXiv: 2405.14918, 2024), applies domain-specific prompt engineering to existing LLMs to generate Python-style SPICE (i.e., PySpice) netlists for analog circuits. However, the availability of publicly accessible SPICE netlist data remains significantly limited compared to the wealth of publicly available analog circuit topologies. This is because analog circuit topologies are human-readable illustrations commonly found in textbooks and scientific publications, whereas netlists are software-oriented representations often used together with confidential semiconductor technologies to extract circuit performance by simulation tools. Another key challenge faced by code generation approaches is their reliance on high-level text-based circuit topology representations. Specifically, to add a new device or connection, autoregressive models must predict multiple tokens to generate a complete line of code (FIG. 4B), making them more prone to errors compared to graph-based methods, which require only a single action per step. AnalogCoder (Yao Lai, Sungyoung Lee, Guojin Chen, Souradip Poddar, Mengkang Hu, David Z Pan, and Ping Luo. Analogcoder: Analog circuit design via training-free code generation. arXiv preprint arXiv: 2405.14918, 2024) shows that even advanced models (e.g., GPT-4) struggle to correctly generate simple circuits with fewer than 10 devices. Thus, an example embodiment disclosed herein may focus on graph generation to achieve a more robust and scalable generation.

### 2.3 Open-Source Analog Circuit Datasets

The lack of a comprehensive analog circuit dataset fundamentally hinders the development of generative AI-based methods to automate the design of analog ICs. While some circuit datasets exist in the field, such as those provided by Align (Kishor Kunal, Meghna Madhusudan, Arvind K Sharma, Wenbin Xu, Steven M Burns, Ramesh Harjani, Jiang Hu, Desmond A Kirkpatrick, and Sachin S Sapatnekar. Align: Open-source analog layout automation from the ground up. In Proceedings of the 56th Annual Design Automation Conference 2019, pp. 1â€″4, 2019), CktGNN (Zehao Dong, Weidong Cao, Muhan Zhang, Dacheng Tao, Yixin Chen, and Xuan Zhang. Cktgnn: Circuit graph neural network for electronic design automation. arXiv preprint arXiv: 2308.16406, 2023), and AMSNet (Zhuofu Tao, Yichen Shi, Yiru Huo, Rui Ye, Zonghang Li, Li Huang, Chen Wu, Na Bai, Zhiping Yu, Ting-Jung Lin, et al. Amsnet: Netlist dataset for ams circuits. arXiv preprint arXiv: 2405.09045, 2024), they are often limited to specific types of analog circuits (i.e., Op-Amp) without any label (e.g., circuit performance). In addition, most of their topologies are synthesized by permutating pre-defined template, resulting in non-unique designs. To address this fundamental gap, a thorough dataset was created by collecting 3350 distinct analog circuit topologies with di-verse functionalities (e.g., LDO, Bandgap reference, Comparator, PLL, LNA, PA, Mixer, VCO, etc) from public resources (Behzad Razavi. Design of Analog CMOS Integrated Circuits. McGraw-Hill, Inc., USA, 1 edition, 2000. ISBN 0072380322; Behzad Razavi and Razavi Behzad. RF microelectronics, volume 2. Prentice hall New York, 2012; David A Johns and Ken Martin. Analog integrated circuit design. John Wiley & Sons, 2008; Paul R Gray, Paul J Hurst, Stephen H Lewis, and Robert G Meyer. Analysis and design of analog integrated circuits. John Wiley & Sons, 2009; Phillip E Allen and Douglas R Holberg. CMOS analog circuit design. Elsevier, 2011; Hans Camenzind. Designing analog chips. Virtualbookworm Publishing, 2005). To ensure accurate connections, each schematic is manually drawn in an industry-standard circuit design tool for performance simulation. Each circuit is also labeled with its performance metrics.

### 3 Approach

AnalogGenie is a domain-specific GPT model designed to generate various analog circuit topologies with greatly improved scalability. To achieve this, an expressiveness-enhanced graph representation that models each device pin as an individual node is introduced, ensuring that every connection and interaction between circuit devices is explicitly represented. Next, a sequence-style data structure is developed to effectively handle large-scale analog circuits that can be typically modeled as large and sparse graphs. To further enhance the generation quality of AnalogGenie, an example embodiment proposes a data augmentation technique to address both data scarcity and the permutation invariance issue inherent in sequence data. Building upon these innovations, an example embodiment customizes a tokenizer to pre-train AnalogGenie and perform finetuning afterward, enabling AnalogGenie to generate specific type of high-performance circuits.

### 3.1 Expressiveness-Enhanced Graph Representation for Topology Modeling

Prior works (Zehao Dong, Weidong Cao, Muhan Zhang, Dacheng Tao, Yixin Chen, and Xuan Zhang. Cktgnn: Circuit graph neural network for electronic design automation. arXiv preprint arXiv: 2308.16406, 2023; Jialin Lu, Liangbo Lei, Jiangli Huang, Fan Yang, Li Shang, and Xuan Zeng. Automatic op-amp generation from specification to layout. IEEE Transactions on Computer-Aided Design of Integrated Circuits and Systems, 2023) rely on high-level graph representations to generate circuit topologies, where each node represents a device or a subgraph. This method omits essential low-level device details, leading to the issue of ambiguous generation, i.e., a single generated Prior works (Zehao Dong, Weidong Cao, Muhan Zhang, Dacheng Tao, Yixin Chen, and Xuan Zhang. Cktgnn: Circuit graph neural network for electronic design automation. arXiv preprint arXiv: 2308.16406, 2023; Jialin Lu, Liangbo Lei, Jiangli Huang, Fan Yang, Li Shang, and Xuan Zeng. Automatic op-amp generation from specification to layout. IEEE Transactions on Computer-Aided Design of Integrated Circuits and Systems, 2023) rely on high-level graph representations to generate circuit topologies, where each node represents a device or a subgraph. This method omits essential low-level device details, leading to the issue of ambiguous generation, i.e., a single generated graph can be interpreted as multiple unique topologies. To understand this, consider that an NMOS transistor (NM) has four device pins-drain (D), gate (G), source(S), and body (B). When an entire device is abstracted into a single node, it becomes challenging to interpret to which pin an edge connects (FIG. 6A). Therefore, to ensure a unique one-on-one mapping between the graph and the circuit topology—where every circuit connection is explicitly represented, an analog circuit has to be represented at the pin level (FIG. 6B). Furthermore, previous methods restricted the graph representation of analog circuit topologies to directed acyclic graphs (DAGs), greatly limiting the types of circuit topologies that can be learned and generated. In this work, a more expressive and flexible representation of analog circuit topologies is adopted. Specifically, the topology of an analog circuit is represented as a finite connected undirected graph G=(V,E), where V={1, 2, . . . , n} is the node set representing each device pin with |V|=n and E∈V×V is the edge set. For each node i in a graph G, let N(v)={u∈V|(u, v)∈E} denote the set of neighboring nodes of v.

FIG. 5 is an overview 500 of an example embodiment of AnalogGenie. In the overview 500, AnalogGenie represents each topology as a sequence and generates all sorts of analog circuit topology from scratch by predicting the device pin to connect.

### 3.2 Sequential Graph Representation of Scalable Analog Circuit Topologies

Previous methods (Zehao Dong, Weidong Cao, Muhan Zhang, Dacheng Tao, Yixin Chen, and Xuan Zhang. Cktgnn: Circuit graph neural network for electronic design automation. ar Xiv preprint arXiv: 2308.16406, 2023; Jialin Lu, Liangbo Lei, Jiangli Huang, Fan Yang, Li Shang, and Xuan Zeng. Automatic op-amp generation from specification to layout. IEEE Transactions on Computer-Aided Design of Integrated Circuits and Systems, 2023) use adjacency matrices to represent circuit graphs. Yet, an adjacency matrix requires O(n²) space to store n nodes, regardless of the number of edges, which is inefficient for sparse graphs. Analog circuit topologies are typically sparse because most devices are connected only to their immediate neighbors. As a result, the number of edges e is far smaller than n², leaving the adjacency matrix filled with zeros and wasting significant space on non-existent edges. For example, the graph in FIG. 5 has six nodes and six undirected edges or 12 directed edges. An adjacent matrix will need 6×6 matrices to represent them, wasting 24 elements to store nothing. In contrast, our work represents the graph as an Eulerian circuit that stores only existing edges, making it much more efficient than adjacency matrices, particularly for handling large analog circuit topologies. More examples of the advantages of using the Eulerian circuit to represent large sparse graphs can be found in Appendix A.3.

Definition 3.2.1: Eulerian circuit is a graph trail that visits every edge exactly once and starts and ends at the same node.

Theorem 3.2.1: Let G=(V, E) be a finite connected undirected graph. Construct a directed graph D=(V, A) by replacing each undirected edge {u, v}∈E with two directed arcs (u, v) and (v, u) in A. Then, the directed graph D contains at least one Eulerian circuit starting from any node.

Proof. Since directed graph D=(V, A) is derived from a finite connected undirected graph G=(V, E), all of D's node will have even degree and directed graph D is connected. According to Euler theorem (Norman Biggs, E Keith Lloyd, and Robin J Wilson. Graph Theory, 1736-1936. Oxford University Press, 1986), if a graph is connected and every node has even degree, then it has at least one Eulerian circuit. The Eulerian circuits can start at any vertex. Thus, the directed graph D contains at least one Eulerian circuit starting from any vertex.

Theorem 3.2.1 clearly shows that all analog topologies have at least one Eulerian circuit once the original finite connected undirected graph G is converted into a finite connected directed graph D. Thus, the Eulerian circuit can represent any analog circuits as long as they can be represented as finite connected undirected graph (i.e., Eulerian circuit traverse each directed edge exactly once when converting finite connected undirected graph to finite connected directed graph).

### 3.3 Data Augmentation to Prevent Over-Fitting and Reduce Inductive Bias

Conventional graph-based generation circuit methods (Zehao Dong, Weidong Cao, Muhan Zhang, Dacheng Tao, Yixin Chen, and Xuan Zhang. Cktgnn: Circuit graph neural network for electronic design automation. arXiv preprint arXiv: 2308.16406, 2023; Chen-Chia Chang, Yikang Shan, Shaoze Fan, Jing Li, Shun Zhang, Ningyuan Cao, Yiran Chen, and Xin Zhang. Lamagic: Language-model-based topology generation for analog integrated circuits. arXiv preprint arXiv: 2407.18269, 2024) rely on synthetic circuit data to mitigate model overfitting by permutating circuit connections under a fixed number of nodes. Models trained on such data fail to capture the full complexity and nuances of real-world circuits, limiting their ability to generate only a single type of analog circuits. In addition to the overfitting, another critical issue that significantly impacts the model's learning ability is the inherent bias in data representation. Permutation invariance is a fundamental inductive bias of graph-structured data. For a graph with n nodes, there are up to n! different adjacency matrices that are equivalent representations of the same graph. A well-designed circuit generative model should assign the same probability to each of these equivalent representations.

To address these limitations, AnalogGenie learns from real-world circuits with diverse circuit types and their augmented representations. Specifically, AnalogGenie learns diverse representations from each analog circuit topology by generating multiple unique Eulerian circuits that represent the same topology. This allows us to generate 70×more data. Eulerian circuits ensure each sequence traverses each directed edge exactly once. To enforce graph-level permutation invariance, AnalogGenie adopt the approach used by GraphRNN (Jiaxuan You, Rex Ying, Xiang Ren, William Hamilton, and Jure Leskovec. Graphrnn: Generating realistic graphs with deep auto-regressive models. In International conference on machine learning, pp. 5708-5717. PMLR, 2018), employing a breadth-first-search (BFS) method to assign node orders within each device type, ensuring that each circuit topology has a unique graph representation. To further minimize permutation invariance at the sequence level, AnalogGenie manually defines “VSS” (the ground node universal to all analog circuits) as the starting node for all sequences. These techniques let AnalogGenie to learn a robust and generalizable representation.

### 3.4 Customizing Tokenizer to Pre-Train a Domain-Specific Gpt Model

Built on the above foundations, an example embodiment customizes a tokenizer to encode and decode our sequence that represents the circuit topology to train AnalogGenie. Table 2 in Appendix A.2 shows an example of a look-up table used for tokenization, where each token represent a device pin. The device type and the maximum number of devices in each device type are determined through a data-driven method by scanning the devices types and number in the training data. To allow AnalogGenie to generate topologies with different numbers of devices, an example embodiment introduces a special “Truncate” token and use padding to ensure that all sequences have the same length.

With this customized tokenizer, an example embodiment pre-trains AnalogGenie to predict the next device pin in the sequence. Unlike traditional pre-training of LLMs, which often involves randomly cropping sequences from text documents, AnalogGenie's pre-training ensures that each sequence corresponds to a complete circuit topology. Specifically, given an unsupervised corpus of tokens U={u₁, . . . , uₙ} that represent one circuit topology, aiming to maximize the standard language modeling objective (Alec Radford. Improving language understanding by generative pre-training. 2018) to train AnalogGenie. During generation, AnalogGenie begins with a single context token, “VSS” (the starting node for all Eulerian circuits) and completes the rest of the sequence, ensuring it represents a valid circuit topology. The pre-trained AnalogGenie model is capable of learning from various circuit topologies without requiring knowledge of their performance or specific circuit types. An example embodiment can then further fine-tune it to target high-performance, unseen circuits for a particular task following the typical manner of reinforcement learning with human feedback.

FIG. 6A is a representation of a device level graph representation 600A.

FIG. 6B is a representation of an example embodiment of a device pin level graph representation 600B. FIGS. 6A and 6B provide a comparison between two different circuit graph representations. FIG. 6A is an example showing the limitation of device level graph representation 600A used by previous graph generation work (Zehao Dong, Weidong Cao, Muhan Zhang, Dacheng Tao, Yixin Chen, and Xuan Zhang. Cktgnn: Circuit graph neural network for electronic design automation. arXiv preprint arXiv: 2308.16406, 2023; Jialin Lu, Liangbo Lei, Jiangli Huang, Fan Yang, Li Shang, and Xuan Zeng. Automatic op-amp generation from specification to layout. IEEE Transactions on Computer-Aided Design of Integrated Circuits and Systems, 2023), which oversimplified the analog circuit connection and led to non-unique mapping from graph to circuit topology during generation. The example embodiment of the device pin-level graph representation 600B ensures there is a unique mapping between each graph and circuit topology and is able to explicitly represent every connection in a circuit topology.

### 4 Results

### 4.1 Experiment Setup

Dataset and AnalogGenie setup. Our circuit dataset contains 3350 distinct topologies, spanning 11 circuit types: Op-Amps, LDOs, Bandgap references, Comparators, PLLs, LNAs, PAs, Mixers, VCOs, Power converters, and Switched Capacitor Samplers. The largest circuit comprises 54 devices. The performance of circuits has been evaluated with circuit simulator and thus been labeled. The detailed statistics are shown in Appendix A.1. During training, an example embodiment may first split the topology data set into train and validation sets with a 9 to 1 ratio. Then, the data augmentation technique in Section 3.3 can be leveraged to generate 70×unique sequences of these circuit topologies. This ensures that all the topologies in the validation set are unseen. Our AnalogGenie model is a decoder-only transformer including 6 hidden layers and 6 attention heads with 11.825 million parameters in total. The vocab size is 1029. The maximum sequence length is 1024.

Baselines. A comparison of AnalogGenie with recent approaches was performed for analog circuit generation, i.e., Ck-tGNN (Zehao Dong, Weidong Cao, Muhan Zhang, Dacheng Tao, Yixin Chen, and Xuan Zhang. Cktgnn: Circuit graph neural network for electronic design automation. arXiv preprint arXiv: 2308.16406, 2023) based on VAE, and LaMAGIC (Chen-Chia Chang, Yikang Shan, Shaoze Fan, Jing Li, Shun Zhang, Ningyuan Cao, Yiran Chen, and Xin Zhang. Lamagic: Language-model-based topology generation for analog integrated circuits. arXiv preprint arXiv: 2407.18269, 2024) and AnalogCoder (Yao Lai, Sungyoung Lee, Guojin Chen, Souradip Poddar, Mengkang Hu, David Z Pan, and Ping Luo. Analogcoder: Analog circuit design via training-free code generation. arXiv preprint arXiv: 2405.14918, 2024) built on foundation models. These methods are different from AnalogGenie in circuit representation, generation capability and scalability as introduced in Section 2.2. The original work was followed to produce the baseline results.

Evaluation task and metrics. Focus was made on evaluating the generative capabilities of AnalogGenie and baseline models. Specifically, we employ each model to generate topologies for various circuits, including Op-Amps, bandgap references, and power converters, and assess the outcomes based on four key criteria: correctness, scalability, novelty, and performance. (1) Correctness: A standard circuit simulator was used to determine whether the generated circuits are simulatable with default sizing, checking for issues such as floating and shorting nodes (i.e., open and short circuits). Circuits that are simulatable are considered valid. (2) Scalability: Scalability was measured by recording the number of circuit types and the largest valid circuit generated by each model, based on the number of devices. (3) Novelty: Novelty of generated topologies was assessed by comparing them to existing ones in the dataset. A topology is deemed novel if it differs from all known topologies in the datasets. (4) Performance: Each generated topology was sized using a genetic method and use the figure-of-merit (FoM) that considers all major metrics (e.g., gain, bandwidth, power for Op-Amps), as a comprehensive indicator to represent the circuit performance. The best FoM of the circuits generated by each model were compared.

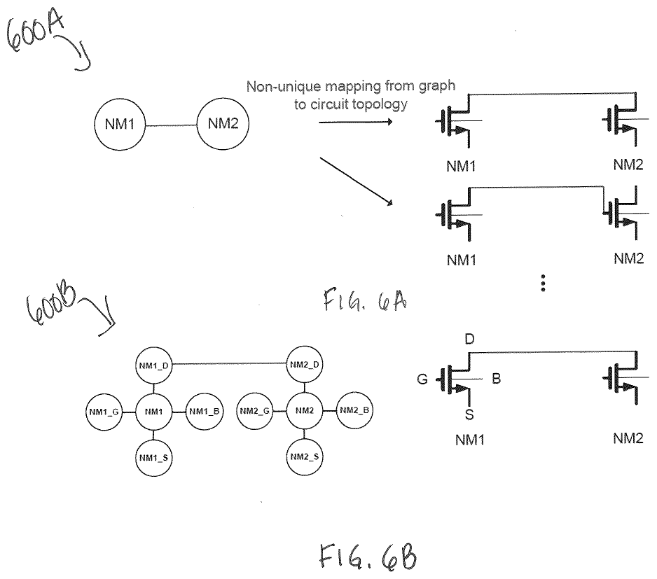

FIG. 7 is a graph 700 of loss comparisons between AnalogGenie pretrained with unaugmented data and augmented data. An example embodiment of an augmentation method disclosed herein is able to improve validation loss around 8.5×.

4.2 Enhanced Generation Capabilities with Data Augmentation

This section begins by examining the impact of the proposed data augmentation technique on the learning capabilities of AnalogGenie. The unaugmented training dataset include only 3015 unique sequences due to the train and validation split, with each sequence representing a distinct circuit topology. FIG. 7 compares the training performance of AnalogGenie using unaugmented data (3015 sequences) against augmented data (227766 sequences). The results demonstrate that our augmentation technique reduces validation loss by approximately 8.5×. How this improvement influences the quality of circuit generation was also evaluated. The results indicate that without augmentation, AnalogGenie struggled with overfitting, leading to failures in generating valid circuits. In contrast, augmentation significantly enhances generation quality, increasing the number of valid circuits by 73.5× as shown in Table 1.

TABLE 1
Performance comparison between AnalogGenie and existing
analog circuit topology generation work.

| | | Topology scale ↑ | | | | | |
|---|---|---|---|---|---|---|---|
| | Valid | | Number | Novel | FoM ↑ | | |
| | circuits | Topology | of | circuits | Op- | Power | |
| Evaluation Metric | (%) ↑ | type | devices | (%) ↑ | Amp | Converter | Bandgap |
| CktGNN | 67.5 | 1 | 22 | 93.1 | 10.9 | — | — |
| LaMAGIC | 68.2 | 1 | 4 | 12.7 | — | 2.2 | — |
| AnalogCoder | 57.3 | 7 | 10 | 8.9 | 1.7 | — | — |
| AnalogGenie | 1 | >11 | 20 | 82.1 | 0 | 0 | 0 |
| (unaug + pretrain) | | | | | | | |
| AnalogGenie | 73.5 | >11 | 63 | 98.9 | 19.3 | 2.5 | 17.2 |
| (aug + pretrain) | | | | | | | |
| AnalogGenie | 93.2 | >11 | 56 | 99 | 36.5 | 3.3 | 21.9 |
| (aug + pretrain + finetune) | | | | | | | |

4.3 Comparisons with State-of-the-Arts

Next, AnalogGenie was compared with existing VAE model (CktGNN (Zehao Dong, Weidong Cao, Muhan Zhang, Dacheng Tao, Yixin Chen, and Xuan Zhang. Cktgnn: Circuit graph neural network for electronic design automation. arXiv preprint arXiv: 2308.16406, 2023)) and foundation models (LaMAGIC (Chen-Chia Chang, Yikang Shan, Shaoze Fan, Jing Li, Shun Zhang, Ningyuan Cao, Yiran Chen, and Xin Zhang. Lamagic: Language-model-based topology generation for analog integrated circuits. arXiv preprint arXiv: 2407.18269, 2024) and AnalogCoder (Yao Lai, Sungyoung Lee, Guojin Chen, Souradip Poddar, Mengkang Hu, David Z Pan, and Ping Luo. Analogcoder: Analog circuit design via training-free code generation. arXiv preprint arXiv: 2405.14918, 2024)) addressing the problem of analog circuit topology generation. The comparisons are shown in Table 1.

Correctness: AnalogCoder generates only 57.3% valid circuits, primarily due to the error-prone nature of code generation. CktGNN and LaMAGIC, which employ graph generation techniques, achieve slightly better results, with 67.5% and 68.2% valid circuits, respectively. They rely on high-level graph representations, which pose interpretability issues (i.e., ambiguous connections between devices), as discussed in Section 3.1. In contrast, AnalogGenie uses an expressive device pin-level representation, where each connection is explicitly defined, eliminating the mapping issues seen with the other models. As such, AnalogGenie demonstrates superior correctness, achieving 73.5% valid circuits after pretraining and an impressive 93.2% after fine-tuning.

Scalability: CktGNN and LaMAGIC are developed for specific types of circuits, such as Op-Amps or power converters, which limits their ability to generate beyond those particular types. AnalogCoder is able to design 7 circuit types. AnalogGenie demonstrates a zero-shot capability to generate circuit types outside its training set, which includes 11 analog circuit types, as shown in Appendix A.4.2.

Beyond topology types, LaMAGIC is constrained by its graph representation, which contains only four device nodes, preventing it from generating larger circuits. CktGNN has a similar limitation with its fixed-node graph representation, which supports at most 22 devices. AnalogCoder also struggles with scalability, making it capable of generating circuit topologies with a maximum of 10 devices. This restriction arises from its prompt template, which requires users to specify small circuit examples with limited device counts, leading the GPT model to generate circuits of similar size. In contrast, AnalogGenie benefits from a comprehensive dataset, which includes topologies with over 50 devices. Its sequential representation efficiently captures these larger designs, enabling AnalogGenie to generate circuits with up to 64 devices after pretraining and 56 devices after fine-tuning, all within a limited sequence length. Novelty (unseen designs): AnalogCoder generates only 8.9% novel circuits, as it is designed pri-marily for task completion rather than exploring new topologies. LaMAGIC, limited to circuits with just four devices, produces 12.7% novel circuits. CktGNN, with its graph model supporting up to 22 device nodes, achieves 93.1% novel circuit discovery. Remarkably, AnalogGenie generates nearly 100% novel circuits, leveraging its ability to design large circuits from scratch. Visualizations of these novel circuits are provided in Appendix A.4.1

Performance: For Op-Amp design, AnalogCoder achieves a low FoM of just 1.7, constrained by the limited design options available through its prompt engineering. CktGNN performs significantly better with a FoM of 10.9, though it is still restricted by the lack of detailed low-level design control. AnalogGenie, with its expressive graph structure and flexible bottom-up generation method, initially achieves a FoM of 19 after pre-training. However, following fine-tuning with a focus on high-performance Op-Amp design, AnalogGenie makes impressive gains, reaching a FoM of 36.5. In power converter design, AnalogGenie performs similarly to LaMAGIC, achieving a FoM of 2.5 compared to LaMAGIC's 2.2. After fine-tuning, AnalogGenie further improves, discovering topologies that achieve a FoM of 3.3, thanks to its larger design capacity. Lastly, AnalogGenie stands out as the only model capable of designing bandgap reference circuits. Its pre-trained model achieves a FoM of 17.2, while fine-tuning elevates this to an outstanding FoM of 21.9.

In conclusion, AnalogGenie demonstrates unmatched superiority over AnalogCoder, CktGNN, and LaMAGIC across key metrics such as correctness, scalability, novelty, and performance. This ad-vantage stems from its expressive device pin-level graph representation, which ensures precise and accurate circuit generation, combined with its efficient sequential data structure that supports larger, more complex designs. Additionally, its bottom-up generation approach allows for greater flexibility and innovation in circuit topology, enabling AnalogGenie to explore beyond the limitations faced by the other models. These strengths collectively make AnalogGenie a highly versatile and powerful tool for analog circuit topology design.

As disclosed herein, AnalogGenie is introduced, a generative engine built on a GPT model to generate diverse analog circuits by predicting the next device pin to connect within a circuit. AnalogGenie addresses two key gaps in the field: building a comprehensive dataset of analog circuit topology and developing a scalable sequence-based graph representation universal to analog circuits. Experimental results across three types of analog circuit benchmarks demonstrate that an example embodiment of a method disclosed herein can efficiently discover previously unseen circuit topologies in a scalable manner. Given the expressive nature of an example embodiment of a representation disclosed herein and the bottom-up generative approach, it is believed that such method has broader applicability beyond analog circuit topology generation and can be generalized to digital design as well. Ultimately, it is considered that such disclosure may pave the way for the integration of generative AI into IC design, fostering a mutually beneficial relationship where IC design enhances generative AI capabilities, while generative AI accelerates IC design advancements.

AnalogGenie is a comprehensive framework that combines a domain-specific generative engine for discovering analog circuit topologies with a genetic method for optimizing the parameters (e.g., sizing and bias) of the generated topologies. The primary focus of this section is on discovering topologies with a high likelihood of achieving a superior FoM once sized. While the current sizing method is effective, its sample efficiency can be improved by exploring more advanced alternatives (Hanrui Wang, Kuan Wang, Jiacheng Yang, Linxiao Shen, Nan Sun, Hae-Seung Lee, and Song Han. Gen-rl circuit designer: Transferable transistor sizing with graph neural networks and reinforcement learning. In 2020 57th ACM/IEEE Design Automation Conference (DAC), pp. 1-6. IEEE, 2020). Additionally, for digital circuit development, one may consider combining AnalogGenie's graph generation approach with code generation work to enhance its ability.

### 6 Reproducibility Statement

The main theoretical backbone of the disclosure above is Theorem 3.2.1. Its proof is shown in Section 3.2. Furthermore, the experiment setup and implementation details are disclosed in Section 4.1. For the open-sourced circuit dataset, its statistics are provided in Appendix A.1. The code and dataset are planned to be made public on Github in the future.

### A Appendix

### A.1 Dataset Statistics

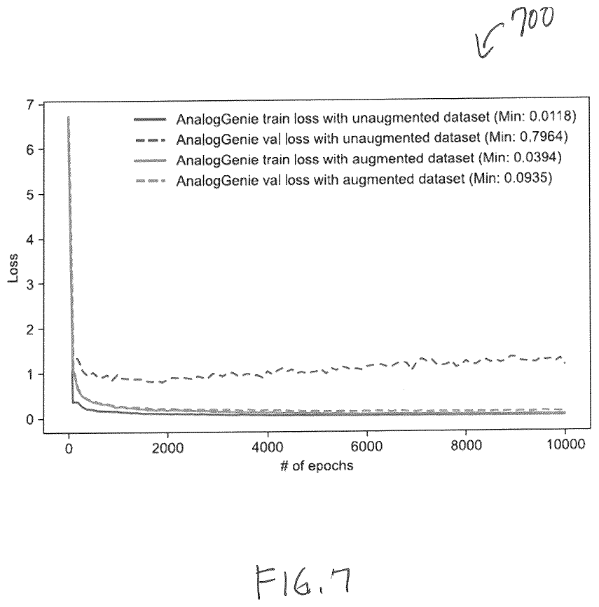

FIG. 8 and FIG. 9 are graphs of statistics of an example embodiment of an open-source dataset. The total number of topologies is 3350, and all of them are unique. FIG. 8 is a graph 800 of an analog circuit dataset's device number distribution. FIG. 9 is a graph 900 of an example embodiment an analog circuit dataset's circuit topology type distribution.

### A.2 Tokenizer Lookup Table

Table 2, disclosed below, shows the tokenizer lookup table used in the experiment. Specifically, the lookup table does not only describe basic devices (e.g., NMOS, PMOS, etc.) but also describes logic gates (e.g., INV, XOR, etc.) that include multiple devices so it can scale up to describe large digital circuits for constructing mixed-signal circuits.

TABLE 2
The tokenizer's look-up table used in the experiment for device to index mapping.

| Device | Index | Device | Index | Device | Index | Device | Index |
|---|---|---|---|---|---|---|---|
| NM1 | 0 | NM1_D | 1 | NM1_G | 2 | NM1_S | 3 |
| NM1_B | 4 | NM2 | 5 | . . . | . . . | NM25_B | 124 |
| PM1 | 125 | PM1_D | 126 | PM1_G | 127 | PM1_S | 128 |
| PM1_B | 129 | PM2 | 130 | . . . | . . . | PM25_B | 249 |
| NPN1 | 250 | NPN1_C | 251 | NPN1_B | 252 | NPN1_E | 253 |
| NPN2 | 254 | . . . | . . . | NPN25_E | 349 | PNP1 | 350 |
| PNP1_C | 351 | PNP1_B | 352 | PNP1_E | 353 | PNP2 | 354 |
| . . . | . . . | PNP25_E | 449 | R1 | 450 | R1_P | 451 |
| R1_N | 452 | R2 | 453 | . . . | . . . | R25_N | 524 |
| C1 | 525 | C1_P | 526 | C1_N | 527 | C2 | 528 |
| . . . | . . . | C25_N | 599 | L1 | 600 | L1_P | 601 |
| L1_N | 602 | L2 | 603 | . . . | . . . | L25_N | 674 |
| DIO1 | 675 | DIO1_P | 676 | DIO1_N | 677 | DIO2 | 678 |
| . . . | . . . | DIO25_N | 749 | XOR1 | 750 | XOR1_A | 751 |
| XOR1_B | 752 | XOR1_VDD | 753 | XOR1_VSS | 754 | XOR1_Y | 755 |
| XOR2 | 756 | . . . | . . . | XOR5_Y | 779 | INV1 | 815 |
| INV1_A | 816 | INV1_Q | 817 | INV1_VDD | 818 | INV1_VSS | 819 |
| INV2 | 820 | . . . | . . . | INV10_VSS | 864 | TG1 | 865 |
| TG1_A | 866 | TG1_B | 867 | TG1_C | 868 | TG1_VDD | 869 |
| TG1_VSS | 870 | TG2 | 871 | . . . | . . . | TG10_VSS | 924 |
| VIN1 | 925 | VIN2 | 926 | VIN3 | 927 | VIN4 | 928 |
| VIN5 | 929 | IIN1 | 930 | IIN2 | 931 | . . . | . . . |
| LOGICQB1 | 1024 | LOGICRB2 | 1025 | VDD | 1026 | VSS | 1027 |
| TRUNCATE | 1028 | | | | | | |

### A.3 More Details About Eulerian Circuit and Data Augmentation

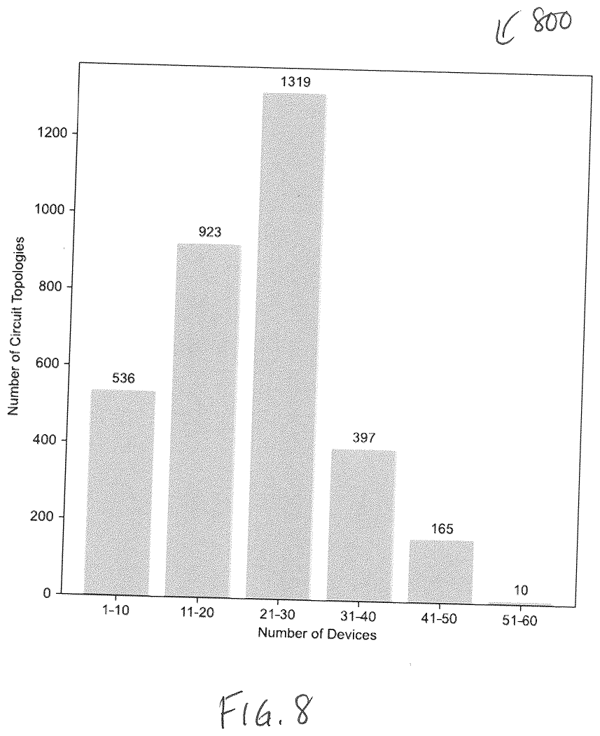

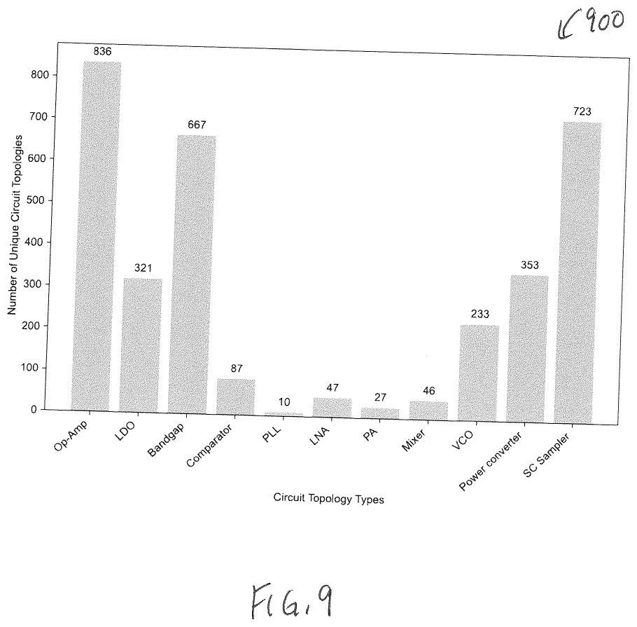

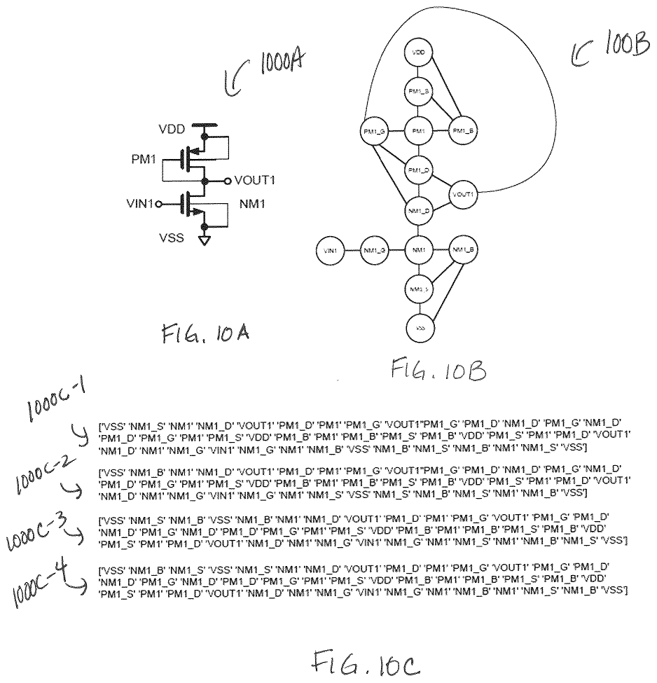

FIG. 10A is an example of an analog circuit topology 1000A.

FIG. 10B is a device pin level graph representation 1000B of the analog circuit topology 1000A of FIG. 10A.

FIG. 10C includes four representations (1000C-1, 1000C-2, 1000C-3, and 1000C-4) of unique Eulerian circuits found by using DFS.

As shown in FIGS. 10A-C, to represent a circuit topology in an expressive way (i.e., device pin level), a small circuit with two devices can lead to a graph with 14 nodes. Using an adjacency matrix to represent it will take 14×14=256 elements. On the other hand, the Eulerian circuit only needs 43 elements, which is around 5.95× smaller than the adjacency matrix representation. For data augmentation, an example embodiment may permutate how the depth-first search (DFS) method explores its neighbor to generate unique Eulerian circuits. The number of Eulerian circuits will drastically increase with the number of devices.

### A.4 Analoggenie'S Generated Circuit Topology Visualization

In this section, non-limiting example embodiments of the novel circuits AnalogGenie generated are disclosed and demonstrate its zero-shot capability by generating circuits that belong to a type that is not included in the dataset. Particularly, to visualize the circuit schematic, all examples are manually drawn in Cadence Virtuoso, which is an industry-standard analog schematic edit tool.

### A.4.1 Novel Circuits

FIG. 11 is a schematic 1100 of an example embodiment of a novel Op-Amp circuit generated by AnalogGenie with GBW=12 MHz, CL=100 pF, Power=32.88 mW, and FoM=36.5.

FIG. 12 is a schematic 1200 of a novel direct current (DC) converter circuit generated by AnalogGenie with Efficiency=0.95, Voltage conversion ratio=2.35, and FoM=3.3.

FIG. 13 is a schematic 1300 of a novel bandgap reference circuit generated by AnalogGenie with TC=3 ppm/° C., Line regulation=0.196%/V, PSRR=70 dB, and FoM=21.9.

### A.4.2 Zero-Shot Generation

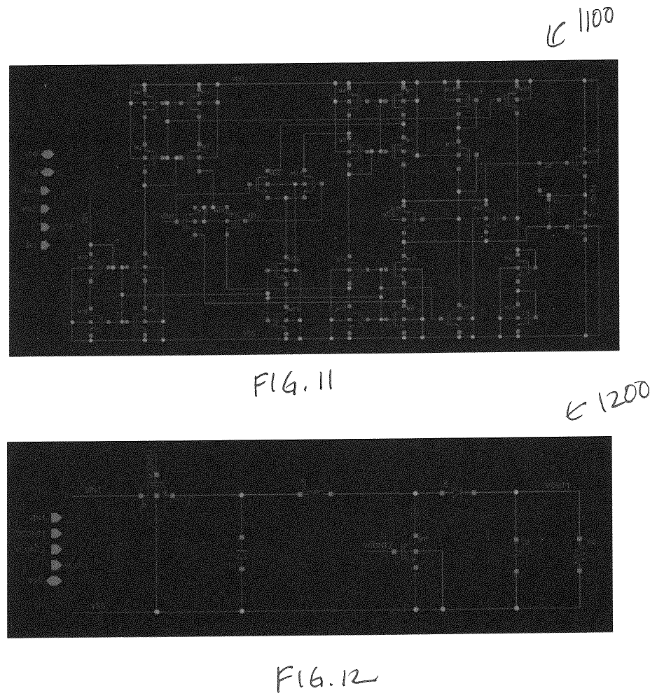

FIG. 14 is a schematic 1400 of an example showing AnalogGenie's zero-shot ability by generating a transconductance amplifier which is a circuit type that is not included in the dataset.

### A.5 Failed Examples Generated by Analoggenie Pre-Trained Model

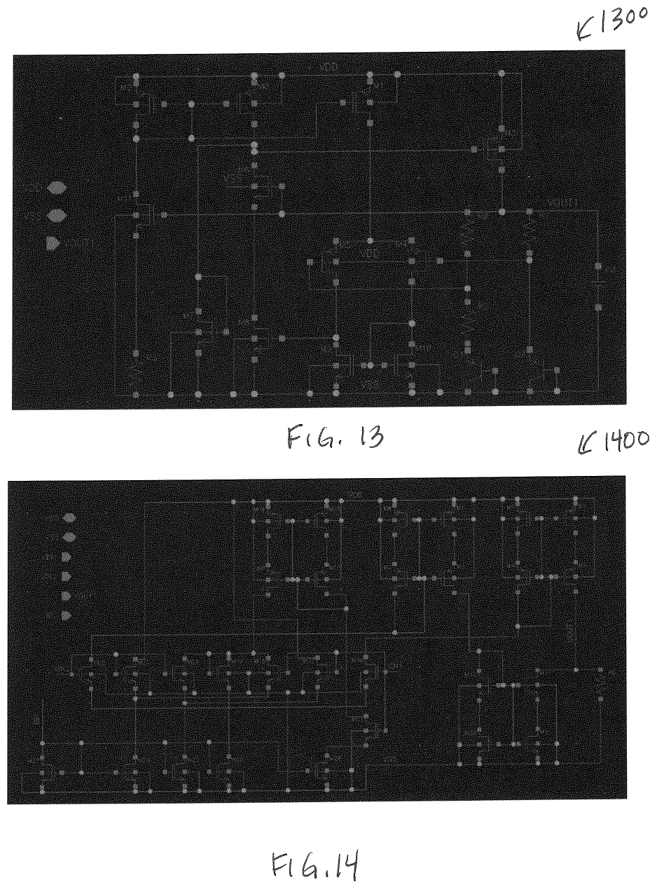

FIG. 15 is a schematic 1500 of a failed example 1.

FIG. 16 is a schematic 1600 of a failed example 2.

AnalogGenie-Lite: Enhancing Scalability and Precision in Circuit Topology Discovery through Lightweight Graph Modeling

The sustainable performance improvements of integrated circuits (ICs) drive the continuous advancement of nearly all transformative technologies. Since its invention, IC performance enhancements have been dominated by scaling the semi-conductor technology. Yet, as Moore's law tapers off, a crucial question arises: How can IC performance be sustained in the post-Moore era? Creating new circuit topologies has emerged as a promising pathway to address this fundamental need. This work proposes AnalogGenie-Lite, a decoder-only Generative engine to discover novel circuit topologies for analog ICs with significantly enhanced scalability and precision through lightweight graph modeling. AnalogGenie-Lite makes several unique contributions, including concise device-pin representations (i.e., advancing the best prior art from O(n²) to O(n)), frequent sub-graph mining, and optimal sequence modeling. Thus, it remarkably pushes the frontier of generative-AI-based methods for analog circuit topology discovery, i.e., 5.15× to 71.11× in scalability and 23.5% to 33.6% improvement in validity, compared to the state-of-the-art. Case studies on social networks and protein graphs are also provided to show the broader applicability of the proposed graph modeling approach.

Nearly every transformative technology over the past several decades, ranging from medical devices and 5G communication to generative AI and quantum computing, has been powered fundamentally by the semiconductor integrated circuits (ICs) technology. The relentless performance improvements of ICs have been the driving force behind the continuous advancement of these innovations and will continue to play a key role in enabling future technological breakthroughs. Historically, remarkable progress in IC performance has been primarily driven by semiconductor process scaling, evolving from 10 μm in the early 1960s to the cutting-edge 2 nm nodes of today—a 5000× in dimension reduction and nearly 100000× in performance improvement. This progression laid the foundation for the well-known Moore's law, which predicts that computing power (i.e., CPU performance) doubles approximately every 18 months-a principle that has shaped the trajectory of modern technology. Yet, the end of Moore's law is looming (Theis, T. N. and Wong, H. S. P. The end of moore's law: A new beginning for information technology. Computing in science & engineering, 19 (2): 41-50, 2017) and the continuous performance enhancements of ICs can no longer be expected from technology scaling, a crucial question thus arises: How can we sustain and advance IC performance in the post-Moore era?

Developing novel circuit topologies, especially for analog ICs, has emerged as a promising pathway to meet this critical challenge (Schuman, C. D., Kulkarni, S. R., Parsa, M., Mitchell, J. P., Date, P., and Kay, B. Opportunities for neuromorphic computing algorithms and applications. Nature Computational Science, 2 (1): 10-19, 2022; Mohseni, N., McMahon, P. L., and Byrnes, T. Ising machines as hardware solvers of combinatorial optimization problems. Nature Reviews Physics, 4 (6): 363-379, 2022; De Leon, N. P., Itoh, K. M., Kim, D., Mehta, K. K., Northup, T. E., Paik, H., Palmer, B., Samarth, N., Sangtawesin, S., and Steuerman, D. W. Materials challenges and opportunities for quantum computing hardware. Science, 372 (6539): eabb2823, 2021). Analog ICs essentially bridge the physical world and cyberspace by dealing with continuous signals and enabling seamless interaction with digital ICs in the cyber domain that handle binary data. Their topologies (i.e., interconnections between different devices) primarily determine the performance, functionality, and efficiency of a circuit once a semiconductor process is finalized to implement the circuit, akin to a protein structure that dictates the generation of amino acids. Yet, unlike their digital counterparts that can be easily synthesized with high-level hardware description languages (e.g., Verilog and VHDL) or programming languages (e.g., C) or even multiple generative AI-based tools (Blocklove, J., Garg, S., Karri, R., and Pearce, H. Chip-chat: Challenges and opportunities in conversational hardware design. In 2023 ACM/IEEE 5th Workshop on Machine Learning for CAD (MLCAD), pp. 1-6. IEEE, 2023, Thakur, S., Ahmad, B., Pearce, H., Tan, B., Dolan-Gavitt, B., Karri, R., and Garg, S. Verigen: A large language model for verilog code generation. ACM Transactions on Design Automation of Electronic Systems, 29 (3): 1-31, 2024; Fu, Y., Zhang, Y., Yu, Z., Li, S., Ye, Z., Li, C., Wan, C., and Lin, Y. C. Gpt4aigchip: Towards next-generation ai accelerator design automation via large language models. In 2023 IEEE/ACM International Conference on Computer Aided Design (ICCAD), pp. 1-9. IEEE, 2023; Wu, H., He, Z., Zhang, X., Yao, X., Zheng, S., Zheng, H., and Yu, B. Chateda: A large language model powered autonomous agent for eda. IEEE Transactions on Computer-Aided Design of Integrated Circuits and Systems, 2024.; Liu, M., Ene, T. D., Kirby, R., Cheng, C., Pinckney, N., Liang, R., Alben, J., Anand, H., Banerjee, S., Bayrak-taroglu, I., et al. Chipnemo: Domain-adapted Ilms for chip design. arXiv preprint arXiv: 2311.00176, 2023), analog ICs have relied on a longstanding handcraft design process. This is mainly due to their inherent complexity, which makes them resistant to the universal and hierarchical abstraction that digital ICs benefit from. Thus, the discovery of novel analog circuit topologies has been significantly limited since the invention of ICs and remains a critical challenge to be addressed.

AI/generative AI has recently emerged as a promising solution for automating analog circuit topology discovery. To facilitate the discovery, pioneering methods have explored two typical representations to model analog circuit topologies, i.e., text (Lai, Y., Lee, S., Chen, G., Poddar, S., Hu, M., Pan, D. Z., and Luo, P. Analogcoder: Analog circuit design via training-free code generation. arXiv preprint arXiv: 2405.14918, 2024; Chen, Z., Huang, J., Liu, Y., Yang, F., Shang, L., Zhou, D., and Zeng, X. Artisan: Automated operational amplifier design via domain-specific large language model. In Proceedings of the 61st ACM/IEEE Design Automation Conference, DAC '24, New York, NY, USA, 2024. Association for Computing Machinery. ISBN 9798400706011. doi: 10.1145/3649329.3655903. URL https://doi. org/10.1145/3649329.3655903) and graph (Dong, Z., Cao, W., Zhang, M., Tao, D., Chen, Y., and Zhang, X. CktGNN: Circuit graph neural network for electronic design automation. In The Eleventh International Conference on Learning Representations, 2023. URL https://openreview.net/forum?id=NE2911Kq1sp; Chang, C. C., Shan, Y., Fan, S., Li, J., Zhang, S., Cao, N., Chen, Y., and Zhang, X. Lamagic: Language-model-based topology generation for analog integrated circuits. arXiv preprint arXiv: 2407.18269, 2024; Gao, J., Cao, W., Yang, J., and Zhang, X. Analoggenie: A generative engine for automatic discovery of analog circuit topologies. In The Thirteenth International Conference on Learning Representations, 2025. URL https://openreview.net/forum?id=jCPak79Kev). Text representation uses PySpice codes or natural language to describe analog circuits, which can be converted to a SPICE (Simulation Program with Integrated Circuit Emphasis) netlist-a textual high-level description of device connections used for circuit simulation. Graph representation formulates the topology design as a graph/sequence generation task, as circuit topologies of analog ICs can be naturally represented as graph structures. Yet, these representations face significant limitations that must be addressed to enable precise and scalable discovery of topologies. Text-based representations are prone to errors, as generating even a single device or connection often involves predicting multiple text tokens. Even advanced LLM models such as GPT-4 (Lai, Y., Lee, S., Chen, G., Poddar, S., Hu, M., Pan, D. Z., and Luo, P. Analogcoder: Analog circuit design via training-free code generation. arXiv preprint arXiv: 2405.14918, 2024) struggle to generate circuits with fewer than 10 devices accurately. While graph-based representations can significantly mitigate errors by predicting device-pin connections, they still suffer from scalability and accuracy. Specifically, these methods (Dong, Z., Cao, W., Zhang, M., Tao, D., Chen, Y., and Zhang, X. CktGNN: Circuit graph neural network for electronic design automation. In The Eleventh International Conference on Learning Representations, 2023. URL https://openreview.net/forum?id=NE2911Kq1sp; Chang, C. C., Shan, Y., Fan, S., Li, J., Zhang, S., Cao, N., Chen, Y., and Zhang, X. Lamagic: Language-model-based topology generation for analog integrated circuits. arXiv preprint arXiv: 2407.18269, 2024; Gao, J., Cao, W., Yang, J., and Zhang, X. Analoggenie: A generative engine for automatic discovery of analog circuit topologies. In The Thirteenth International Conference on Learning Representations, 2025. URL https://openreview.net/forum?id=jCPak79Kev) do not efficiently and precisely model circuit graphs. When leveraging auto-regressive models such as transformers that have a limited context window for circuit graph generation, they are unable to generate circuits at scale and are limited to accuracy due to the error propagation of long-sequence predictions (Zhu, Y., Du, Y., Wang, Y., Xu, Y., Zhang, J., Liu, Q., and Wu, S. A survey on deep graph generation: Methods and applications. In The First Learning on Graphs Conference, 2022. URL https://openreview.net/forum?id=Im8G9R1boQi).

This work proposes AnalogGenie-Lite, a Generative engine based on a decoder-only transformer for discovering novel analog circuit topologies with enhanced scalability and precision through lightweight graph modeling. Compared to its predecessor (Gao, J., Cao, W., Yang, J., and Zhang, X. Analoggenie: A generative engine for automatic discovery of analog circuit topologies. In The Thirteenth International Conference on Learning Representations, 2025. URL https://openreview.net/forum?id=jCPak79Kev), AnalogGenie-Lite harnesses a lightweight circuit graph modeling to address the limitations of existing methods. At the graph level, it simplifies the cutting-edge device-pin graph representation (Gao, J., Cao, W., Yang, J., and Zhang, X. Analoggenie: A generative engine for automatic discovery of analog circuit topologies. In The Thirteenth International Conference on Learning Representations, 2025. URL https://openreview.net/forum?id=jCPak79Kev) by removing redundant nodes and edges, reducing graph complexity for multi-pin shared edge connection from O n² to O(n). At the subgraph level, it employs data mining on a database (Gao, J., Cao, W., Yang, J., and Zhang, X. Analoggenie: A generative engine for automatic discovery of analog circuit topologies. In The Thirteenth International Conference on Learning Representations, 2025. URL https://openreview.net/forum?id-jCPak79Kev) of more than 3000 topologies across tens of circuit types to identify and simplify frequently reused subcircuits, replacing them with compact representations. Finally, it models a circuit graph as a shortest closed path that visits every edge of an undirected graph at least once by solving the Chinese Postman Problem (Edmonds, J. and Johnson, E. L. Matching, euler tours and the chinese postman. Mathematical programming, 5:88-124, 1973) and significantly reduce sequence length compared to previous non-optimal methods (Gao, J., Cao, W., Yang, J., and Zhang, X. Analoggenie: A generative engine for automatic discovery of analog circuit topologies. In The Thirteenth International Conference on Learning Representations, 2025. URL https://openreview.net/forum?id-jCPak79Kev). These innovations remarkably enhance the scalability and precision of topology discovery. Moreover, this efficient graph modeling method from AnalogGenie-Lite can also be broadly applied to other domains such as protein generation (Jumper, J., Evans, R., Pritzel, A., Green, T., Figurnov, M., Ronneberger, O., Tunyasuvunakool, K., Bates, R., Z ̌'ídek, A., Potapenko, A., et al. Highly accurate protein structure prediction with alphafold. nature, 596 (7873): 583-589, 2021) and community detection (Fortunato, S. Community detection in graphs. Physics reports, 486 (3-5): 75-174, 2010). Contributions are as follows:

Precise and efficient graph modeling: AnalogGenie-Lite significantly improves the efficiency of graph representation at the device-pin level for analog circuit topology modeling. It exploits opportunities to eliminate redundant device self nodes and simplifies multi-pin shared edge connections, reducing space complexity from O(n²) to O(n).

Compact subgraph modeling: AnalogGenie-Lite employs frequent subgraph mining to identify commonly reused subgraphs in the database. It further simplifies these subgraphs by pruning isolated nodes and restructuring the remaining non-isolated nodes into a cycle.

Optimal sequence modeling: AnalogGenie-Lite models the graph as a shortest closed path that visits every edge of an undirected graph at least once by solving the Chinese Postman Problem (Edmonds, J. and Johnson, E. L. Matching, euler tours and the chinese postman. Mathematical programming, 5:88-124, 1973). This significantly reduces sequence length compared to previous non-optimal methods.

Experimental results show that AnalogGenie-Lite achieves remarkable generation performance, i.e., 5.15× to 71.11× reduction in average sequence length across the entire database and 23.5% to 33.6% improvement in validity, compared to the best prior art. Case studies on social networks and protein graph datasets further showcase the broad applicability and superior scalability of our graph modeling approach.

### 2-L. Preliminaries and Related Work

### 2-L.1. Analog Circuit Design Flow

The analog circuit design process generally involves three key stages. First, it starts with creating the circuit topology, which entails selecting device types (e.g., transistors and resistors), determining the number of devices, and defining their interconnections. Next, designers carry out device sizing, i.e., optimizing the physical dimensions of the de-vices to achieve specific performance objectives. Finally, the physical layout based on the topology and device dimension is created for fabrication, which represents ICs as stacked physical layers used in manufacturing. While significant advancements have been made in automating the device sizing (Wang, H., Wang, K., Yang, J., Shen, L., Sun, N., Lee, H. S., and Han, S. Gen-rl circuit designer: Transferable transistor sizing with graph neural networks and reinforcement learning. In 2020 57th ACM/IEEE Design Automation Conference (DAC), pp. 1-6. IEEE, 2020; Cao, W., Benosman, M., Zhang, X., and Ma, R. Domain knowledge-infused deep learning for automated analog/radio-frequency circuit parameter optimization. In Proceedings of the 59th ACM/IEEE Design Automation Conference, pp. 1015-1020, 2022; Gao, J., Cao, W., and Zhang, X. Rose: Robust analog circuit parameter optimization with sampling-efficient reinforcement learning. In 2023 60th ACM/IEEE Design Automation Conference (DAC), pp. 1-6. IEEE, 2023; Cao, W., Gao, J., Ma, T., Ma, R., Benosman, M., and Zhang, X. Rose-opt: Robust and efficient analog circuit parameter optimization with knowledge-infused reinforcement learning. IEEE Transactions on Computer-Aided Design of Integrated Circuits and Systems, 2024) and layout design stages (Kunal, K., Madhusudan, M., Sharma, A. K., Xu, W., Burns, S. M., Harjani, R., Hu, J., Kirkpatrick, D. A., and Sapatnekar, S. S. Align: Open-source analog layout automation from the ground up. In Proceedings of the 56th Annual Design Automation Conference 2019, pp. 1-4, 2019; Xu, B., Zhu, K., Liu, M., Lin, Y., Li, S., Tang, X., Sun, N., and Pan, D. Z. Magical: Toward fully automated analog ic layout leveraging human and machine intelligence. In 2019 IEEE/ACM International Conference on Computer-Aided Design (ICCAD), pp. 1-8. IEEE, 2019), the problem of topology generation remains significantly underexplored due to its abstract, complex nature, requiring creativity and human-level intelligence. An example embodiment addresses this challenging problem.

### 2L.2. Existing Analog Circuit Topology Generation

Generative AI has demonstrated significant potential in tack-ling topology generation, with early approaches focusing on text-based or graph-based methods. For example, Analog-Coder (Lai, Y., Lee, S., Chen, G., Poddar, S., Hu, M., Pan, D. Z., and Luo, P. Analogcoder: Analog circuit design via training-free code generation. arXiv preprint arXiv: 2405.14918, 2024) models circuits as Python-style SPICE (PySpice) netlists, using domain-specific prompt engineering with large language models (LLMs). While this flexible representation allows diverse and scalable de-signs, its reliance on high-level text introduces challenges in generating valid circuits due to the need for multi-token predictions for each device or connection. Artisan (Chen, Z., Huang, J., Liu, Y., Yang, F., Shang, L., Zhou, D., and Zeng, X. Artisan: Automated operational amplifier design via domain-specific large language model. In Proceedings of the 61st ACM/IEEE Design Automation Conference, DAC '24, New York, NY, USA, 2024. Association for Computing Machinery. ISBN 9798400706011. doi: 10.1145/3649329.3655903. URL https://doi. org/10.1145/3649329.3655903) avoids this complexity by focusing on topology selection rather than generation. Using natural language to represent topology names, Artisan reuses existing topologies, avoiding the complexity of low-level design. How-ever, this limits its ability to generate novel and custom topologies. Graph-based methods, such as CktGNN (Dong, Z., Cao, W., Zhang, M., Tao, D., Chen, Y., and Zhang, X. CktGNN: Circuit graph neural network for electronic design automation. In The Eleventh International Conference on Learning Representations, 2023. URL https://openreview.net/forum?id=NE2911Kq1sp), use adjacency matrices and a graph variational autoencoder (VAE) to generate topologies for specific ana-log ICs like operational amplifiers (20 devices). Similarly, LaMAGIC (Chang, C. C., Shan, Y., Fan, S., Li, J., Zhang, S., Cao, N., Chen, Y., and Zhang, X. Lamagic: Language-model-based topology generation for analog integrated circuits. arXiv preprint arXiv: 2407.18269, 2024) fine-tunes a masked language model (MLM) to generate fixed-node circuits, achieving high success for simpler designs like power converters (fewer than four devices). AnalogGenie (Gao, J., Cao, W., Yang, J., and Zhang, X. Analoggenie: A generative engine for automatic discovery of analog circuit topologies. In The Thirteenth International Conference on Learning Representations, 2025. URL https://openreview.net/forum?id=jCPak79Kev) uses non-optimal Eulerian circuits to model the graph. This efficient representation avoids encoding non-existent edges, enabling scalability to larger circuits (e.g., 63 devices). In this work, AnalogGenie-Lite further advances analog circuit topology generation with lightweight graph modeling.

### 3L. Approach

AnalogGenie-Lite is a domain-specific generative model tailored to discover novel analog circuit topologies of versatile types with exceptional scalability and precision. To achieve this, AnalogGenie-Lite leverages three key innovations in its lightweight graph modeling. First, it significantly improves the efficiency of the device-pin graph, which accurately represents circuit topologies. By eliminating redundant nodes and edges, it simplifies the graph structure, enabling more efficient and precise topology discovery. Second, AnalogGenie-Lite employs frequent subgraph mining to identify commonly used subcircuits and introduces a customized tokenizer that incorporates both fundamental device and subcircuit pins. This approach allows for the versatile generation of custom circuits while enabling efficient reuse of existing subcircuits. Third, it models circuit graphs as the shortest closed path visiting all edges at least once by solving the Chinese Postman Problem (Edmonds, J. and Johnson, E. L. Matching, euler tours and the chinese postman. Mathematical programming, 5:88-124, 1973). This technique significantly reduces sequence length compared to non-optimal methods (Gao, J., Cao, W., Yang, J., and Zhang, X. Analoggenie: A generative engine for automatic discovery of analog circuit topologies. In The Thirteenth International Conference on Learning Representations, 2025. URL https://openreview.net/forum?id=jCPak79Kev).

### 3L.1. Precise and Efficient Graph Modeling

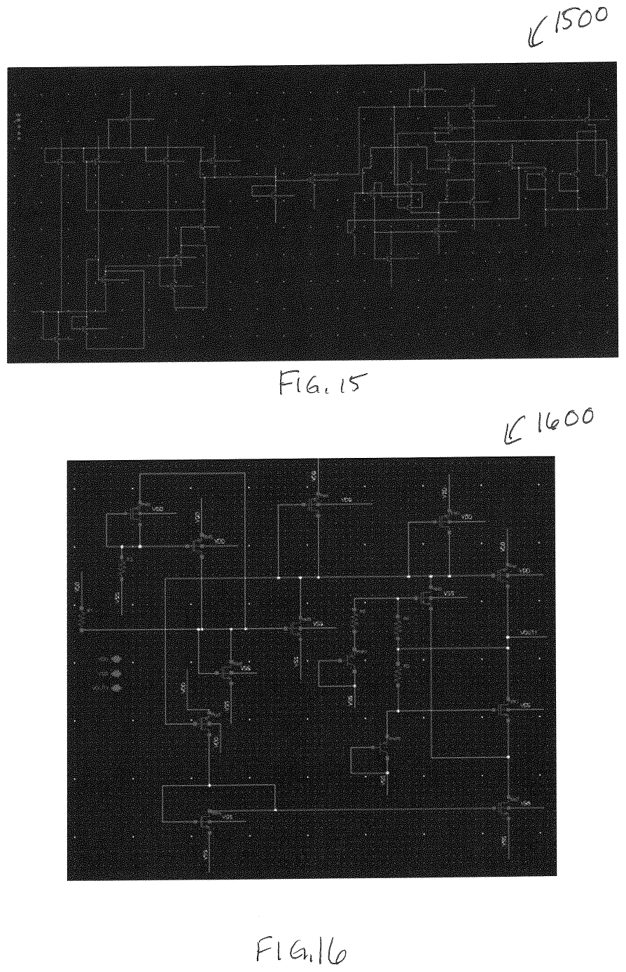

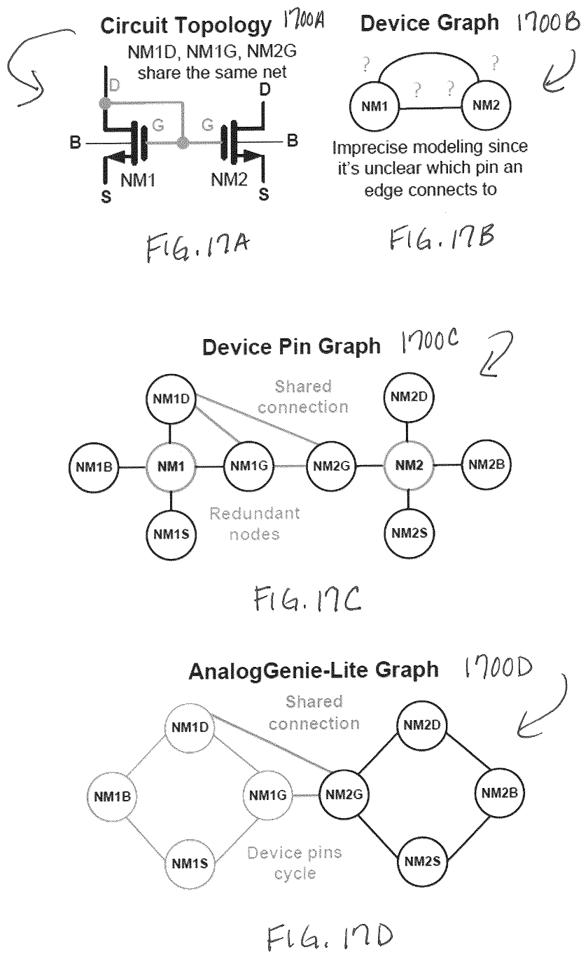

FIGS. 17A-D demonstrate AnalogGenie-Lite's accurate and efficient graph modeling by pruning redundant nodes and edges from device pin graph.

FIG. 17A is an example circuit topology 1700A.

FIG. 17B is a representation of a device graph 1700B of the circuit topology 1700A of FIG. 17A.

FIG. 17C is a representation of example embodiment of a device pin graph 1700C of the circuit topology 1700A of FIG. 17A. The device pin graph 1700C shows precise but inefficient modeling (redundant nodes & edges).

FIG. 17D is a representation of an AnalogGenie-Lite graph 1700D. The AnalogGenie-Lite graph 1700D shows accurate and efficient modeling (pruning redundant nodes & edges).

Abstracting the efficient and precise representation of an analog circuit topology is a long-standing challenge. Graph representations have recently emerged as a promising modeling methodology. Early works (Dong, Z., Cao, W., Zhang, M., Tao, D., Chen, Y., and Zhang, X. CktGNN: Circuit graph neural network for electronic design automation. In The Eleventh International Conference on Learning Representations, 2023. URL https://openreview.net/forum?id=NE2911Kq1sp; Lu, J., Lei, L., Huang, J., Yang, F., Shang, L., and Zeng, X. Automatic op-amp generation from specification to layout. IEEE Transactions on Computer-Aided Design of Integrated Circuits and Systems, 2023; Lohn, J. D. and Colombano, S. P. A circuit representation technique for automated circuit design. IEEE Transactions on Evolutionary Computation, 3 (3): 205-219, 1999; Mattiussi, C. and Floreano, D. Analog genetic encoding for the evolution of circuits and networks. IEEE Transactions on evolutionary computation, 11 (5): 596-607, 2007) rely on high-level graphs to generate circuit topologies, where each node represents a device. Although this approach offers efficient representations, it omits essential low-level device details, resulting in ambiguous generation. Consider an NMOS transistor (NM) with four pins, i.e., drain (D), gate (G), source(S), and body (B) in FIG. 17A for illustration. Abstracting the entire device as a single node makes it unclear which pin an edge connects to. On the other hand, AnalogGenie (Gao, J., Cao, W., Yang, J., and Zhang, X. Analoggenie: A generative engine for automatic discovery of analog circuit topologies. In The Thirteenth International Conference on Learning Representations, 2025. URL https://openreview.net/forum?id=jCPak79Kev) represents circuits at the pin level, ensuring a unique mapping between the graph and circuit topology, where every connection is explicitly represented (FIG. 17C). Specifically, it represents the topology of an analog circuit as a finite connected undirected graph G=(V, E), where V={1, 2, . . . , n} is the node set representing each device pin with |V|=n and E∈V×V is the edge set. Yet, this approach inevitably increases graph complexity by introducing more nodes and edges and does not scale well as the number of devices in a circuit grows. AnalogGenie-Lite significantly improves the efficiency and accuracy of this graph modeling by pruning redundant nodes and edges.

Pruning redundant nodes: In the device pin-level graph structure (Gao, J., Cao, W., Yang, J., and Zhang, X. Analoggenie: A generative engine for automatic discovery of analog circuit topologies. In The Thirteenth International Conference on Learning Representations, 2025. URL https://openreview.net/forum?id-jCPak79Kev), each device is represented by its pins (e.g., NM1D, NM1G, NM1S, NM1B) and the device node itself (e.g., NM1 for an NMOS). The device node primarily models situations where device pins are connected to themselves or remain unconnected. However, here redundancy exists, as representing the connection between device pins that belong to the same device is not required. As an example, the edge NM1D↔NM1G is redundant with NM1D↔NM2G in device pin graph (FIG. 17C). Consequently, AnalogGenie-Lite removes all device itself nodes from the graph and connects device pins nodes as a cycle (FIG. 17D).

Pruning redundant edges: When n device pins share the same connection (FIG. 17A), the device-pin graph (Gao, J., Cao, W., Yang, J., and Zhang, X. Analoggenie: A generative engine for automatic discovery of analog circuit topologies. In The Thirteenth International Conference on Learning Representations, 2025. URL https: //openreview.net/forum?id=jCPak79Kev) represents this case using

$$\frac{n ( n - 1 )}{2}$$

edges, connecting every pair of pins explicitly. For example, if three pins (NM1D, NM1G, and NM2G) share a connection (FIG. 17C), existing work uses three edges: NM1D↔NM1G, NM1D↔NM2G, and NM1G↔NM2G. AnalogGenie-Lite simplifies this representation by selecting a single node that does not cause edges overlapping with the device pinscycle and connecting all other nodes to it. Thus, only n-1 edges are required. In the example, AnalogGenie-Lite selects NM2G as the node since selecting NM1G or NM1D will result in NM1G↔NM1D edge that overlaps with NM1 device pins cycle. As a result, it uses only two edges: NM1D↔NM2G and NM1G↔NM2G to describe the shared connection. This technique remarkably enhances the scalability, as n-1 edges scale linearly compared to the quadratic growth of

$$\frac{n ( n - 1 )}{2}$$

edges. More examples of this edge pruning method can be found in Appendix AL.1.

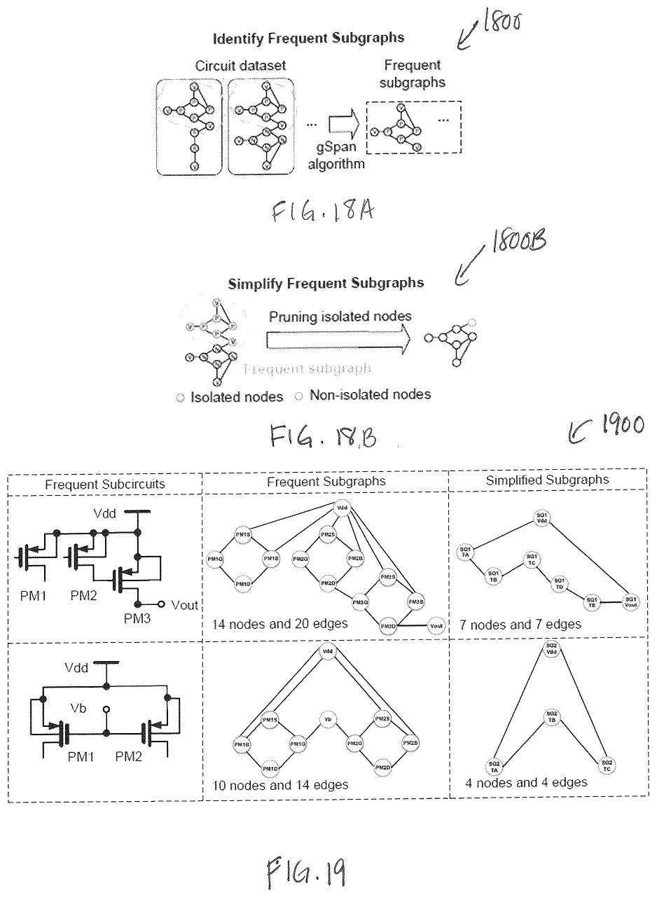

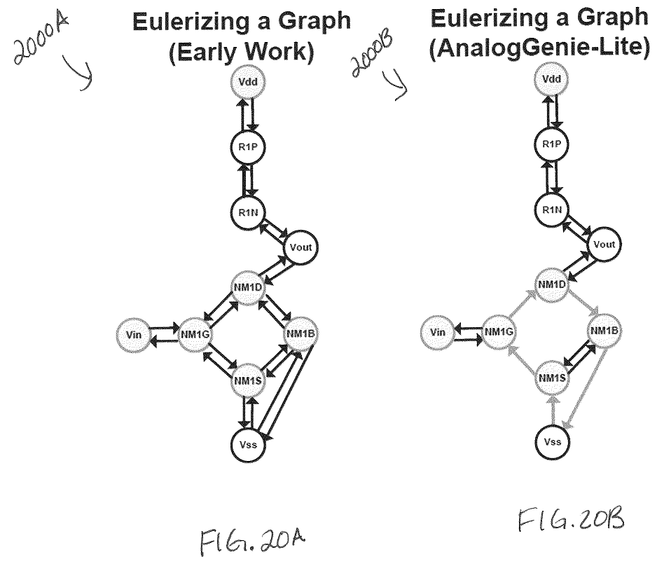

FIGS. 18A and 18B are simplified diagrams that illustrate how an example embodiment of AnalogGenie-Lite identifies 1800A and simplifies 1800B frequent subgraphs, respectively.

### 3L.2. Compact Subgraph Modeling

FIGS. 18A and 18B are simplified diagrams that illustrate how an example embodiment of AnalogGenie-Lite identifies (1800A) and simplifies (1800B) frequent subgraphs, respectively.

Analog circuit topologies naturally exhibit a hierarchical structure, combining low-level unique devices essential for novel configurations with high-level subcircuits that are versatile and reusable across various circuits. Yet, existing approaches either focus solely on generating analog circuit topologies at the most fundamental device level from scratch (i.e., device pin), resulting in heavyweight sequential structures (Gao, J., Cao, W., Yang, J., and Zhang, X. Analoggenie: A generative engine for automatic discovery of analog circuit topologies. In The Thirteenth International Conference on Learning Representations, 2025. URL https://openreview.net/forum?id=jCPak79Kev), or operate exclusively at the high level (i.e., subcircuit), limiting their versatility to represent diverse topology structures and restricting them to specific circuit types (Dong, Z., Cao, W., Zhang, M., Tao, D., Chen, Y., and Zhang, X. CktGNN: Circuit graph neural network for electronic design automation. In The Eleventh International Conference on Learning Representations, 2023. URL https://openreview.net/forum?id=NE2911Kq1sp). AnalogGenie-Lite bridges this gap by enabling the simultaneous exploration of both custom and hierarchical structures. First, AnalogGenie-Lite employs a domain-specific tokenizer to encode and decode sequences. Each token in AnalogGenie-Lite's tokenizer corresponds to either a device pin (e.g., NM1G, NM1D, NM1S, NM1B) or a circuit-level pin for the overall analog topology (e.g., VIN1, VOUT1, VDD, VSS). This approach allows AnalogGenie-Lite to generate topologies at the most fundamental level by predicting the next device pin token. Additionally, AnalogGenie-Lite incorporates special tokens to represent the pins of subgraphs or SG (e.g., SG1 VDD, SG1 VOUT, SG1 termA, SG1 termB, SG1 termC). These tokens enable the generation of only the outer pins of a subcircuit, omitting inner low-level design details. This significantly simplifies the graph structure while maintaining the ability to represent hierarchical topologies. Detailed tokenizer table is shown in Table 3 in Appendix AL.2.

Additionally, existing approaches either construct an ex-tensive design library (i.e., tokenizer table) to significantly simplify the graph structure, which includes numerous in-frequent subcircuits and inefficiently utilizes the design library's space (Gielen, G. G. and Rutenbar, R. A. Computer-aided design of analog and mixed-signal integrated circuits. Proceedings of the IEEE, 88 (12): 1825-1854, 2000; Zhao, Z. and Zhang, L. Analog integrated circuit topology synthesis with deep reinforcement learning. IEEE Trans-actions on Computer-Aided Design of Integrated Circuits and Systems, 41 (12): 5138-5151, 2022, Zhao, Z. and Zhang, L. An automated topology synthesis framework for analog integrated circuits. IEEE Transactions on Computer-Aided Design of Integrated Circuits and Systems, 39 (12): 4325-4337, 2020), or rely solely on heuristic design knowledge to identify frequent subcircuits, which may lead to inaccuracies (Dong, Z., Cao, W., Zhang, M., Tao, D., Chen, Y., and Zhang, X. CktGNN: Circuit graph neural network for electronic design automation. In The Eleventh International Conference on Learning Representations, 2023. URL https://openreview.net/forum?id=NE2911Kq1sp). AnalogGenie-Lite, on the other hand, employs rigorous data mining on a large ana-log circuit topology database (Gao, J., Cao, W., Yang, J., and Zhang, X. Analoggenie: A generative engine for automatic discovery of analog circuit topologies. In The Thirteenth International Conference on Learning Representations, 2025. URL https://openreview.net/forum?id=jCPak79Kev) comprising over 3000 unique topologies and 11 types of analog circuits to accurately identify the frequent subcircuits that are actively reused within the database (FIG. 18A). Specifically, AnalogGenie-Lite utilizes the gSpan method (Yan, X. and Han, J. gspan: Graph-based substructure pattern mining. In 2002 IEEE International Conference on Data Mining, 2002. Proceedings., pp. 721-724. IEEE, 2002) to mine frequent subgraphs. gSpan discovers frequently connected subgraphs in a graph dataset with-out explicitly generating candidate subgraphs, overcoming the limitations of earlier Apriori-based approaches and significantly reducing runtime. Once frequent subgraphs are identified, AnalogGenie-Lite classifies the nodes within subgraphs as isolated nodes (nodes connected only to other nodes within the subgraph) or non-isolated nodes (nodes also connected to the rest of the graph) based on their degree. To simplify the frequent subgraphs, AnalogGenie-Lite prunes the isolated nodes and their edges (FIG. 18B). Next, it connects the remaining non-isolated nodes in a cycle and replaces the original subgraph within the graph to simplify its structure. The non-isolated nodes are renamed as subgraph pin names (e.g., SG1 VDD, SG1 VOUT, SG1 termA, etc) and added to the tokenizer table. AnalogGenie-Lite simplifies subgraphs only if the number of isolated nodes exceeds a certain threshold, balancing lightweight graph structures with the overhead in the tokenizer table. FIG. 19 presents examples of AnalogGenie-Lite mined subgraphs with a large number of isolated nodes. Excitingly, these structures differ significantly from those used in previous work (Zhao, Z. and Zhang, L. Analog integrated circuit topology synthesis with deep reinforcement learning. IEEE Trans-actions on Computer-Aided Design of Integrated Circuits and Systems, 41 (12): 5138-5151, 2022, Zhao, Z. and Zhang, L. An automated topology synthesis framework for analog integrated circuits. IEEE Transactions on Computer-Aided Design of Integrated Circuits and Systems, 39 (12): 4325-4337, 2020) based on human heuristics, underscoring the necessity of rigorous data mining.

FIG. 19 is a representation 1900 of two frequent subgraph examples (over 25% appearing frequency in the dataset and over 50% of nodes within subgraphs are isolated) that AnalogGenie-Lite selects to identify and simplify (red: isolated nodes; blue: non-isolated nodes).

### 3L.3. Optimal Sequence Modeling

Harnessing an efficient data structure to model the circuit graph is the last key innovation of AnalogGenie-Lite's modeling method. Previous work (Dong, Z., Cao, W., Zhang, M., Tao, D., Chen, Y., and Zhang, X. CktGNN: Circuit graph neural network for electronic design automation. In The Eleventh International Conference on Learning Representations, 2023. URL https://openreview.net/forum?id=NE2911Kq1sp; Lu, J., Lei, L., Huang, J., Yang, F., Shang, L., and Zeng, X. Automatic op-amp generation from specification to layout. IEEE Transactions on Computer-Aided Design of Integrated Circuits and Systems, 2023) uses adjacency matrices to represent circuit graphs. However, an adjacency matrix requires O n² space to store n nodes, regardless of the number of edges, which is inefficient for sparse graphs. Analog circuit topologies are typically sparse, as most devices connect only to their adjacent neighbors. In contrast, AnalogGenie-Lite optimally represents the circuit graph as the shortest closed path that visits every edge of a finite connected undirected graph at least once by solving the Chinese Postman Problem.

Definition 3.1 (Chinese postman problem, (Edmonds, J. and Johnson, E. L. Matching, euler tours and the chinese postman. Mathematical programming, 5:88-124, 1973). Chinese postman problem is a combinatorial optimization problem that tries to find the shortest circuit that visits every edge of a finite connected undirected graph at least once.

When a graph contains an Eulerian circuit, that circuit rep-resents the optimal solution.

Definition 3.2 (Eulerian circuit, (Biggs, N., Lloyd, E. K., and Wilson, R. J. Graph Theory, 1736-1936. Oxford University Press, 1986). Eulerian circuit is a graph trail that visits every edge exactly once and starts and ends at the same node.

However, not all finite connected undirected graphs contain Eulerian circuit unless all of their nodes have even degree.

Eulerian circuit unless all of their nodes have even degree.

Definition 3.3 (Eulerian graph, (Biggs, N., Lloyd, E. K., and Wilson, R. J. Graph Theory, 1736-1936. Oxford University Press, 1986). If all the nodes in a finite connected undirected graph have even degree, the graph is Eulerian and contains at least one Eulerian circuit.

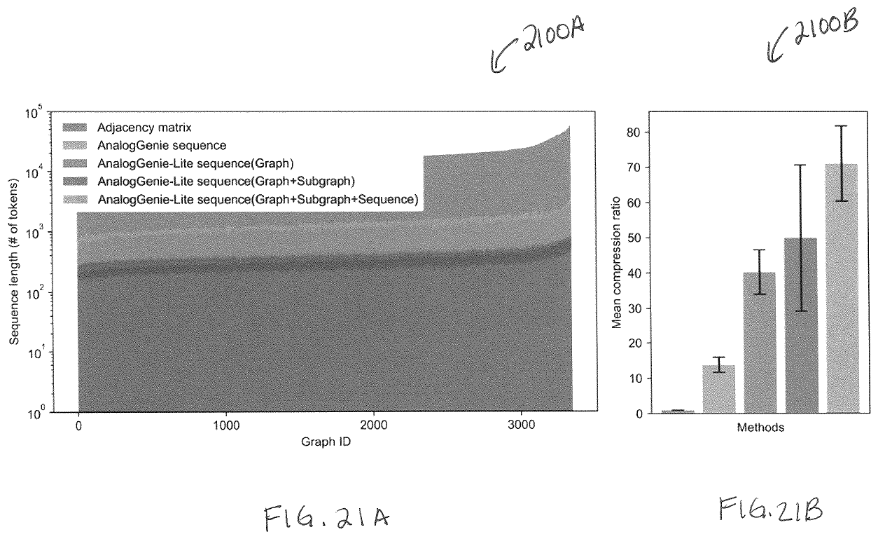

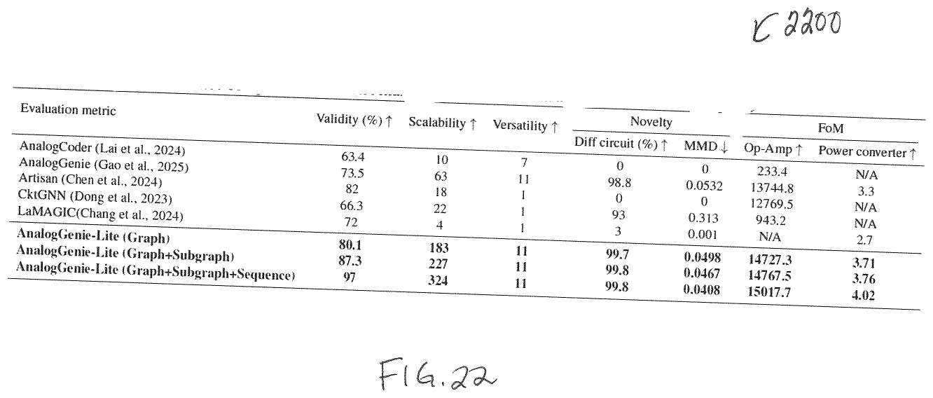

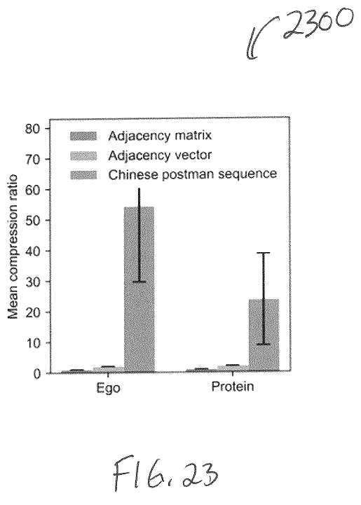

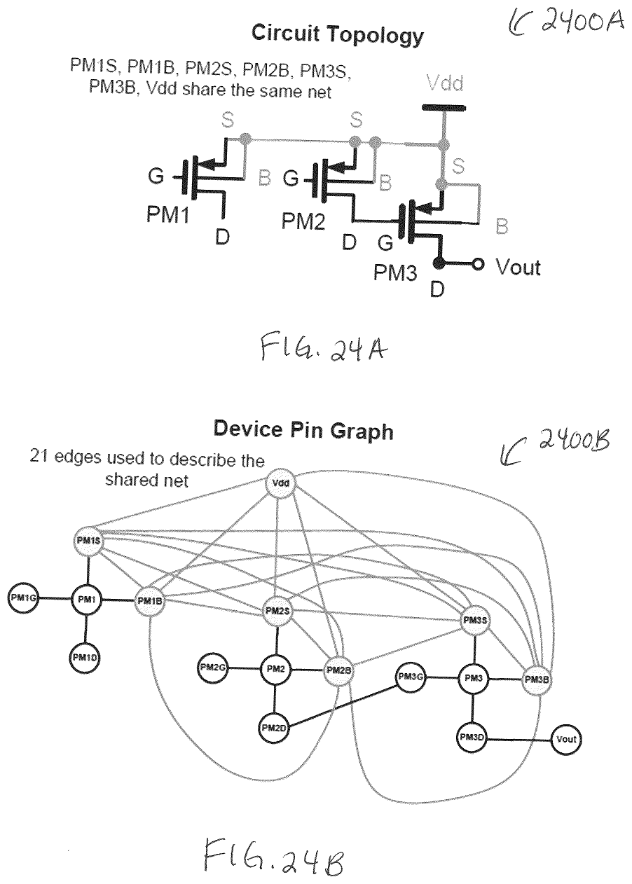

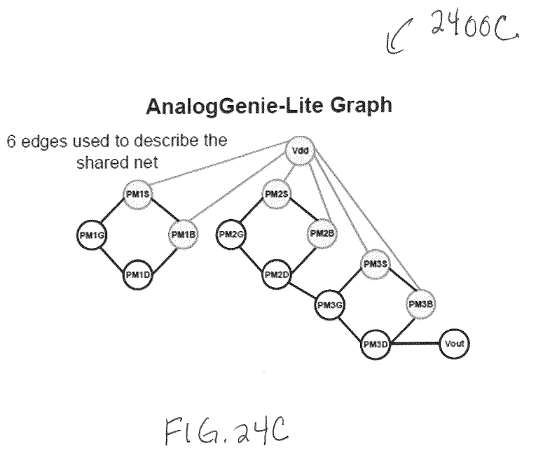

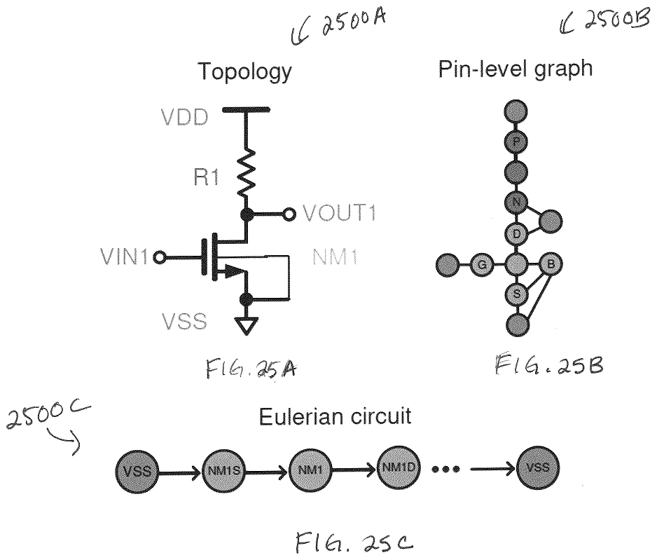

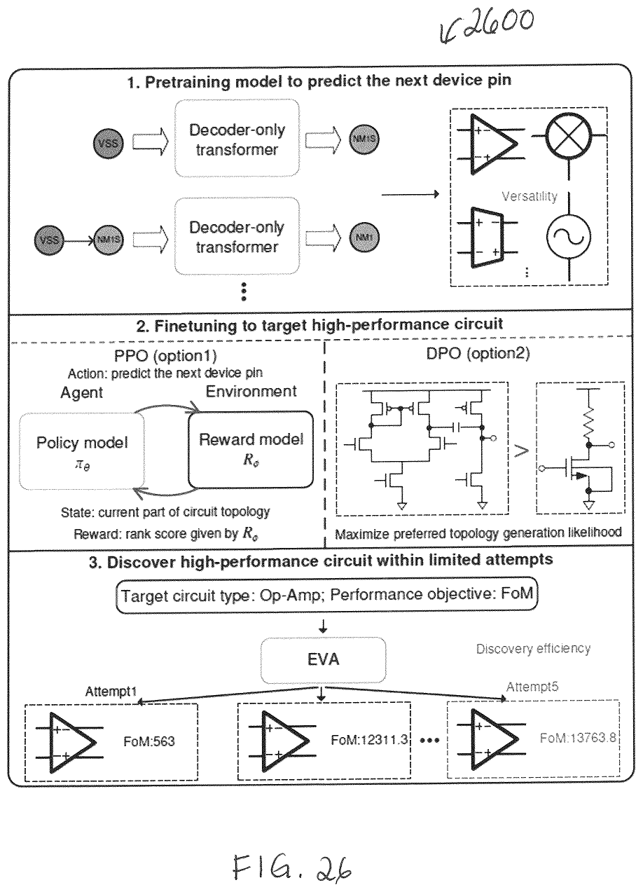

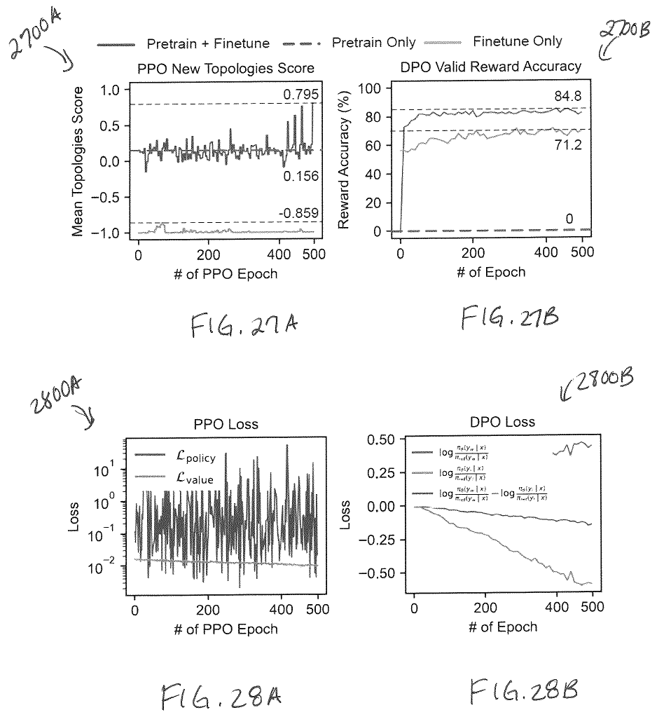

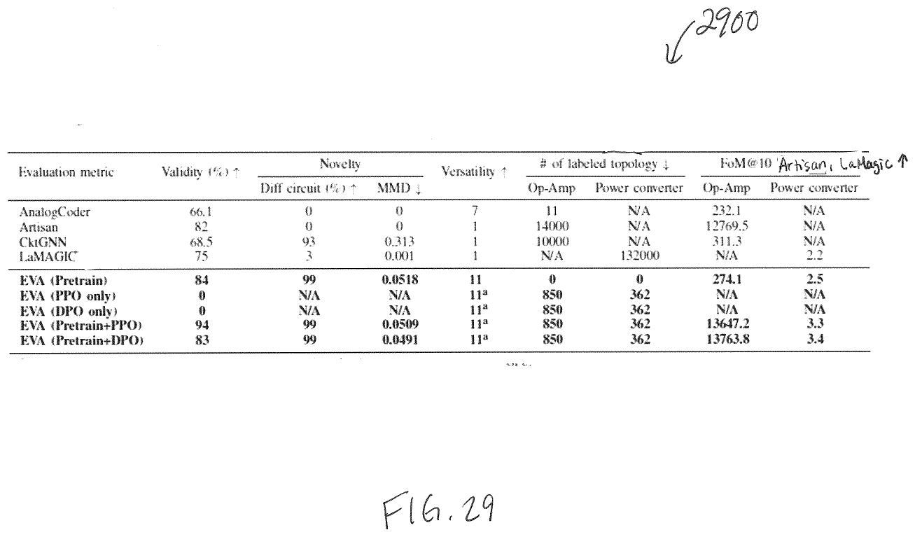

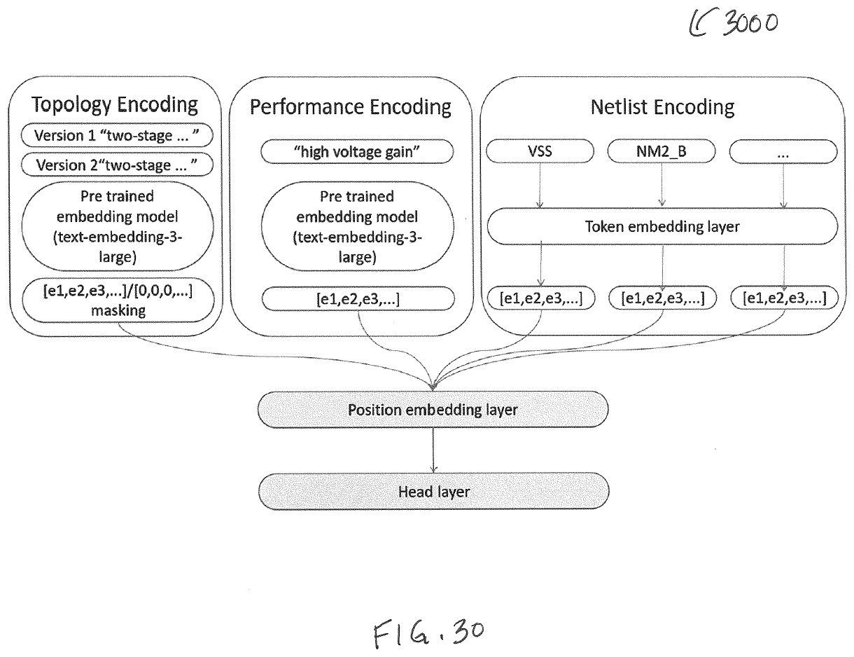

Thus, the optimization problem for non-Eulerian graph is to find the smallest number of graph edges to duplicate so that the resulting multigraph does have an Eulerian circuit (Roberts, F. S. and Tesman, B. Applied combinatorics. CRC Press, 2024). As shown in FIG. 20A, existing non-optimal method (Gao, J., Cao, W., Yang, J., and Zhang, X. Analoggenie: A generative engine for automatic discovery of analog circuit topologies. In The Thirteenth International Conference on Learning Representations, 2025. URL https: //openreview.net/forum?id=jCPak79Kev) duplicates all the existing edges in a finite connected undirected graph to ensure the graph to be Eulerian by replacing each undirected edge {u, v}∈E with two directed arcs (u, v) and (v, u) (i.e., traverse all the undirected edge exactly twice). This causes a large overhead in its sequence representation since not all the edges need to be duplicated to make the graph Eulerian. On the other hand, AnalogGenie-Lite finds the optimal sequence by employing Method 1 (Mei-Ko, K. Graphic programming using odd or even points. Chinese Math, 1:237-277, 1962; Edmonds, J. and Johnson, E. L. Matching, euler tours and the chinese postman. Mathematical programming, 5:88-124, 1973) to Eulerize the undirected graph. Since the topology graph G=(V, E) includes unweighted edges and Method 1 requires a weighted undirected graph, we assign a weight of 1 to all edges in G. The method begins by identifying vertices with odd degrees. It then pairs the odd-degree vertices in a way that minimizes the total cost of connecting them, leveraging a shortest-path strategy. Finally, it duplicates the edges along these shortest paths to ensure all vertices have even degrees, thereby Eulerizing the graph. Through this process, AnalogGenie-Lite minimizes the duplication of existing edges, efficiently transforming the graph into an Eulerian circuit.

FIGS. 20A and 20B are representations (2000A, 2000B) of eulerizing a graph based on early work and eulerizing a graph based on an example embodiment of AnalogGenie-Lite, respectively. FIGS. 20A and 20B illustrate a comparison between the early work (Gao et al., 2025) and an example embodiment of the AnalogGenie-Lite eulerizing method (red: odd degree nodes in the original undirected graph; blue: non-duplicated edges). The early work eulerian circuit has 23 tokens, namely [‘Vss’ ‘NM1S’ ‘NM1G’ ‘Vin’ ‘NM1G’ ‘NM1D’ ‘Vout’ ‘R1N’ ‘R1P’ ‘Vdd’ ‘R1P’ ‘R1N’ ‘Vout’ ‘NM1D’ ‘NM1B’ ‘Vss’ ‘NM1B’ ‘NM1S’ ‘NM1B’ ‘NM1D’ ‘NM1G’ ‘NM1S’ ‘Vss’] whereas the AnalogGenie-Lite eulerian circuit has 18 tokens, namely [‘Vss’ ‘NM1S’ ‘NM1G’ ‘Vin’ ‘NM1G’ ‘NM1D’ ‘Vout’ ‘R1N’ ‘R1P’ ‘Vdd’ ‘R1P’ ‘R1N’ ‘Vout’ ‘NM1D’ ‘NM1B’ ‘NM1S’ ‘NM1B’ ‘Vss’].

### 4L. Results

### 4L.1. Experiment Setup

Datasets: The AnalogGenie-Lite uses a dataset (Gao, J., Cao, W., Yang, J., and Zhang, X. Analoggenie: A generative engine for automatic discovery of analog circuit topologies. In The Thirteenth International Conference on Learning Representations, 2025. URL https://openreview.net/forum?id=jCPak79Kev) that comprises 3350 unique and real-world topologies across 11 types: Op-Amps, LDOs, Bandgap references, Comparators, PLLs, LNAs, PAs, Mixers, VCOs, Power converters, and SC Samplers from public resources (Razavi, B. Design of Analog CMOS Integrated Circuits. McGraw-Hill, Inc., USA, 1 edition, 2000. ISBN 0072380322; Razavi, B. and Behzad, R. RF microelectronics, volume 2. Prentice hall New York, 2012; Johns, D. A. and Martin, K. Analog integrated circuit design. John Wiley & Sons, 2008.; Gray, P. R., Hurst, P. J., Lewis, S. H., and Meyer, R. G. Analysis and design of analog integrated circuits. John Wiley & Sons, 2009; Allen, P. E. and Holberg, D. R. CMOS analog circuit design. Elsevier, 2011; Camenzind, H. Designing analog chips. Virtualbookworm Publishing, 2005).

### Method 1 Chinese Postman Method

Require: A weighted, undirected graph G=(V,E)
1: Step 1: Identify odd-degree vertices
2: odd vertices←{ν∈V|degree(v) mod 2≠0}
3: Step 2: Pair up odd-degree vertices to minimize cost
4: CompleteGraph←Construct a complete graph where vertices are the odd-degree vertices, and edge weights are the shortest path distances between each pair of odd-degree vertices in the original graph.
5: pairs←Solve the minimum weight perfect matching problem on CompleteGraph using the Blossom method (Edmonds, J. Paths, trees, and flowers. Canadian Journal of mathematics, 17:449-467, 1965).
6: Step 3: Duplicate edges to make degrees even
7: for each pair (u, v) ∈ pairs do
8: path←ShortestPath (u, v, G) using Dijkstra method (Dijkstra, E. W. A note on two problems in connexion with graphs. In Edsger Wybe Dijkstra: his life, work, and legacy, pp. 287-290. 2022)
9: for each edge (x, y) ∈ path do
10: Add duplicate edge (x, y) to G
11: end for
12: end for

Training setup: During pretraining, AnalogGenie-Lite splits the data into train and validation sets with a 9 to 1 ratio. It augments the dataset by generating multiple unique Eulerian circuits per topology. It uses a decoder-only trans-former with 6 layers, 6 attention heads, and 11.825 million parameters, with a vocabulary size of 1029 and a maxi-mum sequence length of 1024. For performance evaluation, AnalogGenie-Lite leverages reinforcement learning with human feedback (Ouyang, L., Wu, J., Jiang, X., Almeida, D., Wainwright, C., Mishkin, P., Zhang, C., Agarwal, S., Slama, K., Ray, A., et al. Training language models to follow instructions with human feedback. Advances in neural information processing systems, 35:27730-27744, 2022) to target specific types of analog circuits optimized for given performance metrics.

Baseline: We select AnalogCoder (Lai, Y., Lee, S., Chen, G., Poddar, S., Hu, M., Pan, D. Z., and Luo, P. Analogcoder: Analog circuit design via training-free code generation. arXiv preprint arXiv: 2405.14918, 2024) and Artisan (Chen, Z., Huang, J., Liu, Y., Yang, F., Shang, L., Zhou, D., and Zeng, X. Artisan: Automated operational amplifier design via domain-specific large language model. In Proceedings of the 61st ACM/IEEE Design Automation Conference, DAC'24, New York, NY, USA, 2024. Association for Computing Machinery. ISBN 9798400706011. doi: 10.1145/3649329.3655903. URL https://doi. org/10.1145/3649329.3655903) as the representative of text generation work. Then, we select CktGNN (Dong, Z., Cao, W., Zhang, M., Tao, D., Chen, Y., and Zhang, X. CktGNN: Circuit graph neural network for electronic design automation. In The Eleventh International Conference on Learning Representations, 2023. URL https://openreview.net/forum?id=NE2911Kq1sp), LaMAGIC (Chang, C. C., Shan, Y., Fan, S., Li, J., Zhang, S., Cao, N., Chen, Y., and Zhang, X. Lamagic: Language-model-based topology generation for analog integrated circuits. arXiv preprint arXiv: 2407.18269, 2024), and AnalogGenie (Gao, J., Cao, W., Yang, J., and Zhang, X. Analoggenie: A generative engine for automatic discovery of analog circuit topologies. In The Thirteenth International Conference on Learning Representations, 2025. URL https://openreview.net/forum?id=jCPak79Kev) as the representative of graph generation work. The differences between these methods and AnalogGenie-Lite are discussed in Section 2L. The original work to produce their results was followed.

Evaluation tasks and metrics: We evaluate the generative quality of each method using the following metrics:
(1) Validity: An unsized circuit is considered valid if it can be simulated in SPICE without errors (e.g., floating or shorted nodes). Each method generates 1,000 topologies, and we report the percentage of valid designs.
(2) Scalability: The largest valid circuit generated by each model, based on the number of devices.
(3) Versatility: The versatility of a model is determined by the number of distinct analog circuit types it generates.
(4) Novelty: To evaluate novelty, each method generates 1,000 topologies, and we measure the percentage of these that differ from those in the dataset. Topology differences are quantified by converting the circuits into graphs and computing the maximum mean discrepancy (MMD) (Guo, X. and Zhao, L. A systematic survey on deep generative models for graph generation. IEEE Transactions on Pattern Analysis and Machine Intelligence, 45 (5): 5370-5390, 2022) between these generated graphs and real-world graphs derived from the dataset.
(5) Performance: Each generated topology is sized using a genetic method, and the resulting figure-of-merit (FoM)—considering all major metrics (e.g., gain, bandwidth, and power for operational amplifiers)—is used as a comprehensive performance indicator. We compare the best FoM achieved by circuits generated from each model.

FIGS. 21A and 21B are graphs (2100A, 2100B) illustrating a comparison between adjacency matrix (Dong et al., 2023; Lu et al., 2023), AnanlogGenie (Gao, J., Cao, W., Yang, J., and Zhang, X. Analoggenie: A generative engine for automatic discovery of analog circuit topologies. In The Thirteenth International Conference on Learning Representations, 2025. URL https://openreview.net/forum?id=jCPak79Kev) sequence, and AnanlogGenie-Lite sequence for representing each topology or graph within the dataset in terms of sequence length (left) and mean compression ratio (right). The adjacency matrices were flattened to sequences for comparison.

We begin by evaluating AnalogGenie-Lite's lightweight graph modeling in terms of mean compression ratio for rep-resenting circuit topology. FIGS. 21A and 21B compare the sequence length required to encode each topology using AnalogGenie-Lite, the adjacency matrix baseline (Dong, Z., Cao, W., Zhang, M., Tao, D., Chen, Y., and Zhang, X. CktGNN: Circuit graph neural network for electronic design automation. In The Eleventh International Conference on Learning Representations, 2023. URL https://openreview.net/forum?id=NE2911Kq1sp; Lu, J., Lei, L., Huang, J., Yang, F., Shang, L., and Zeng, X. Automatic op-amp generation from specification to layout. IEEE Transactions on Computer-Aided Design of Integrated Circuits and Systems, 2023), and the state-of-the-art sequence representation, AnalogGenie (Gao, J., Cao, W., Yang, J., and Zhang, X. Analoggenie: A generative engine for automatic discovery of analog circuit topologies. In The Thirteenth International Conference on Learning Representations, 2025. URL https://openreview.net/forum?id=jCPak79Kev). The adjacency matrix approach, based on the device-pin graph (Gao, J., Cao, W., Yang, J., and Zhang, X. Analoggenie: A generative engine for automatic discovery of analog circuit topologies. In The Thirteenth International Conference on Learning Representations, 2025. URL https: //openreview.net/forum?id=jCPak79Kev), results in sequences of approximately 104 to 105 tokens due to its O(n²) space complexity, making it impractical for training with typical LLMs (Radford, A., Wu, J., Child, R., Luan, D., Amodei, D., Sutskever, I., et al. Language models are unsupervised multitask learners. OpenAI blog, 1 (8): 9, 2019; Brown, T., Mann, B., Ryder, N., Subbiah, M., Kaplan, J. D., Dhariwal, P., Neelakantan, A., Shyam, P., Sastry, G., Askell, A., et al. Language models are few-shot learners. Advances in neural information processing systems, 33:1877-1901, 2020; Achiam, J., Adler, S., Agarwal, S., Ahmad, L., Akkaya, I., Aleman, F. L., Almeida, D., Altenschmidt, J., Altman, S., Anadkat, S., et al. Gpt-4 technical report. arXiv preprint arXiv: 2303.08774, 2023). AnalogGenie mitigates this issue by encoding graphs as non-optimal Eulerian circuits, reducing sequence length by 13.81×to around 10³ tokens. However, it still struggles with large circuits exceeding 100 devices, where sequences reach 10⁴ tokens. To enhance scalability, AnalogGenie-Lite employs a more efficient graph modeling strategy. The AnalogGenie-Lite (Graph) method prunes redundant nodes and edges while maintaining the non-optimal Eulerian representation, improving compression by 40.28×over adjacency matrices and 2.91×over AnalogGenie. The AnalogGenie-Lite sequence (Graph+Subgraph) further prunes isolated nodes and edges within subgraphs, improving compression to 49.91×and 3.61×over the respective baselines. However, the compression benefit varies across circuits as shown in FIGS. 21A and 21B, particularly for those with unique structures (e.g., PA circuits), emphasizing the need for a flexible generation approach capable of predicting both device pins and subcircuits. Finally, AnalogGenie-Lite (Graph+Subgraph+Sequence) integrates all optimizations, solving the Chinese Postman Problem for an optimal Eulerian circuit representation. This method achieves a 71.11×compression over adjacency matrices and 5.15×over AnalogGenie. These results demonstrate that AnalogGenie-Lite offers a scalable and precise representation, crucial for robust circuit topology discovery.

### 4L.3. Evaluating the Generation Quality

Then, we evaluate AanalogGenie-Lite's generation quality by comparing to prior methods, as shown in Table 2200 of FIG. 22.

FIG. 22 is a table 2200 that provides a performance comparison between AnalogGenie-Lite and existing analog circuit topology generation work.

Validity: AnalogGenie-Lite achieves 97% validity, significantly surpassing prior methods. AnalogCoder generates only 63.4% valid circuits due to errors in code generation, while CktGNN, LaMAGIC, and AnalogGenie achieve 66.3%, 72%, and 73.5% validity, respectively, using graph-based techniques. Artisan, focused on topology selection, reaches 82% validity but cannot generate novel circuits. In contrast, AnalogGenie-Lite's lightweight graph modeling mitigates error propagation, achieving a 23.5% to 33.6% improvement over previous methods while generating over 99% novel circuits.

Scalability: AnalogGenie-Lite achieves unmatched scalability. CktGNN and LaMAGIC, limited by quadratic costs of adjacency matrix representations, handle circuits with up to 4 and 22 devices, respectively. AnalogCoder and Artisan, constrained by prompt templates, generate circuits with a maximum of 10 and 18 devices. AnalogGenie im-proves scalability to 63 devices with an efficient sequence representation. AnalogGenie-Lite, leveraging a lightweight representation, extends this further to 324 devices, achiev-ing a 5.15×to 71.11×improvement over prior methods. Versatility: AnalogGenie-Lite surpasses Artisan, CktGNN, and LaMAGIC, which are restricted to designing only a single circuit type. AnalogCoder, while supporting seven types, is limited by a synthesis library containing 20 topologies. Novelty: AnalogGenie-Lite outperforms other methods in discovering novel circuits. AnalogCoder and Artisan primarily reuse existing topologies or subblocks, while LaMAGIC is restricted to a small design space, significantly limiting its ability to explore new topologies. Although both Ckt-GNN and AnalogGenie-Lite support the generation of larger circuits, CktGNN is trained on synthetic datasets that lack critical real-world features. AnalogGenie-Lite, trained on real-world circuit, improves the MMD metric by over 7.67× and generates approximately 99% novel circuits. Compared to AnalogGenie, AnalogGenie-Lite produces more realistic circuits with lower MMD values due to its lightweight graph modeling, which eliminates redundant edges and nodes and lets the model focus on generating essential components. Performance: In op-amp design, AnalogCoder achieves a low FoM of 233.4 due to limited design options, while Ckt-GNN performs better at 943.2 by selecting optimized subcircuits. Artisan achieves an even higher FoM of 12769.5 by selecting state-of-the-art designs. AnalogGenie and AnalogGenie-Lite by pretraining on diverse circuit topologies, discover unseen topologies with superior FoM values of 13744.8 and 15017.7, respectively, outperforming dedicated synthesizers. AnalogGenie-Lite's advantage comes from its lightweight graph representation, eliminating redundant circuit details while focusing on learning essential components. A similar trend is seen in power converter design, where AnalogGenie-Lite achieves an FoM of 4.02, surpassing AnalogGenie (3.3) and LaMAGIC (2.7).

### 4L.4. Case Study on Ego and Protein Graphs

Finally, beyond circuits, we believe that AnalogGenie's lightweight graph modeling can also be applied to other domains, such as protein generation (Jumper et al., 2021) and community detection (Fortunato, S. Community detection in graphs. Physics reports, 486 (3-5): 75-174, 2010) that can also be represented as graphs. To demonstrate its general applicability, we conduct a case study on ego (Sen, P., Namata, G., Bilgic, M., Getoor, L., Galligher, B., and Eliassi-Rad, T. Collective classification in network data. AI magazine, 29 (3): 93-93, 2008) and protein (Dobson, P. D. and Doig, A. J. Distinguishing enzyme structures from non-enzymes without alignments. Journal of molecular biology, 330 (4): 771-783, 2003) graphs. Using the adjacency matrix and state-of-the-art adjacency vector (You, J., Ying, R., Ren, X., Hamilton, W., and Leskovec, J. Graphrnn: Generating realistic graphs with deep auto-regressive models. In International conference on ma-chine learning, pp. 5708-5717. PMLR, 2018) as baselines, we evaluate AnalogGenie-Lite with its optimal sequence modeling technique. As shown in FIG. 23, AnalogGenie-Lite's Chinese Postman sequence achieves over 50× and 20× compression for the ego and protein graphs. Since Eulerian circuits have a space complexity of O (e) where e is the number of edges, these results suggest that the ego graph, like analog circuit topologies, exhibits sparsity that e<<n, whereas the denser protein graphs pose a greater challenge for compression.

FIG. 23 is a graph 2300 that demonstrates an example embodiment of compression for AnalogGenie-Lite's Chinese Postman sequence. The graph 2300 that provides a comparison between adjacency matrix, adjacency vector (You, J., Ying, R., Ren, X., Hamilton, W., and Leskovec, J. Graphrnn: Generating realistic graphs with deep auto-regressive models. In International conference on ma-chine learning, pp. 5708-5717. PMLR, 2018), and Chinese postman sequence for ego (Sen, P., Namata, G., Bilgic, M., Getoor, L., Galligher, B., and Eliassi-Rad, T. Collective classification in network data. AI magazine, 29 (3): 93-93, 2008) and protein graph (Dobson, P. D. and Doig, A. J. Distinguishing enzyme structures from non-enzymes without alignments. Journal of molecular biology, 330 (4): 771-783, 2003).

As disclosed above, an example embodiment of AnalogGenie-Lite may be a decoder-only transformer model for discovering novel analog IC topologies with enhanced scalability and precision through lightweight graph modeling. While it sets a new standard in circuit topology discovery, several challenges remain, such as efficiently mining representative subgraphs from diverse datasets and further improving the compression while preserving essential features for effective model learning.

### AL. Appendix

### AL.1. More Details about Redundant Edges Pruning

As shown in FIG. 24A, a total of seven pins—PM1S, PM1B, PM2S, PM2B, PM3S, PM3B, and Vdd-share the same net within the topology. The device-pin graph (Gao et al., 2025) connects each pair of these pins directly, forming a fully connected subgraph that requires (7×(7−1))/2=21 edges to represent the shared net. In contrast, AnalogGenie-Lite selects Vdd and connects the remaining pins directly to it. This avoids overlapping device-pin cycles, effectively pruning redundant edges and reducing the edge count to just 7−1=6, achieving a 3.5× reduction in edges compared to the device-pin graph.

FIG. 24A is a representation 2400A of an example circuit topology.

FIG. 24B is a representation 2400B of an example embodiment of a device pin graph (Gao, J., Cao, W., Yang, J., and Zhang, X. Analoggenie: A generative engine for automatic discovery of analog circuit topologies. In The Thirteenth International Conference on Learning Representations, 2025. URL https://openreview.net/forum?id=jCPak79Kev.) of the example circuit topology of FIG. 24A.

FIG. 24C is a representation 2400C of an example embodiment of an AnalogGenie-Lite graph of the example circuit topology of FIG. 24A.

### AL.2. Tokenizer Lookup Table

Table 3 presents the tokenizer lookup table used by AnalogGenie-Lite for its versatile generation scheme, which predicts the next device, subcircuit, or circuit pin. The token indices are structured as follows: indices 0 to 549 represent basic device pins, covering NMOS, PMOS, NPN, PNP, resistors, capacitors, inductors, and diodes. Indices 550 to 890 correspond to subcircuit pins, including mined subgraphs, XOR gates, inverters, transmission gates, etc. Lastly, indices 891 to 1027 define circuit pins such as VIN, IIN, VTRACK, VDD, VSS, etc. The TRUNCATE token (index 1028) is used to pad sequences to a uniform length for training.

TABLE 3
Tokenizer look-up table with basic devices,
subcircuits, and circuit pins.

| Device | Index | Device | Index | Device | Index |
|---|---|---|---|---|---|
| NM1D | 0 | NM1G | 1 | NM1S | 2 |
| NM1B | 3 | NM2D | 4 | . . . | . . . |
| NM25B | 99 | PM1D | 100 | PM1G | 101 |
| PM1S | 102 | PM1B | 103 | PM2D | 104 |
| . . . | . . . | PM25B | 199 | NPN1C | 200 |
| NPN1B | 201 | NPN1E | 202 | NPN2C | 203 |
| . . . | . . . | NPN25E | 274 | PNP1C | 275 |
| PNP1B | 276 | PNP1E | 277 | PNP2C | 278 |
| . . . | . . . | PNP25E | 349 | R1P | 350 |
| R1N | 351 | R2P | 352 | . . . | . . . |
| R25N | 399 | C1P | 400 | C1N | 401 |
| C2P | 402 | . . . | . . . | C25N | 449 |
| L1P | 450 | L1N | 451 | L2P | 452 |
| . . . | . . . | L25N | 499 | DIO1P | 500 |
| DIO1N | 501 | DIO2P | 502 | . . . | . . . |
| DIO25N | 549 | SG1VDD | 550 | SG1VOUT | 551 |
| SG1TA | 552 | SG1TB | 553 | SG1TC | 554 |
| SG1TD | 555 | SG1TE | 556 | SG2VDD | 557 |
| . . . | . . . | XOR1A | 726 | XOR1B | 727 |
| XOR1VDD | 728 | XOR1VSS | 729 | XOR1Y | 730 |
| . . . | . . . | XOR5Y | 750 | INV1A | 751 |
| INV1Q | 752 | INV1VDD | 753 | INV1VSS | 754 |
| INV2A | 755 | . . . | . . . | INV10VSS | 790 |
| TG1A | 791 | TG1B | 792 | TG1C | 793 |
| TG1VDD | 794 | TG1VSS | 795 | TG2A | 796 |
| . . . | . . . | TG20VSS | 890 | VIN1 | 891 |
| VIN2 | 892 | VIN3 | 893 | VIN4 | 894 |
| VIN5 | 895 | IIN1 | 896 | IIN2 | 897 |
| . . . | . . . | VTRACK1 | 1024 | VTRACK2 | 1025 |
| VDD | 1026 | VSS | 1027 | TRUNCATE | 1028 |

### EVA: An Efficient and Versatile Generative Engine for Targeted Discovery of Novel Analog Circuits

Analog circuit design has traditionally depended on manual expertise, slowing the discovery of novel topologies essential for advanced technologies like AI, 5G/6G, and quantum computing. While AI-driven methods have accelerated hardware design workflows, most of them focus on topology synthesis, often reusing known structures to achieve specific goals. The challenge of discovering entirely new, high-performance topologies remains largely underexplored due to its abstract nature. In this work, we introduce EVA, an efficient and versatile generative engine for discovering novel analog circuit topologies. EVA employs a bottom-up generation framework, using a decoder-only transformer to sequentially predict device pin connections and create diverse circuits from scratch. Pretraining on unlabeled circuit topologies builds foundational knowledge about circuit connectivity, achieving baseline discovery efficiency by generating valid circuits and reducing performance-labeled samples needed in fine-tuning. For targeted discovery of high-performance designs, EVA leverages two fine-tuning strategies—proximal policy optimization (PPO) and direct preference optimization (DPO)—to further enhance discovery efficiency for relevant, high-performing topologies. Experimental results across various circuit types highlight EVA's strengths in validity, novelty, versatility, and both training sample and discovery efficiency.

Analog circuit topologies' design has historically relied heavily on manual effort and domain expertise. This approach not only results in a lengthy design cycle but also restricts the discovery of novel analog circuit topologies. Emerging technologies, such as AI, 5G/6G, and quantum computing, impose stringent performance demands, creating a need for innovative analog circuit topologies beyond the capabilities of well-established designs. To support the advancement of these technologies, a critical question arises: how can we efficiently explore and invent circuit topologies that might achieve unprecedented performance, surpassing what human expertise alone has accomplished? Recently, AI-driven methodologies for analog hardware design have shown promise in accelerating the design cycle across various stages of the design flow (Z. Dong, W. Cao, M. Zhang, D. Tao, Y. Chen, and X. Zhang, “Cktgnn: Circuit graph neural network for electronic design automation,” arXiv preprint arXiv: 2308.16406, 2023, H. Wang, K. Wang, J. Yang, L. Shen, N. Sun, H. S. Lee, and S. Han, “Gen-rl circuit designer: Transferable transistor sizing with graph neural networks and reinforcement learning,” in 2020 57th ACM/IEEE Design Automation Conference (DAC). IEEE, 2020, pp. 1-6, W. Cao, M. Benosman, X. Zhang, and R. Ma, “Domain knowledge-infused deep learning for automated analog/radio-frequency circuit parameter optimization,” in Proceedings of the 59th ACM/IEEE Design Automation Conference, 2022, pp. 1015-1020, J. Gao, W. Cao, and X. Zhang, “Rose: Robust analog circuit parameter optimization with sampling-efficient reinforcement learning,” in 2023 60th ACM/IEEE Design Automation Conference (DAC). IEEE, 2023, pp. 1-6, W. Cao, J. Gao, T. Ma, R. Ma, M. Benosman, and X. Zhang, “Rose-opt: Robust and efficient analog circuit parameter optimization with knowledge-infused reinforcement learning,” IEEE Transactions on Computer-Aided Design of Integrated Circuits and Systems, 2024, W. Lyu, F. Yang, C. Yan, D. Zhou, and X. Zeng, “Batch bayesian optimization via multi-objective acquisition ensemble for automated analog circuit design,” in International conference on machine learning. PMLR, 2018, pp. 3306-3314, B. Liu, Y. Wang, Z. Yu, L. Liu, M. Li, Z. Wang, J. Lu, and F. V. Fernandez, “Analog circuit optimization system based on hybrid evolutionary algorithms,” Integration, vol. 42, no. 2, pp. 137-148, 2009, K. Kunal, M. Madhusudan, A. K. Sharma, W. Xu, S. M. Burns, R. Harjani, J. Hu, D. A. Kirkpatrick, and S. S. Sapatnekar, “Align: Open-source analog layout automation from the ground up,” in Proceedings of the 56th Annual Design Automation Conference 2019, 2019, pp. 1-4, B. Xu, K. Zhu, M. Liu, Y. Lin, S. Li, X. Tang, N. Sun, and D. Z. Pan, “Magical: Toward fully automated analogic layout leveraging human and machine intelligence,” in 2019 IEEE/ACM International Conference on Computer-Aided Design (ICCAD). IEEE, 2019, pp. 1-8, Z. Wu and I. Savidis, “Circuit-gnn: A graph neural network for transistor-level modeling of analog circuit hierarchies,” in 2023 IEEE International Symposium on Circuits and Systems (ISCAS). IEEE, 2023, pp. 1-5). However, existing research (Y. Lai, S. Lee, G. Chen, S. Poddar, M. Hu, D. Z. Pan, and P. Luo, “Analogcoder: Analog circuit design via training-free code generation,” arXiv preprint arXiv: 2405.14918, 2024, Z. Chen, J. Huang, Y. Liu, F. Yang, L. Shang, D. Zhou, and X. Zeng, “Artisan: Automated operational amplifier design via domain-specific large language model,” in 2024 61th ACM/IEEE Design Automation Conference (DAC). ACM, 2024, pp. 1-6, C. C. Chang, Y. Shan, S. Fan, J. Li, S. Zhang, N. Cao, Y. Chen, and X. Zhang, “Lamagic: Language-model-based topology generation for analog integrated circuits,” arXiv preprint arXiv: 2407.18269, 2024) mainly addresses the analog circuit topology synthesis problem, focusing on meeting specific design objectives by selecting or reusing known topologies or sub-blocks from existing designs. In contrast, the discovery problem of novel analog circuit topologies remains underexplored due to its abstract and complex nature.

In this work, we tackle the novel circuit topology discovery problem due to its scientific significance and potential for breakthrough innovations. Existing approaches have achieved great progress in topology discovery for certain types of analog circuits. CktGNN (Z. Dong, W. Cao, M. Zhang, D. Tao, Y. Chen, and X. Zhang, “Cktgnn: Circuit graph neural network for electronic design automation,” arXiv preprint arXiv: 2308.16406, 2023), a pioneering effort, employs a variational autoencoder (VAE) with a two-level graph neural network (GNN) to learn and generate diverse operational amplifier (Op-Amp) topologies. Similarly, Karahan et al. (E. A. Karahan, Z. Liu, and K. Sengupta, “Deep-learning-based inverse-designed millimeter-wave passives and power amplifiers,” IEEE Journal of Solid-State Circuits, vol. 58, no. 11, pp. 3074-3088, 2023) propose an inverse design approach for the rapid synthesis of complex RF-to-terahertz (THz) matching networks by generating various electromagnetic (EM) structures. However, these approaches are limited in versatility and discovery efficiency without the ability to discover diverse types of analog circuit topologies while targeting certain performance preferences.

To address these challenges, we introduce EVA, an efficient and versatile generative engine for discovering novel analog circuit topologies. To achieve great versatility, EVA proposed a bottom-up generation framework that uses a decoder-only transformer to generate diverse analog designs from scratch, starting from a VSS pin and sequentially predicting the next device pin connection. Instead of training with performance-labeled topology from scratch, EVA is first pre-trained on a diverse set of unlabeled circuit topologies to learn the circuit connectivity. In this way, the model itself has already achieved a basic level of discovery efficiency by generating valid topology and setting a great foundation for finetuning. For targeted discovering specific circuit types with high performance within limited attempts, EVA proposed two fine-tuning strategies based on proximal policy optimization (PPO) (L. Ouyang, J. Wu, X. Jiang, D. Almeida, C. Wainwright, P. Mishkin, C. Zhang, S. Agarwal, K. Slama, A. Ray et al., “Training language models to follow instructions with human feedback,” Advances in neural information processing systems, vol. 35, pp. 27 730-27 744, 2022 and direct preference optimization (DPO) (R. Rafailov, A. Sharma, E. Mitchell, C. D. Manning, S. Ermon, and C. Finn, “Direct preference optimization: Your language model is secretly a reward model,” Advances in Neural Information Processing Systems, vol. 36, 2024) with a limited number of labeled topology thanks to the foundation laid by the pretrained model. In this way, EVA is able to achieve great training sample efficiency and discovery efficiency with-out wasting evaluation time on irrelevant or low-performing circuits. Our key contributions are as follows:

EVA is a versatile generative engine that can discover diverse, novel analog circuit topologies by sequentially predicting device pin connections, starting from VSS.

EVA pretrains a decoder-only transformer on an un-labeled dataset of circuit topologies, enabling efficient generation of valid circuits and significantly improving training sample efficiency by reducing the reliance on performance-labeled samples during fine-tuning.

EVA enhances discovery efficiency by fine-tuning with PPO and DPO on a small set of performance-labeled topologies, focusing on high-performance circuits and minimizing irrelevant evaluations.

Experimental results across various analog circuit types demonstrate EVA's advantages in topology validity, novelty, versatility, sample efficiency, and discovery efficiency.

### II. Related Work

### A. ML Methods for Analog Circuit Topology Synthesis

Analog circuit topology synthesis aims to develop circuits that meet design goals using established topologies or sub-block topologies. Existing ML methods primarily address the issue of data scarcity when building models capable of automating analog circuit design. AnalogCoder (Y. Lai, S. Lee, G. Chen, S. Poddar, M. Hu, D. Z. Pan, and P. Luo, “Analogcoder: Analog circuit design via training-free code generation,” arXiv preprint arXiv: 2405.14918, 2024) highlights that while large language models (LLMs) have been extensively trained on Python code, they lack exposure to the SPICE netlist, the industry-standard format for describing analog circuits. To bridge this gap, they employ domain-specific prompt engineering, enabling LLMs to generate PySpice code that can be seamlessly converted into SPICE netlists without additional training-thus maximizing training sample efficiency. Similarly, Artisan (Z. Chen, J. Huang, Y. Liu, F. Yang, L. Shang, D. Zhou, and X. Zeng, “Artisan: Automated operational amplifier design via domain-specific large language model,” in 2024 61th ACM/IEEE Design Automation Conference (DAC). ACM, 2024, pp. 1-6) translates SPICE netlists into natural language, allowing the development of domain-specific foundation models for analog circuit design, even with limited data. On the other hand, LaMAGIC (C. C. Chang, Y. Shan, S. Fan, J. Li, S. Zhang, N. Cao, Y. Chen, and X. Zhang, “Lamagic: Language-model-based topology generation for analog integrated circuits,” arXiv preprint arXiv: 2407.18269, 2024), a fine-tuned masked language model (MLM), has been proposed to generate power converter circuit topologies by predicting the connections between predefined nodes. However, most current approaches to analog circuit topology design rely heavily on existing circuit topologies or subblock structures, which constrains their ability to discover novel topologies.

### B. ML Methods for Novel Analog Circuit Topology Discovery

Novel analog circuit topology discovery aims to identify novel, non-existent circuit topologies that could potentially expand our understanding of analog circuits. Existing ML approaches have primarily focused on discovering designs at two distinct levels, each restricted to a specific type of analog circuit. CktGNN (Z. Dong, W. Cao, M. Zhang, D. Tao, Y. Chen, and X. Zhang, “Cktgnn: Circuit graph neural network for electronic design automation,” arXiv preprint arXiv: 2308.16406, 2023) addresses the schematic level by generating a variety of Op-Amp topologies. This method adopts a top-down graph generation approach but limits the design scope to sub-blocks without incorporating device-level details. While this constraint simplifies the generation process and ensures valid topologies (e.g., avoiding floating nodes), it also restricts the diversity of circuits that can be explored. Karahan et al. (E. A. Karahan, Z. Liu, and K. Sengupta, “Deep-learning-based inverse-designed millimeter-wave passives and power amplifiers,” IEEE Journal of Solid-State Circuits, vol. 58, no. 11, pp. 3074-3088, 2023), on the other hand, focus on the physical level, employing an inverse-design approach using binary matrices to generate unintuitive EM structures for RF-to-THz matching networks. However, applying this method to schematic-level design is challenging, as the complexity of analog circuit topologies—due to the wide variety of device types and numbers-cannot be adequately captured by a binary matrix representation. Beyond versatility limitations, these methods are also constrained by inefficient discovery processes. Both approaches lack target discovery capabilities, relying heavily on trial and error, which leads to substantial evaluation overhead from real-world simulators due to frequent low-performance circuit assessments. To mitigate this, (E. A. Karahan, Z. Liu, and K. Sengupta, “Deep-learning-based inverse-designed millimeter-wave passives and power amplifiers,” IEEE Journal of Solid-State Circuits, vol. 58, no. 11, pp. 3074-3088, 2023) proposed training a forward model to predict performance for specific EM structures, a promising direction but one that demands over 600k performance-labeled EM structures, making it extremely sample inefficient.

### III. EVA Framework

FIG. 26 is an overview 2600 of an example embodiment of EVA. EVA in FIG. 26 is an efficient and versatile generative engine designed to discover novel analog circuit topologies. It uses a device pin-level graph representation (Anonymous, “Analoggenie: A generative engine for automatic discovery of analog circuit topologies,” in Submitted to The Thirteenth International Conference on Learning Representations, 2024, under review. [Online]. Available: https://openreview.net/forum?id=jCPak79Kev), sequentialized as an Eulerian circuit, to capture all possible connections in a compact format while retaining critical structural information. EVA leverages a decoder-only transformer architecture, pre-trained on diverse analog circuit topologies, to generate circuits from scratch by sequentially predicting device pin connections. Through fine-tuning strategies such as PPO and DPO, EVA efficiently generates high-performance circuit topologies with minimal labeled data, targeting specific circuit types and desired performance.

### A. Expressive and Efficient Sequential Graph Representation

Existing approaches to schematic-level analog circuit topology discovery generally formulate the problem as a graph generation task, where each circuit topology is represented as a device-level graph with nodes corresponding to individual devices (e.g., NMOS transistors) (Z. Dong, W. Cao, M. Zhang, D. Tao, Y. Chen, and X. Zhang, “Cktgnn: Circuit graph neural network for electronic design automation,” arXiv preprint arXiv: 2308.16406, 2023). EVA, in contrast, adopts a device pin-level graph representation as shown in FIG. 25B where each node corresponds to an individual device pin (e.g., NM1 G, NM1 D, NM1 S, and NM1 B) (Anonymous, “Analoggenie: A generative engine for automatic discovery of analog circuit topologies,” in Submitted to The Thirteenth International Conference on Learning Representations, 2024, under review. [Online]. Available: https://openreview.net/forum?id=jCPak79Kev). Since analog circuit topologies are typically sparse—most devices connect only to their immediate neighbors—traditional adjacency matrices are inefficient, as they waste space representing non-existent edges (Z. Dong, W. Cao, M. Zhang, D. Tao, Y. Chen, and X. Zhang, “Cktgnn: Circuit graph neural network for electronic design automation,” arXiv preprint arXiv: 2308.16406, 2023), (C. C. Chang, Y. Shan, S. Fan, J. Li, S. Zhang, N. Cao, Y. Chen, and X. Zhang, “Lamagic: Language-model-based topology generation for analog integrated circuits,” arXiv preprint arXiv: 2407.18269, 2024). To address this, EVA sequentializes the graph as an Eulerian circuit (Anonymous, “Analoggenie: A generative engine for automatic discovery of analog circuit topologies,” in Submitted to The Thirteenth International Conference on Learning Representations, 2024, under review. [Online]. Available: https://openreview.net/forum?id=jCPak79Kev), a path that traverses each directed edge exactly once before returning to the starting node (e.g., VSS). Unlike prior approaches that limit graph structures to directed acyclic graphs (DAGs) (Z. Dong, W. Cao, M. Zhang, D. Tao, Y. Chen, and X. Zhang, “Cktgnn: Circuit graph neural network for electronic design automation,” arXiv preprint arXiv: 2308.16406, 2023)—which cannot universally represent all analog topologies—the Eulerian circuit approach is more versatile, capable of representing any analog circuit that can be modeled as a finite connected undirected graph.

FIG. 25A is an original circuit topology 2500A.

FIG. 25B is an example embodiment of pin-level graph representation 2500B of the original circuit topology 2500A of FIG. 25A.

FIG. 25C is an example embodiment of an Eulerian circuit 2500C of the original circuit topology 2500A of FIG. 25A.

FIG. 26 is an overview 2600 of an example embodiment of an efficient and versatile generative engine for targeted discovery of novel analog circuits.

### B. Pretraining Model to Generate Diverse Circuits

EVA employs a customized domain-specific tokenizer to encode and decode sequences for pretraining a decoder-only transformer to discover a wide range of analog circuit topologies. Each token in EVA's tokenizer corresponds either to a device pin (e.g., NM1 G, NM1 D, NM1 S, NM1 B) or to a circuit-level pin for the overall analog topology (e.g., VIN1, VOUT1, VDD, VSS). To ensure the model can generalize across circuit topologies with varying numbers and types of devices, EVA uses a data-driven approach to scan the entire dataset and determine device limits. A special token, “Truncate,” is introduced to handle padding when sequences of varying lengths are processed.

With this domain-specific tokenizer, EVA pre-trains a decoder-only transformer to predict the next device pin within a circuit topology. Unlike typical language model pretraining, which crops sequences randomly from text, EVA ensures that each sequence corresponds to a single complete circuit topology. Given an corpus of tokens U={u₁, . . . , uₙ} representing one circuit topology, EVA maximizes the standard language modeling objective (A. Radford, “Improving language understanding by generative pre-training,” 2018) to train the model.

$${ℒ}_{pretrained} ( 𝒰 ) = {\sum }_{i} log P ( {u}_{i} \vert {u}_{i - k} , … , {u}_{i - 1} ; Θ )$$

Here, k represents the size of the context window, and the conditional probability Pis modeled by a neural network with parameters Q. During the generation phase, the model is initially provided with just one context token, “VSS,” which serves as the starting node for all Eulerian circuits. From this single token, the model generates the rest of the sequence, completing it to represent an entire circuit topology.

TABLE 4
Rank score definitions for PPO finetuning

| Reward | Definition |
|---|---|
| 1.0 | High performance relevant valid circuit |
| 0.5 | Low performance relevant valid circuit |
| −0.5 | Irrelevant valid circuit |
| −1.0 | Invalid circuit |

### C. Finetuning Model to Target High Performance Circuit

The pre-trained model in EVA has developed foundational knowledge of circuit connections across various circuit types, enabling it to achieve baseline discovery efficiency by generating valid circuits. To further enhance its ability to efficiently generate high-performance circuits within limited attempts, EVA fine-tunes this model to align with human preferences for both type and performance. Building on the foundation provided by pretraining, EVA can leverage a small set of performance-labeled topologies to guide generation towards high-performance designs. EVA introduces two fine-tuning strategies that balance training stability and overfitting.
1) Proximal policy optimization: EVA adopts PPO (L. Ouyang, J. Wu, X. Jiang, D. Almeida, C. Wainwright, P. Mishkin, C. Zhang, S. Agarwal, K. Slama, A. Ray et al., “Training language models to follow instructions with human feedback,” Advances in neural information processing systems, vol. 35, pp. 27 730-27744, 2022) as one of its reinforcement learning with human feedback (RLHF) strategies. PPO uses limited labeled samples to train a reward model as a labeler, enabling the pre-trained model to generate new samples, which are then labeled by the reward model for fine-tuning based on human preferences. Specifically, EVA utilizes a Plackett-Luce ranking model (A. Radford, J. Wu, R. Child, D. Luan, D. Amodei, I. Sutskever et al., “Language models are unsupervised multitask learners,” OpenAI blog, vol. 1, no. 8, p. 9, 2019) for sequence reward, ranking multiple classes as shown in Table 4. The reward model combines a rule-based checker with a multiclass classifier: it first checks if a generated circuit is valid (i.e., simulatable with default sizing) and then classifies circuit type and performance. To train this multiclass classifier, a limited set of circuit topologies is initially labeled for type and performance. For instance, if EVA aims to discover high-performance Op-Amps, only Op-Amps are relevant, while other types are irrelevant. The figure of merit (FoM) deter-mines whether relevant circuits are high-performance, with Otsu's method (N. Otsu et al., “A threshold selection method from gray-level histograms,” Automatica, vol. 11, no. 285-296, pp. 23-27, 1975) setting the FoM threshold. Once labeled, EVA adds a three-output linear layer on top of the final transformer layer, outputting a reward value after softmax.

Method 1 PPO RLHF Finetuning

Require: Policy model π_{θ}, Reference model π_{θref}, Reward model R_{φ}, Epochs N_{epochs}, PPO epochs
Nₚₚₒ, Batch size D, Minibatch size B, Value loss coefficient vc

| | |
|---|---|
| 1: | for epoch = 1 to N_{epochs} do |
| 2: | Let π_{θ} generate a batch of sequences with size D and corresponding values and |

store them as x, y, V

| | |
|---|---|
| 3: | Compute PPO rewards r from Eq. (2) |
| 4: | for ppo_epoch = 1 to Nₚₚₒ do |
| 5: | Randomly sample minibatch (x_{b}, y_{b}, V_{b}, r_{b}) |
| 6: | Repredict V_{bnew} for minibatch using π_{θ} |
| 7: | Calculate L_{policy}, Lᵥₐₗᵤₑ from Eq. (3) and Eq. (4) |
| 8: | Calculate L_{PPO} = −L_{policy} + vc · Lᵥₐₗᵤₑ |
| 9: | Backpropagate and update π_{θ} |
| 10: | end for |
| 11: | end for |

With the trained reward model, PPO performs optimization as shown in Method 1 PPO RLHF Finetuning.

The major components of PPO are defined as follows:

Agent: The agent is the policy model π_{θ}, which is the pre-trained model fine-tuned to align with human preferences. EVA adds a value head to it, which includes a simple linear layer that takes hidden states as input and outputs a single scalar per token. The value function provides an estimate of the expected cumulative reward from any given state.

Environment: The environment is the reward model Rφ. This environment assigns rewards based on whether generated sequences meet criteria defined in Table 4.

Action: The action is discrete by selecting a token yₜ (i.e., device-pin) from a pre-defined tokenizer's look-up table based on the current context xₜ (i.e., generated sequence).

State: The state is the current context xₜ.

Reward: Starting from the initial state x₀ (i.e., ‘VSS’), the RL agent takes a discrete action by predicting the next token yₜ given the current state xₜ in each time step t, and the environment returns a reward rₜ at that step. EVA defines the PPO reward function as follows:

Here, R_{φ}(x, y), is the reward model's score that measures how well the entire sequence aligns with preference defined in Table 4. The second term is a penalty that discourages π_{θ} from deviating too much from π_{θref}, with β controlling the strength of this penalty. The reference model π_{θref} is a fixed version of the pre-trained language model that the policy model was initially based on.

In PPO, the entire sequence or circuit topology acts as a trajectory, with the objective of optimizing the policy model π_{θ} to generate sequences that maximize the expected accumulated reward via the advantage A and the policy loss L_{policy}. Concurrently, PPO refines value prediction Vbnew using the value loss Lᵥₐₗᵤₑ. As shown in Method 1 PPO RLHF Finetuning, each epoch begins with PPO generating rollouts (sequences) using the policy model, and the reward model R_{φ} assigns rewards r, where each r corresponds to a rollout. PPO then performs minibatch optimization. The policy loss L_{policy} is designed to maximize the expected advantage of the actions taken by the agent while preventing large, destabilizing updates to the policy.

$${ℒ}_{policy} = {𝔼}_{t} [ min ( L \cdot {A}_{t} , clip ( L , 1 - ϵ , 1 + ϵ ) \cdot {A}_{t} ) ]$$

$$where L = \frac{{π}_{θ} ( {y}_{{b}_{t}} \vert {x}_{{b}_{t}} )}{{π}_{{θ}_{old}} ( {y}_{{b}_{t}} \vert {x}_{{b}_{t}} )}$$

Here, advantages Aₜ=δₜ+γλ·Aₜ₊₁ where δₜ=r_{b}_{ₜ}+γV_{b} (x_{b}_{ₜ₊₁})−V_{b}(x_{b}_{ₜ}) measure how much better (or worse) an action at time t is compared to the expected outcome calculated from value function V_{b}(x_{b}_{ₜ₊₁}). L represents the probability ratio between the current and previous policies during minibatch optimization. With the clip objective, the policy loss in PPO strikes a balance between exploiting the current advantage—encouraging the model to increase the probability of actions that yield higher expected rewards—and maintaining stable, incremental updates to the policy. In PPO, the value loss [symbol] calculated to enhance the accuracy of the model's value function.

$${ℒ}_{value} = \frac{1}{2} \cdot {( {V}_{{b}_{new}} ( {x}_{{b}_{t}} ) - {G}_{t} )}^{2}$$

The value loss [symbol] value is the squared difference between the newly predicted value V_{b}_{_{new}}(x_{b}_{ₜ}) and the target return Gₜ. The Gₜ=Aₜ+V_{b}(x_{b}_{ₜ}) represents the total expected reward for the trajectory from t onward, including the estimated value of future states. By incorporating both immediate and future rewards, Gₜ is a robust target for updating the value function.
2) Directed preference optimization: PPO is effective in preventing overfitting by continually generating new training data (S. Xu, W. Fu, J. Gao, W. Ye, W. Liu, Z. Mei, G. Wang, C. Yu, and Y. Wu, “Is dpo superior to ppo for llm alignment? a comprehensive study,” arXiv preprint arXiv: 2404.10719, 2024). However, its complexity and stability issues arise from its sensitivity to hyperparameters and dependence on a reward model. To address these challenges in a simpler and more stable way, EVA introduces a finetuning strategy based on DPO (R. Rafailov, A. Sharma, E. Mitchell, C. D. Manning, S. Ermon, and C. Finn, “Direct preference optimization: Your language model is secretly a reward model,” Advances in Neural Information Processing Systems, vol. 36, 2024). Unlike PPO, which requires a separate reward model to label newly generated data, DPO finetunes the pre-trained model using a static dataset with expert-labeled data. This approach enhances stability, as the training labels are accurate and unaffected by the reward model's classification reliability. Moreover, DPO's objective function is simplified compared to PPO, with only a single hyperparameter, β, which controls the extent of πθ deviation from the reference model.

$${ℒ}_{DPO} ( {π}_{θ} ; {π}_{ref} ) = - {𝔼}_{( x , {y}_{w} , {y}_{l} )} ∼ 𝒟 [ log σ ( β log \frac{{π}_{θ} ( {y}_{w} \vert x )}{{π}_{ref} ( {y}_{w} \vert x )} - β log \frac{{π}_{θ} ( {y}_{l} \vert x )}{{π}_{ref} ( {y}_{l} \vert x )} ) ]$$

DPO utilizes the Bradley-Terry model (R. A. Bradley and M. E. Terry, “Rank analysis of incomplete block designs: I. the method of paired comparisons,” Biometrika, vol. 39, no. 3/4, pp. 324-345, 1952) as its preference framework, focusing on pairwise comparisons (win or lose) rather than the multi-rank model employed in PPO. Specifically, optimizing L_{DPO} guides the pre-trained model to identify analog circuit topologies that maximize the expression

$$log \frac{\text{?}}{{π}_{ref} ( {y}_{w} \vert x )} - log \frac{\text{?}}{{π}_{ref} ( {y}_{l} \vert x )} ,$$

$$\text{?} \text{indicates text missing or illegible when filed}$$

thus encouraging it to generate “winning” topologies while discouraging “losing” ones. Given the complexity of human preferences for analog circuit topologies, EVA still relies on human experts to label circuit topologies according to a multi-rank model, as defined in Table 4. For any four data points where each belongs to a unique class, EVA transforms these into six unique win-lose pairs for DPO training (e.g., High performance relevant valid circuit >Low performance relevant valid circuit, High performance relevant valid circuit >Irrelevant valid circuit, etc.).

### IV. Experiments

### A. Experiments Setup

Datasets: The EVA circuit dataset comprises 3470 unique and real-world topologies across 11 circuit types: Op-Amps, LDOs, Bandgap references, Comparators, PLLs, LNAs, PAS, Mixers, VCOs, Power converters, and Switched Capacitor Samplers from public resources (B. Razavi, Design of Analog CMOS Integrated Circuits, 1st ed. USA: McGraw-Hill, Inc., 2000, B. Razavi and R. Behzad, RF microelectronics. Prentice hall New York, 2012, vol. 2, D. A. Johns and K. Martin, Analog integrated circuit design. John Wiley & Sons, 2008, P. R. Gray, P. J. Hurst, S. H. Lewis, and R. G. Meyer, Analysis and design of analog integrated circuits. John Wiley & Sons, 2009, P. E. Allen and D. R. Holberg, CMOS analog circuit design. Elsevier, 2011, H. Camenzind, Designing analog chips. Virtualbookworm Publishing, 2005). Each circuit's performance was assessed through circuit simulation, and a corresponding label was assigned based on its performance metrics and label definition defined in Table 4.

EVA training setup: EVA splits the topology dataset into training and validation sets with a 9:1 ratio, ensuring the validation topologies remain unseen during training. EVA uses a depth-first search (DFS) to identify the Eulerian circuit for each topology. To prevent overfitting, it permutes DFS traversal order, creating multiple unique Eulerian circuits per topology, expanding the original 3470 topologies to 234393 sequences. EVA's generation model is a decoder-only trans-former with 6 layers, 6 attention heads, and 11.825 million parameters, with a vocabulary size of 1029 and maximum sequence length of 1024. The reward model architecture is detailed in Section III-C1.

Baseline: To compare with EVA, we select AnalogCoder (Y. Lai, S. Lee, G. Chen, S. Poddar, M. Hu, D. Z. Pan, and P. Luo, “Analogcoder: Analog circuit design via training-free code generation,” arXiv preprint arXiv: 2405.14918, 2024), Artisan (Z. Chen, J. Huang, Y. Liu, F. Yang, L. Shang, D. Zhou, and X. Zeng, “Artisan: Automated operational amplifier design via domain-specific large language model,” in 2024 61th ACM/IEEE Design Automation Conference (DAC). ACM, 2024, pp. 1-6), and LaMAGIC (C. C. Chang, Y. Shan, S. Fan, J. Li, S. Zhang, N. Cao, Y. Chen, and X. Zhang, “Lamagic: Language-model-based topology generation for analog integrated circuits,” arXiv preprint arXiv: 2407.18269, 2024) as the representative ML baselines for analog circuit topology synthesis and select CktGNN (Z. Dong, W. Cao, M. Zhang, D. Tao, Y. Chen, and X. Zhang, “Cktgnn: Circuit graph neural network for electronic design automation,” arXiv preprint arXiv: 2308.16406, 2023) as the representative ML baselines for novel analog circuit topology discovery at the schematic level. The differences between these methods and EVA are discussed in Section II. We follow original work to produce their results.

Evaluation tasks and metrics: We evaluate generative quality across the following metrics: (1) Validity: An unsized circuit is valid if it can be simulated in SPICE without errors (e.g., floating or shorting nodes). Each method generates 1000 topologies, and we report the percentages that are valid. (2) Novelty: Each method generates 1000 topologies, and we measure the percentage of them that are different from the topologies in the dataset. To quantify the topology difference, We converted them into graphs and computed the maximum mean discrepancy (MMD) (X. Guo and L. Zhao, “A systematic survey on deep generative models for graph generation,” IEEE Transactions on Pattern Analysis and Machine Intelligence, vol. 45, no. 5, pp. 5370-5390, 2022) between these and real-world graphs converted from our circuit dataset. (3) Versatility: The number of distinct analog circuit types generated indicates versatility. (4) Training sample efficiency: Efficiency is evaluated by comparing the number of labeled topologies (i.e., with known performance) required for training. (5) Discovery efficiency: Given the time cost of performance evaluation, each method only generates 10 topologies, and we report the maximum FoM (e.g., gain, bandwidth, power for Op-Amps) after sizing with a genetic method and SPICE evaluation.

### B. Necessity of Pretraining and Finetuning

We first perform an ablation study to evaluate the necessity of both pretraining and fine-tuning.

FIGS. 27A and 27B are graphs (2700A, 2700B) of example embodiments of a PPO score and DPO validation reward accuracy comparison between Pretrain+Finetune, Pretrain only, and Finetune only while targeting Op-Amp design as an example. As shown in FIG. 27A, PPO results reveal that the pretrain-only model establishes a solid foundation in generating irrelevant valid circuits (score=−0.5) and low-performance relevant valid circuits (score=0.5). However, it lacks the ability to specifically target high-performance relevant valid circuits (score=1), necessitating further fine-tuning. Similar observations are evident in DPO results, where the pretrain-only model shows no strong preference for winning topologies, as indicated by 0 reward accuracy. This suggests the model predominantly generates losing topologies during generation, i.e.,

$$log \frac{{π}_{θ} ( {y}_{w} \vert x )}{{π}_{ref} ( {y}_{w} \vert x )} < log \frac{{π}_{θ} ( {y}_{l} \vert x )}{{π}_{ref} ( {y}_{l} \vert x )} .$$

In contrast, the finetune-only model lacks the foundational understanding of circuit connectivity, making it challenging to effectively train on a limited number of labeled samples to generate valid topologies. For PPO, EVA's vast design space (10241029), dominated by invalid topologies, leads to an extremely sparse reward signal (i.e., most rewards are suboptimal). As a result, guiding the finetune-only model to discover high-performance relevant valid circuits from scratch becomes infeasible using a simple reward model. On the other hand, DPO results indicate that even an untrained model can achieve reward accuracy exceeding 50%, highlighting a limitation in this metric. Specifically, the metric only measures the preference for generating winning topologies,

$$log \frac{{π}_{θ} ( {y}_{w} \vert x )}{{π}_{ref} ( {y}_{w} \vert x )} > log \frac{{π}_{θ} ( {y}_{l} \vert x )}{{π}_{ref} ( {y}_{l} \vert x )} ,$$

without assessing the actual generation quality of winning topologies π_{θ}(y_{w}|x) or losing topologies (π_{θ}(yₗ|x). This limitation is further validated in Table 2900, where EVA (DPO only) fails to generate any valid topologies. In conclusion, EVA can effectively target high-performance relevant valid circuits only through a combination of pretraining and finetuning.

### C. Comparison Between PPO and DPO for EVA Finetuning

We compare PPO and DPO for EVA fine-tuning in terms of training stability and generation quality. PPO, an online RL method, dynamically generates new topologies and samples rewards from the environment, but its training instability stems from the stochastic reward signal r_{b}_{ₜ}, leading to noisy advantage estimates Aₜ and oscillations in L_{policy}. In contrast, DPO, an offline RL method, optimizes the relative log-likelihood between winning and losing topologies using static preference data, avoiding noisy rewards. For generation, PPO demonstrates superior validity by optimizing for both preference and reward-based quality through continuous exploration of new topologies. This enables it to overcome degeneration issues and produce valid, diverse outputs that outperform the pre-trained model. DPO, however, shifts the model's preference to high-performance topologies in the dataset without learning from new data, leading to degeneration in validity. This degeneration is characterized by a reduction in both winning and losing topology generation likelihoods in FIGS. 28A-B, with the latter declining faster.

FIGS. 28A and 28B are graphs (2800A, 2800B) of EVA's PPO loss and DPO loss, respectively, after pretraining while targeting Op-Amp design as an example.

At low learning rates, this degeneration is manageable, and our results focus on these settings, as shown in the FIGS. 28A-B and Table 2900 of FIG. 29. Higher learning rates, while not depicted, can cause the model to collapse, generating repetitive tokens. Despite these limitations, DPO excels in targeted discovery, producing higher-FoM topologies within 10 attempts and achieving lower MMD values, which indicate a closer resemblance to real-world circuits.

FIG. 29 is a Table 2900 that provides a performance comparison between EVA and existing analog circuit topology generation work Targeting another circuit type requires redo fine-tuning, which takes less than an hour on an A100 GPU.

### D. Comparison Between EVA and Prior Arts

Finally, we compare EVA with prior methods:

Validity: EVA demonstrates higher validity than previous methods. Top-down approaches like CktGNN and LaMAGIC rely on predefined representations, which limit their generalization to other circuit types and restrict the range of topologies they can be trained on. In contrast, EVA's universal circuit representation and bottom-up generation framework enable pretraining on diverse analog circuits with more training data. Novelty: EVA excels in discovering novel circuits compared to AnalogCoder and Artisan, which primarily reuse existing topologies or subblocks. LaMAGIC is confined to a small design space (fewer than 4 devices), limiting its ability to dis-cover new topologies. While CktGNN and EVA both support larger circuits (around 20 and 60 devices, respectively), CktGNN is trained on synthetic datasets, which lack critical real-world features. EVA, trained on real-world circuits, improves MMD by over 6× and generates around 99% novel circuits. Versatility: EVA outperforms Artisan, CktGNN, and LaMAGIC, which can only design one type of circuit. While AnalogCoder supports seven circuit types, it is limited to a synthesis library of just 20 topologies. EVA, trained on a dataset with 11 circuit types and over 3000 topologies (minimum 30 per type), demonstrates unparalleled versatility. Sample efficiency: Unlike prior work that typically uses performance-labeled topology to train a model from scratch, EVA first pretrains on an unlabeled dataset to build a strong foundation in circuit connectivity. This enables efficient fine-tuning with only a small labeled dataset, achieving up to 364× greater training sample efficiency compared to other methods. Discovery efficiency: CktGNN and EVA (Pretrain) lack targeted discovery, often producing low-performance circuits within 10 attempts. AnalogCoder's synthesis library only contains simple circuits, which also limits the FoM of the circuit it synthesized. After finetuning, EVA is able to align with human preference and target high-performance circuits within limited attempts. Combining the foundation knowledge it learned from all sorts of analog circuit types during pretraining, EVA is able to discover unseen topologies with superior FoM compared to dedicated synthesizers like Artisan and LaMAGIC, excelling in both Op-Amp and power converter.

An example embodiment of EVA is disclosed above, a versatile and efficient generative engine for discovering novel analog circuit topologies. EVA employs a bottom-up generation framework using a decoder-only transformer to sequentially predict device pin connections, starting from a VSS pin. By pretraining on an unlabeled dataset of circuit topologies, EVA establishes a strong foundation for topology generation, enabling fine-tuning with minimal performance-labeled data. Through fine-tuning strategies based on PPO or DPO, EVA achieves high discovery efficiency, targeting high-performance circuits while minimizing wasteful evaluations. EVA paves the way for AI-driven discovery in analog circuit, unlocking unprecedented potential for innovation in next-generation technologies.

### Supplemental Disclosure

### I. Methodology

A. Model Architecture with Control Prompts

In the original AnalogGenie model, the input is formulated as a sequence of tokens x=(x₁, x₂, . . . , x_{T}), where each token x; represents a component or node within a circuit topology. Each token is first mapped to a learnable embedding vector eₓᵢ ∈ [symbol] ^{d}^{_{model}}. To encode positional information, a corresponding positional embedding pᵢ ∈ [symbol] ^{d}^{_{model}} is added to the token embedding. The resulting input to the initial Transformer layer is given by:

$${z}_{i}^{( 0 )} = {e}_{{x}_{i}} + {p}_{i} , i = 1 , … , T .$$

The model is trained using an autoregressive objective: the input includes a sequence of preceding tokens, and the goal is to predict the next token in the sequence. During inference, generation begins with a special VSS token that serves as an initial prompt, after which the model autoregressively produces a sequence of tokens representing the circuit topology.
a) Control-Prompt Extension.: To incorporate topology and performance constraints into the generative process, we prepend two control embeddings to the input token sequence:
1) t∈ [symbol] ^{d}^{_{model}}—a pre-embedded topology description vector,
2) p∈ [symbol] ^{d}^{_{model}}—a pre-embedded performance description vector.

These control vectors are derived from a pre-trained, general-purpose embedding model, such as one trained on large-scale natural language corpora. Their dimensions are aligned with the model's token embeddings, allowing direct concatenation without additional projection layers. The control vectors remain fixed during training to preserve the semantics of the prompt space.

Leveraging pre-trained embeddings offers two key advantages: (1) it introduces rich semantic priors from large external language models, enabling the system to better interpret complex topology or performance descriptions; and (2) it mitigates the risk of underfitting when training data is limited, since the semantic structure of the control space does not need to be learned from scratch.

Let the token embedding matrix be denoted as E=[eₓ₁, . . . , eₓ_{_{T}}]^{T}. The complete input sequence, augmented with positional encoding, becomes:

$${Z}^{( 0 )} = [ t + {p}_{0} ; p + {p}_{1} ; {e}_{{x}_{1}} + {p}_{2} ; … ; {e}_{{x}_{T}} + {p}_{T + 1} ] ,$$

where [·;] denotes concatenation along the sequence dimension.

This design retains the original autoregressive structure of the model while enabling controllable generation via the introduction of control prompts, which guide the output towards circuit topologies that satisfy specified design objectives.
b) Zero-Embedding Vector Mask.: To improve the model's robustness and generalization capability, we introduce a zero-embedding vector mask mechanism during training. In this approach, the control embeddings (t, p) corresponding to the topology and performance descriptions are stochastically replaced with zero vectors:

$$\tilde{t} = {m}_{t} \cdot t , \tilde{p} = {m}_{p} \cdot p ,$$

where mₜ, mₚ ∈{0, 1} are binary mask variables. When mₜ=0 or mₚ=0, the corresponding control vector is replaced by a zero vector of dimension d_{model}.

This masking strategy serves several key purposes:
1) It simulates scenarios in which control prompts are fully or partially missing, encouraging the model to rely more heavily on contextual information from the token sequence.
2) It helps prevent the model from overfitting to specific prompt-sequence combinations, promoting the acquisition of broader and more transferable knowledge about circuit structures.
3) It facilitates controllable generation during inference, enabling flexible adjustment of control intensity—from fully guided to entirely unguided generation-based on prompt availability.
4) It enhances few-shot generalization and improves generation diversity, by exposing the model to a wider distribution of prompt conditions and encouraging exploration beyond prompt-conditioned patterns.

In practice, we construct augmented training batches that combine full-control, partial-control, and zero-control examples. This training strategy improves the model's adaptability to varying levels of control and supports both prompt-guided and open-ended generation.
c) Training and Inference Setup.: During training, the model input comprises three components: (1) the topology description vector t, (2) the performance description vector p, and (3) the tokenized circuit sequence These inputs are embedded and concatenated to form the input sequence:

$${X}_{in} = [ t ; p ; {x}_{1} ; {x}_{2} ; … ; {x}_{T - 1} ] ,$$

and the model is trained in an autoregressive manner to predict the target sequence:

$${X}_{out} = [ {x}_{1} ; {x}_{2} ; … ; {x}_{T} ] .$$

The control vectors t and p occupy the first two positions and are excluded from the loss computation, as they serve solely as conditioning inputs rather than prediction targets.

At inference time, the model receives the control embeddings (t, p) and generates the circuit topology token by token in an autoregressive fashion. Setting both control vectors to zero,

$$t = 0 , p = 0 ,$$

results in unconditional generation—i.e., the model generates topologies without being guided by any specific structural or performance constraints.

FIG. 30 is a block diagram of an example embodiment of the model architecture disclosed above.

### B. LLM-Based Judger

The first step in evaluating a generated circuit topology is to ensure that it satisfies basic design rules, such as avoiding floating nodes and maintaining valid connectivity. We adopt the same validation procedure as used in AnalogGenie, which checks topological correctness and converts valid Eulerian paths into corresponding netlists for further analysis.

The validation pass rate varies across different prompt conditions, as shown in Table 5.

TABLE 5
Validation pass rate of generated circuits under
different textual promts at temperature T =
0.7. Each result is based on 100 generated samples.

| Prompt | Pass Rate (%) |
|---|---|
| The circuit is an opamp. | 36.00 |
| The circuit is an amplifier. | 56.00 |
| No prompt | 86.00 |
| The circuit is a three-stage opamp. | 92.00 |
| The circuit is a power amplifier. | 51.00 |

While rule-based validation ensures structural soundness, it does not capture whether the generated topology aligns with the intended functional class (e.g., opamp, power amplifier). This limitation is especially pronounced given the inherent diversity of designs produced by AnalogGenie.

To address this gap, we introduce a large language model (LLM) as a semantic judger to assess whether a generated circuit conforms to the task-specific topological requirements. The LLM provides a flexible, language-based evaluation framework that complements rule-based checks with higher-level structural understanding.
a) LLM Ability Test: To assess whether an LLM can reliably determine the circuit type solely from its netlist, we conduct an ability test on the AnalogGenie dataset, where ground-truth topology labels are available. In this experiment, the LLM is provided with the netlist of a circuit and asked to identify its topology class. The predicted class is then compared with the labeled class to evaluate the LLM's classification accuracy.

### Example

M4 (net17 VIN1 net13 VDD) pmos4
M3 (net9 VIN2 net13 VDD) pmos4
M2 (VOUT1 net26 VDD VDD) pmos4
M1 (net13 net26 VDD VDD) pmos4
M0(net29 net26 VDD VDD) pmos4
M11 (net22 VSS net17 VSS) nmos4
M8 (net22 VDD net17 VSS) nmos4
M7 (VOUT1 net17 VSS VSS) nmos4
M6 (net17 net9 VSS VSS) nmos4
M5 (net9 net9 VSS VSS) nmos4
R0(net29 VSS) resistor
C1 (VOUT1 VSS) capacitor
C0 (VOUT1 net22) capacitor
   Response from LLM:

Based on the provided SPICE netlist, this circuit is a two-stage operational amplifier (op-amp) with Miller compensation.

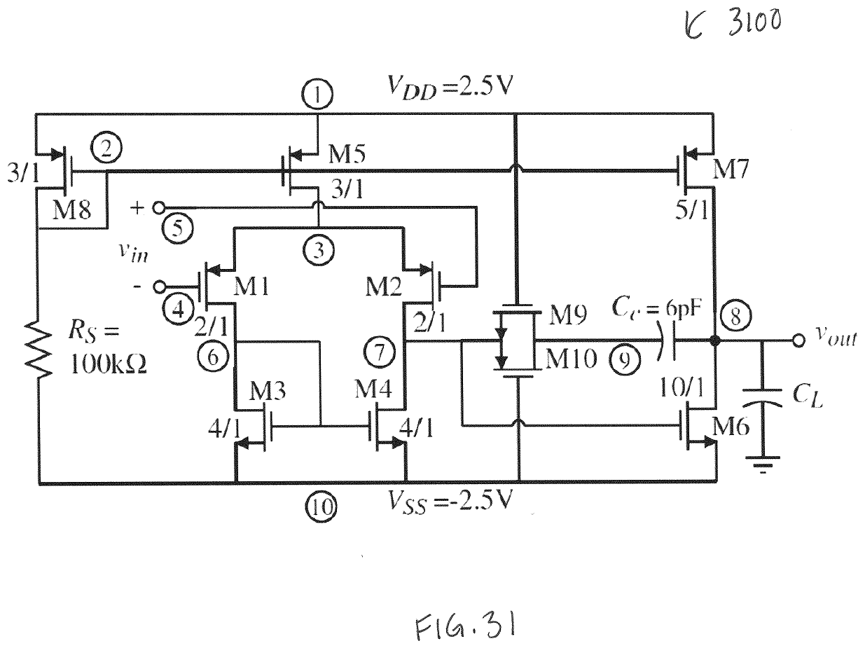

FIG. 31 is a circuit schematic 3100 (not provided to the LLM).
b) LLM Judged result on the output design: Here is a sample output from the modified AnalogGenie model with topology control to generate an amplifier circuit. XNM1 IB1 IB1 VSS VSS nmos_model W=‘wnNM1’
L=‘InNM1’ mult=‘mnNM1’ m=‘mnNM1’ XNM2 net16 IB1 VSS VSS nmos model W=‘wnNM2’
L=‘InNM2’ mult=‘mnNM2’ m=‘mnNM2’ XNM3 VOUT2 VIN2 net16 VSS nmos model
W=‘wnNM3’ L=‘InNM3’ mult=‘mnNM3’ m=‘mnNM3’ XNM4 VOUT1 VIN1 net16 VSS nmos model
W=‘wnNM4’ L=‘InNM4’ mult=‘mnNM4’ m=‘mnNM4’ XPM1 VOUT2 VOUT2 VDD VDD pmos_model W=‘wpPM1’
L=‘lpPM1’ mult=‘mpPM1’ m=‘mpPM1’ XPM2 VOUT1 VOUT2 VDD VDD pmos_model W=‘wpPM2’
L=‘lpPM2’ mult=‘mpPM2’ m=‘mpPM2’ XPM3 VOUT2 VOUT1 VDD VDD pmos_model W=‘wpPM3’
L=‘lpPM3’ mult=‘mpPM3’ m=‘mpPM3’ XPM4 VOUT1 VOUT1 VDD VDD pmos_model W=‘wpPM4’
L=‘lpPM4’ mult=‘mpPM4’ m=‘mpPM4’

Here is the output type classification by the LLM (gemini-2.5 Pro): Based on the provided SPICE netlist, this circuit is a Differential Amplifier with a Cross-Coupled PMOS Active Load.

FIG. 32 is a block diagram of an example of the internal structure of a computer 3200 in which various embodiments of the present disclosure may be implemented. The computer 3200 contains a system bus 3252, where a bus is a set of hardware lines used for data transfer among the components of a computer or digital processing system. The system bus 3252 is essentially a shared conduit that connects different elements of a computer system (e.g., processor, disk storage, memory, input/output ports, network ports, etc.) that enables the transfer of information between the elements. Coupled to the system bus 3252 is an I/O device interface 3254 for connecting various input and output devices (e.g., keyboard, mouse, displays, printers, speakers, etc.) to the computer 3200. A network interface 3256 allows the computer 3200 to connect to various other devices attached to a network (e.g., global computer network, wide area network, local area network, etc.). Memory 3258 provides volatile or non-volatile storage for computer software instructions 3260 and data 3262 that may be used to implement embodiments of the present disclosure, where the volatile and non-volatile memories are examples of non-transitory media. Disk storage 3264 provides non-volatile storage for computer software instructions 3260 and data 3262 that may be used to implement embodiments of the present disclosure. A central processor unit 3266 is also coupled to the system bus 3252 and provides for the execution of computer instructions.

An example embodiment disclosed herein may employ hardware, software, firmware, electronic control component, processing logic, and/or processor device, individually or in any combination, including without limitation: an application specific integrated circuit (ASIC), a field-programmable gate-array (FPGA), an electronic circuit, a processor and memory that executes one or more software or firmware programs, and/or other suitable components that provide the described functionality.

Example embodiments disclosed herein may be configured using a computer program product; for example, controls may be programmed in software for implementing example embodiments. Further example embodiments may include a non-transitory computer-readable medium that contains instructions that may be executed by a processor, and, when loaded and executed, cause the processor to complete methods described herein. It should be understood that elements of the block and flow diagrams may be implemented in software or hardware, such as via one or more arrangements of circuitry of FIG. 32, disclosed above, or equivalents thereof, firmware, a combination thereof, or other similar implementation determined in the future.

In addition, the elements of the block and flow diagrams described herein may be combined or divided in any manner in software, hardware, or firmware. If implemented in software, the software may be written in any language that can support the example embodiments disclosed herein. The software may be stored in any form of computer readable medium, such as random-access memory (RAM), read-only memory (ROM), compact disk read-only memory (CD-ROM), and so forth. In operation, a general purpose or application-specific processor or processing core loads and executes software in a manner well understood in the art. It should be understood further that the block and flow diagrams may include more or fewer elements, be arranged or oriented differently, or be represented differently. It should be understood that implementation may dictate the block, flow, and/or network diagrams and the number of block and flow diagrams illustrating the execution of embodiments disclosed herein. The teachings of all patents, published applications, and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A computer-implemented method for training a generative engine for circuit topology discovery, the computer-implemented method comprising:
generating a graph representing a circuit topology of a training dataset, the graph generated including nodes and edges, the nodes representing device pins of circuit components in the circuit topology;
transforming the graph generated into a sequential token representation of tokens by traversing the edges of the graph generated, the tokens representing the device pins, the traversing forming a traversal path that visits each edge of the edges at least once; and
training the generative engine to predict successive tokens of the sequential token representation.

2. The computer-implemented method of claim 1, wherein the training dataset includes a plurality of circuit topologies and wherein the plurality of circuit topologies includes the circuit topology.

3. The computer-implemented method of claim 2, further comprising repeating the representing, transforming, and training for each circuit topology of the plurality of circuit topologies.

4. The computer-implemented method of claim 1, wherein the tokens further represent circuit-level pins in the circuit topology.

5. The computer-implemented method of claim 1, wherein the generative engine is based on a causal model, wherein the graph generated is an undirected graph, wherein the transforming includes converting the undirected graph to obtain an Eulerian circuit that visits each edge at least once, and wherein the generative engine is a decoder-only transformer.

6. The computer-implemented method of claim 1, further comprising compressing the sequential token representation prior to the training, the compressing reducing a total length of the sequential token representation, the compressing including at least one of: pruning redundant nodes and edges in the graph generated, subgraph mining and replacement, and solving a shortest-closed-path problem to obtain a minimal-length sequential token representation.

7. The computer-implemented method of claim 1, further comprising pruning the graph generated prior to the transforming and wherein the pruning includes removing redundant nodes and redundant edges in the graph generated.

8. The computer-implemented method of claim 1, further comprising:
pruning the graph generated prior to the transforming, the pruning including removing isolated nodes of a sub-graph of the graph generated; and
restructuring non-isolated nodes of the sub-graph that remain following the pruning.

9. The computer-implemented method of claim 1, further comprising:
mining graphs representing a plurality of circuit topologies of the training dataset, the mining including identifying a sub-graph that occurs in multiple graphs of the graphs mined; and
replacing instances of the sub-graph identified with a compact representation thereof.

10. The computer-implemented method of claim 1, further comprising performing subsequent training of the generative engine, the subsequent training performed subsequent to the training, the subsequent training fine tuning the generative engine to perform target circuit topology discovery.

11. The computer implemented method of claim 10, wherein the subsequent training is based on a text prompt input to the generative engine and wherein the text prompt represents a) at least one target circuit characteristic of a targeted circuit topology, b) at least one target circuit type of the targeted circuit topology, or c) a combination of a) and b).

12. The computer-implemented method of claim 10, wherein the subsequent training includes proximal policy optimization using a reward model that classifies circuit topologies generated by the generative engine into a plurality of ranked categories based on validity, relevance to a target circuit type, and performance.

13. The computer-implemented method of claim 10, wherein the subsequent training includes direct preference optimization using pairs of circuit topologies, each pair including a preferred topology and a non-preferred topology ranked according to at least one performance metric.

14. The computer implemented method of claim 10, wherein the subsequent training is based on feedback input to the generative engine and wherein the feedback represents a reward or penalty received responsive to a circuit topology discovered by the generative engine.

15. The computer-implemented method of claim 14, wherein the reward or penalty received is based on a comparison of a) at least one target circuit characteristic of a targeted circuit topology and at least one characteristic of the circuit topology discovered, b) at least one target circuit type of the targeted circuit topology and at least one type of the circuit topology discovered, or c) a combination of a) and b).

16. The computer-implemented method of claim 1, wherein the training dataset includes a corpus of distinct circuit topologies with diverse functionalities.

17. The computer-implemented method of claim 1, wherein the transforming includes solving a shortest closed path problem on the graph generated to obtain a minimal-length sequential token representation that visits each edge of the graph at least once.

18. The computer-implemented method of claim 1, further comprising augmenting the training dataset by generating, for each circuit topology of the training dataset, a plurality of distinct sequential token representations, each distinct sequential token representation of the plurality of distinct sequential token representations representing a same circuit topology via a different traversal path of a respective graph.

19. A computer-implemented method for automating circuit topology discovery, the computer-implemented method comprising:
generating, automatically via a trained generative engine, a sequential token representation of tokens, tokens of the sequential token representation representing pins of a circuit topology discovered by the trained generative engine; and
transforming the sequential token representation generated by the trained generative engine into a graph, the graph representing the circuit topology discovered.

20. The computer-implemented method of claim 19, wherein the pins include device-level pins of circuit components of the circuit topology discovered and circuit-level pins in the circuit topology discovered.

21. The computer-implemented method of claim 19, wherein the generative engine is based on a causal model and wherein the generative engine is a decoder-only transformer.

22. The computer-implemented method of claim 19, further comprising performing the generating responsive to a text prompt input to the trained generative engine, the text prompt causing the circuit topology discovered to have a target circuit type or a target circuit characteristic.

23. The computer-implemented method of claim 19, wherein the trained generative engine is trained based on a training dataset, wherein the circuit topology discovered is not present in the training dataset, and wherein the training dataset includes a corpus of distinct circuit topologies with diverse functionalities.

24. A non-transitory computer-readable medium for training a generative engine for circuit topology discovery, the non-transitory computer-readable medium having encoded thereon a sequence of instructions which, when loaded and executed by at least one processor, causes the at least one processor to:
generate a graph representing a circuit topology of a training dataset, the graph generated including nodes and edges, the nodes representing device pins of circuit components in the circuit topology;
transform the graph generated into a sequential token representation of tokens by traversing the edges of the graph generated, the tokens representing the device pins, the traversing forming a traversal path that visits each edge of the edges at least once; and
train the generative engine to predict successive tokens of the sequential token representation.
